(19) United States
(12) Patent Application Publication
(10) Pub. No.: US 2007/0177271 A1
(43) Pub. Date: Aug. 2, 2007

(54) Antireflection film, polarizing plate and image display

(75) Inventor: Naohiro Matsunaga, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/700,873

(22) Filed: Feb. 1, 2007

(30) Foreign Application Priority Data
Feb. 2, 2006 (JP) 2006-025822

(51) Int. Cl. G02B 1/10

(52) U.S. Cl. 359/582

(57) ABSTRACT

An antireflection film is provided and has at least one hard coat layer and a low refractive-index layer having a refractive index of 1.47 or less as the outermost layer on a transparent support. The roughness Ra of the antireflection film is 0.03 μm or more and when it is assumed that average 5° specular reflectance is A and average integrated reflectance is B in a wavelength range of 450 nm to 650 nm, B−A<4 Ra.

### BACKGROUND OF THE INVENTION

1. Field of the Invention

The present invention relates to an antireflection film, and a polarizing plate and an image display using the antireflection film. The antireflection film is generally disposed at the outermost surface of a display device, such as a CRT, a PDP, an ELD, a SED, an LCD or the like, for improvement of display and protection capability of the display device.

2. Description of Related Art

For the purpose of improving display capability, there has been provided an antiglare hard coat film to prevent reflection of an external image by scattering external light reflected on a surface of the film. For example, JP-A-2000-338310 discloses a technique in which particles are contained in a hard coat layer to make its surface uneven so as to scatter external light, thereby lessening glare of an image. In addition, JP-A-2002-196117 and JP-A-2003-161816 disclose a technique in which a low refractive index layer is formed on an antiglare hard coat film having unevenness formed on its surface, thereby achieving further reduction of external light reflection by light interference.

The above-mentioned techniques improve visibility to some degree at a bright place. However, with the advancement in image displays, there arises a need for a surface film to satisfy a high blackness requirement that a black portion of an image appears to be more blackened. Accordingly, there is a need for a design to show maximal performance of the low refractive index layer and/or the antiglare layer for the high blackness.

Also, along with the progress in the image display, tolerances are becoming narrower for the image blur and the loss in contrast in the front direction, caused by mounting of a surface film, and a surface film capable of satisfying these requirements is now being required.

### SUMMARY OF THE INVENTION

One aspect of an illustrative, non-limiting embodiment of the invention is to provide an improved surface film (antireflection film) which is capable of providing high blackness even at a bright place. Another aspect of an illustrative, non-limiting embodiment of the invention is to provide an excellent surface film (antireflection film) that does cause an image blur (does not cause a loss in the front contrast). Still another aspect of an illustrative, non-limiting embodiment of the invention is to provide a high-quality polarizing plate and image display having the above-mentioned antireflection film.

The foregoing aspects can be attained by the following means.

(1) An antireflection film comprising: a transparent support; at least one hard coat layer; and a low refractive index layer having a refractive index of 1.47 or less, the low refractive index layer being an uppermost layer of the antireflection film,

wherein the antireflection film has a center-line average roughness Ra of 0.03 μm or more, and the antireflection film satisfies Expression (1):

B−A<4·Ra (1)

wherein A represents an average 5° specular reflectance in a wavelength rage of 450 to 650 nm, and B represents an average integrated reflectance in the wavelength range.

(2) The antireflection film according to item (1) above, which has an internal haze of less than 36%.

(3) The antireflection film according to item (1) or (2) above, wherein the hard coat layer has a thickness of 5 to 35 μm.

(4) A polarizing plate comprising: a polarizer; and two protective films, wherein at least one of the two polarizing plate is an antireflection film according to any one of items (1) to (3) above.

(5) An image display comprising an antireflection film according to any one of items (1) to (3) above or a polarizing plate according to item (4) above, as an outermost layer of the image display.

(6) The image display according to item (5) above, which is a television having a size of 32 inches or more.

### BRIEF DESCRIPTION OF THE DRAWINGS

The features of the invention will appear more fully upon consideration of the exemplary embodiments of the invention, which are schematically set forth in the drawings, in which:

FIG. 1 is a sectional view schematically illustrating a film according to an exemplary embodiment of the invention;

FIG. 2 is a sectional view schematically illustrating a film according to an exemplary embodiment of the invention;

FIG. 3 is a sectional view schematically illustrating a film according to an exemplary embodiment of the invention;

FIG. 4 is a sectional view schematically illustrating a film according to an exemplary embodiment of the invention;

FIG. 5 is a sectional view schematically illustrating a film according to an exemplary embodiment of the invention;

FIG. 6 is a sectional view of a coater 10 using a slot die 13 according to the invention;

FIG. 7A is a sectional view of the slot die 13 according to the invention, and FIG. 7B is a sectional view of a conventional slot die 30;

FIG. 8 is a perspective view illustrating the slot die and the periphery thereof in a coating process according to the invention;

FIG. 9 is a sectional view illustrating a depressurizing chamber 40 and a web W adjacent to each other (where a back plate 40a forms a body along with a chamber r40 body);

FIG. 10 is a sectional view of an antireflection film for explaining a method of regulating of the film surface;

FIG. 11 is a sectional view of an antireflection film for explaining a method of regulating of the film surface; and

FIG. 12 is a sectional view of an antireflection film for explaining a method of regulating of the film surface.

### DETAILED DESCRIPTION OF THE EXEMPLARY EMBODIMENTS

Although the invention will be described below with reference to the exemplary embodiments thereof, the following exemplary embodiments and modifications do not restrict the invention.

According to an exemplary embodiment of the invention, an improved antireflection film which exhibits high blackness even at a very blight place can be provided, and a high-quality polarizing plate and a high-quality image display using the antireflection film can be provided.

Hereinafter, exemplary embodiments of the present invention will be described in more detail. In the specification, in the case where the numerical value indicates physical property value, characteristic value or the like, the term “(numerical value 1) to (numerical value 2)” as used herein is meant to indicate “not smaller than (numerical value 1) to not greater than (numerical value 2)”. Further, a description such as “(meth)acrylate” means at least any one of acrylate and methacrylate. The same is applied to a term of “(meth)acrylic acid” as well.

An antireflection film of the invention needs to satisfy the following Expression (1):

B−A<4·Ra (1)

wherein A is an average 5° specular reflectance and B is an average integrated reflectance in a wavelength range of 450 nm to 650 nm, and Ra is a center-line average roughness (Jim).

Preferably, B−A<3·Ra. If “B−A” is 4·Ra or more, it is found that the high blackness is so deteriorated that an effect of the invention can not be obtained. A method of measuring the average 5° specular reflectance and the average integrated reflectance will be described later.

In order to obtain an antireflection film satisfying the above Expression (1), it is necessary to regulate the surface shape (such as height and frequency of protrusions) of the antireflection film within a desired range. Specific examples of the regulating method include followings:

(I) In a case where the thickness of a hard coat layer containing particles is smaller than the size of the particles,

(1) the protrusion height of the film surface can be regulated by controlling a difference between the size of the particles and the thickness of the hard coat layer; and

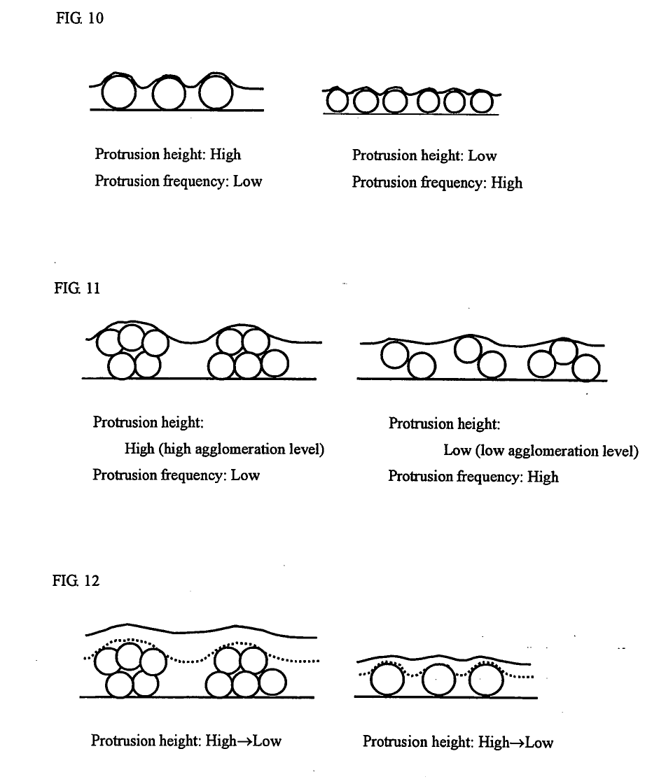

(2) the protrusion frequency of the film surface can be regulated by controlling the number of the particles (FIG. 10).

(II) In a case where the thickness of a hard coat layer containing particles is larger than the size of the particles,

(1) the protrusion height of the film surface can be regulated by controlling a difference in surface energy (difference in hydrophilicity) between the matrix (binder) of the hard coat layer and the particle surface (i.e., regulating agglomeration level of the particles), and the size of the particles; and

(2) the protrusion frequency of the film surface can be regulated by controlling the number of the particles (FIG. 11).

(III) In a case where a hard coat layer containing particles is overcoated by another hard coat layer; the protrusion height of the film surface can be regulated by controlling a thickness of the other hard coat layer (FIG. 12). In addition, the roughness Ra (center-line average roughness) of the antireflection film of the invention is needed to be 0.03 μm or more. If the roughness Ra is less than 0.03 μm, it is not preferable since reflection of an external image is increased, thereby deteriorating visibility. The roughness Ra is not particularly limited as long as it is 0.03 μm or more, preferably 0.03 μm to 0.3 μm, more preferably 0.05 μm to 0.2 μm. From a standpoint of surface unevenness size and high blackness, it is preferable that Ra is not more than 0.3 μm.

### 1. Composition of Antireflection Film

First, various compounds which can be used for the antireflection film of the invention will be described.

### 1-(1) Binder

The antireflection film of the invention may be formed by cross-linking or polymerization of an ionizing radiation-curing compound. That is, a coating composition containing an ionizing radiation-curing multifunctional monomer or oligomer is applied as a binder on a transparent support, and then, the antireflection film may be formed by cross-linking or polymerizing the multifunctional monomer or oligomer.

It is preferable that a functional group of the ionizing radiation-curing multifunctional monomer or multifunctional oligomer is photo, electron beam or radiation polymeric functional group, particularly, the photo polymeric functional group.

It is preferable that the photo polymeric functional group includes unsaturated polymeric functional group such as (meta)acryloyl group, vinyl group, styryl group, allyl group or the like, particularly, the (meta)acryloyl group.

An example of photo polymeric multifunctional monomer having the photo polymeric functional group may include:

(meth)acryl acid diester of alkyleneglycol, such as neopentylglycolacrylate, 1,6-hexanediol(meta)acrylate, propyleneglycolacrylate or the like;

(meth)acryl acid diester of polyoxyalkyleneglycol, such as triethyleneglycoldi(meta)acrylate, dipropyleneglycol (meta)acrylate, polyethyleneglycoldi(meta)acrylate, polypropyleneglycoldi(meta)acrylate or the like;

(meth)acryl acid diester of polyhydric alcohol, such as pentaerythritol(meta)acrylate or the like; and

(meth)acryl acid diester of ethylene oxide or propylene oxide adduct, such as 2,2-bis{4-(acryloxy.diethoxy)phenyl}profane, 2-2-bis{4-(acryloxy.polypropoxy)phenyl}profane or the like.

It is also preferable that epoxy (meth)acrylate, urethane(meta)acrylate or polyester(meta)acrylate is used as the photo polymeric multifunctional monomer.

Of the above-mentioned compounds, it is preferable that (meth)acryl acid diester of polyhydric alcohol is used as the photo polymeric multifunctional monomer. More preferably, multifunctional monomer having 3 or more (meth)acryloyl groups in one molecule is used as the photo polymeric multifunctional monomer. Specifically, the photo polymeric multifunctional monomer may include trimethylolpropanetri(meta)acrylate, trimethylolethanetri(meta)acrylate, 1,2,4-cyclohexanetetra(meta)acrylate, pentaglyceroltriacrylate, pentaerythritoltetra(meta)acrylate, pentaerythritoltri(meta)acrylate, (di)pentaerythritoltriacrylate, (di)pentaerythritolpentaacrylate, (di)pentaerythritoltetra(meta)acrylate, (di)pentaerythritolhexa(meta)acrylate, tripentaerythritoltriacrylate, Tripentaerythritolhexatriacrylate, etc. In the specification, the term “(meta)acrylate”, “(meta)acryl acid”, and “(meta)acryloyl” means “acrylate or methacrylate”, “acryl acid or methacryl acid”, and “acryloyl or methacryloyl”, respectively.

The monomer binder may use monomers having different refractive index to control refractive indexes of layers. Specifically, an example of a high refractive index monomer includes bis(4-metacrysloylthiopenyl)sulfide, vinylnaphtalene, vinylpenylsulfide, 4-metacrysloxypenyl-4′-methoxypenylthioether, etc.

In addition, for example, the monomer binder may use dendrimer disclosed in JP-A-2005-76005 and JP-A-2005-36105, or norbornene ring-contained monomer disclosed in JP-A-2005-60425.

The multifunctional monomer may use two or more kinds of monomers.

Polymerization of monomer having ethylenically unsaturated group may be conducted by ionizing radiation or heating under existence of photo-radical initiator or thermal-radical initiator.

It is preferable that photo polymeric initiator is used for the photo polymeric multifunctional monomer. The photo polymeric initiator is preferably photo-radical polymeric initiator and photo-cation polymeric initiator, more preferably the photo-radical polymeric initiator.

### 1-(2) Polymer Binder

In the present invention, polymer or crosslinking polymer may be used as a binder. It is preferable that the crosslinking polymer has anionic group. The crosslinking polymer having the anionic group has a structure in which a main chain of polymer having anionic group is crosslinked.

An example of main chain of polymer includes polyolefin (saturated hydrocarbon), polyether, polyurea, polyurethane, polyester, polyamine, polyamide and melamine resin. The main chain of polymer is preferably a polyolefin main chain, a polyether main chain and a polyurea main chain, more preferably, the polyolefin main chain and the polyether main chain, most preferably, the polyolefin main chain.

The polyolefin main chain includes saturated hydrocarbon. The polyolefin main chain is obtained by, for example, an addition polymerization reaction of unsaturated polymeric group. The polyether main chain has repeating units combined by ether linkage (—O—). The polyether main chain is obtained by, for example, a ring-opening polymerization reaction of epoxy group. The polyurea main chain has repeating units combined by urea linkage (—NH—CO—NH—). The polyurea main chain is obtained by, for example, a polycondensation reaction of isocyanate group with amino group. The polyurethane main chain has repeating units combined by urethane linkage (—NH—CO—O—). The polyurethane main chain is obtained by, for example, a polycondensation reaction of isocyanate group with hydroxyl group (including N-methyloyl group). The polyester main chain has repeating units combined by ester linkage (—CO—O—). The polyester main chain is obtained by, for example, a polycondensation reaction of carboxyl group (including acid halide group) with hydroxyl group (including N-methylol group). The polyamine main chain has repeating units combined by imino linkage (—NH—). The polyamine main chain is obtained by, for example, a ring-opening polymerization reaction of ethylenimine group. The polyamide main chain has repeating units combined by amide linkage (—NH—CO—). The polyamide main chain is obtained by, for example, a reaction of isocyanate group with carboxyl group (including acid halide group). The melamine resin main chain is obtained by, for example, a polycondensation reaction of triazine group (for example, melamine) with aldehyde (for example, formaldehyde). The main chain of the melamine resin has a crosslinked structure.

Anionic group is linked to a main chain of polymer directly or via a linkage group. It is preferable that the anionic group is linked, as a side chain, to the main chain via the linkage group.

An example of the anionic group includes carboxyl acid group (carboxyl), sulfonic acid group (sulfone), phosphoric acid group (phosphone), etc., preferably, the sulfonic acid group and the phosphoric acid group.

The anionic group may be in a saline state. It is preferable that the anionic group and cation forming salt are alkali metal ions. Also, protons of the anionic group may be dissociated.

It is preferable that linkage group that links the anionic group to the main chain of polymer is bivalent group selected from —CO—, —O—, alkylene group, arylene group, and a combination thereof.

A crosslinked structure refers to a structure that two or more main chains are chemically linked to each other (preferably, covalent-bonded). It is preferable that three or more main chains are covalent-bonded. It is preferable that the crosslinked structure consists of bivalent or more group selected from —CO—, —O—, —S—, nitrogen atoms, phosphorus atoms, aribhatic moiety, aromatic moiety, and a combination thereof.

It is preferable that the polymer having the crosslinked anionic group is copolymer having a repeating unit with anionic group and a repeating unit with a crosslinked structure. In the copolymer, a percentage of the repeating unit with the anionic group is preferably 2 to 96 weight %, more preferably 4 to 94 weight %, most preferably 6 to 92 weight %. The repeating unit may have two or more anionic groups. In the copolymer, a percentage of the repeating unit with the crosslinked structure is preferably 4 to 98 weight %, more preferably 6 to 96 weight %, most preferably 8 to 94 weight %.

The repeating unit of the polymer having the crosslinked anionic group may have both of the anionic group and the crosslinked structure. In addition, the polymer having the crosslinked anionic group may have different repeating units (repeating units having neither anionic group nor crosslinked structure).

It is preferable that the different repeating units are a repeating unit having an amino group or a quaternary ammonium group and a repeating unit having a benzene ring. The amino group or the quaternary ammonium group has a function to keep inorganic particles in a dispersed state, like the anionic group. In addition, the same effect can be obtained even when the amino group, the quaternary ammonium group and the benzene ring are contained in the repeating unit having the anionic group or the repeating unit having the crosslinked structure.

In the repeating unit having the amino group or the quaternary ammonium group, the amino group or the quaternary ammonium group is linked to a main chain of polymer directly or via a linkage group. It is preferable that the amino group or the quaternary ammonium group is linked, as a side chain, to the main chain of polymer via the linkage group. The amino group is preferably a secondary amino group or a tertiary amino group, more preferably the tertiary amino group. A group linked to a nitrogen atom of the tertiary amino group or the quaternary ammonium group is preferably an alkyl group having 1 to 12 carbon atoms, more preferably an alkyl group having 1 to 6 carbon atoms. It is preferable that paired ion of the quaternary ammonium group is halide ions. It is preferable that a linkage group that links the amino group or the quaternary ammonium group to the main chain of polymer is bivalent group selected from —CO—, —NH—, —O—, alkylene group, arylene group, and a combination thereof. If the polymer having the crosslinked anionic group includes a repeating unit with the amino group or the quaternary ammonium group, a percentage of the repeating unit with the amino group or the quaternary ammonium group is preferably 0.06 to 32 weight %, more preferably 0.08 to 30 weight %, most preferably 0.1 to 28 weight %.

### 1-(3) Fluorine-Contained Polymer Binder

In the present invention, a fluorine-contained copolymer compound is preferably used for, particularly, a low refractive index layer of the binder of the polymer. An example of fluorine-contained vinyl monomer may include fluoroolefin (foe example, fluoroethylene, vinylidenefluoride, tetrafluoroethylene, hexafluoropropylene, etc.), partially or completely fluorinated alkylester derivatives of (meta)acryl acid (for example, Biscoat6FM (available from Osaka Organic Chemical Industry., Ltd.) or R-2020 (available from Daikin Industries., Ltd.), etc.), partially or completely fluorinated vinylether, etc. The fluorine-contained copolymer compound is preferably perfluoroolefin, more preferably hexafluoropropylene from a standpoint of refractive index, solubility, transparency, availability, etc. If a composition ratio of fluorine-contained copolymer in these compounds is increased, the strength of a film is lowered although the refractive index is reduced. In the present invention, the fluorine-contained vinyl monomer is introduced such that a percentage of fluorine of the copolymer is preferably 20 to 60 weight %, more preferably 25 to 55 weight %, most preferably 30 to 50 weight %.

Constituent unit for crosslinkage may mainly include (A), (B) and (C) constitutent units as follows:

(A): Constituent unit obtained by polymerization of monomer having self-crosslinking functional groups in molecules, such as glycidyl(meta)acrylate, glycidylvinylether or the like. (B): Constitutent unit obtained by polymerization of monomer having a carboxyl group, a hydroxy group, an amino group, a sulfone group, etc. (for example, (meta)acryl acid, methylol(meta)acrylate, hydroxyalkyl(meta)acrylate, arylacrylate, hydroxyethylvinylether, hydroxybutylvinylether, maleic acid, crotonic acid, etc.)

(C): Constituent unit obtained by reacting a group reacting with functional groups of (A) and (B) with a compound having a crosslinked functional group in the constituent unit of (A) or (B) (for example, constituent unit which can be synthesized by reacting a hydroxyl group with acryl acid chloride).

It is preferable that a crosslinked functional group of the constituent unit of (C) is a photo polymeric group. An example of the photo polymeric group may include a (meta)acryloyl group, an alkenyl group, a cinnamoyl group, cinnamylidenacetyl group, a benzalacetophenone group, a styrylpyridine group, a α-phenylmaleimide group, a phenylazide group, a sulfonylazide group, a carbonylazide group, a diazo group, a o-quinonediazide group, a furylacryloyl group, a coumalin group, a pyrone group, anthracene group, benzophenone group, a stilbene group, a dithiocarbamate group, an xanthate group, a 1,2,3-thiadiazole group, a cycloprophene group, an azadioxabicyclo group, and a combination thereof. Of these groups, the photo polymeric group is preferably the (meta)acryloyl group or the cinnamoyl group, more preferably, the (meta)acryloyl group.

The photo polymeric group-contained copolymer may be made according to the following methods, without being limited thereto.

a. A method of esterificating by reacting (meta)acryl acid chloride to crosslinked functional group-contained copolymer containing a hydroxyl group,

b. A method of uretanizing by reacting (meta)acryl acid ester containing an isocyanate group to crosslinked functional group-contained copolymer containing a hydroxyl group,

c. A method of esterificating by reacting (meta)acryl acid to crosslinked functional group-contained copolymer containing an epoxy group, and

d. A method of esterificating by reacting (meta)acryl acid ester containing an epoxy group to crosslinked functional group-contained copolymer containing a carboxyl group.

In addition, the amount of photo polymeric group introduced may be adjusted randomly, it is preferable that the carboxyl group or the hydroxyl group may be left for surface stability of a coated film, prevention of surface defect in coexistence of inorganic particles, enhancement of film strength, etc.

In the copolymer useful in the invention, repeating units and side chains derived from the fluorine-contained vinyl monomer may be copolymerized with properly different vinyl monomers, in addition to repeating units having the (meta)acryloyl group, in consideration of adhesion to a base material, Tg of polymer (Tg contributes to hardness of coated film), solubility in solvent, transparency, slidability, dustproofing, anti-smudge, etc. These vinyl monomers may be variously combined to meet their purpose. These vinyl monomers is preferably introduced within a range of 0 to 65 mol % of the copolymer, more preferably a range of 0 to 40 mol % of the copolymer, most preferably a range of 0 to 30 mol % of the copolymer in total.

The unit of combined vinyl monomers is not particularly limited. An example of the unit of combined vinyl monomers may include olefins (ethylene, propylene, isoprene, vinyl chloride, vinylidene chloride, etc.), acryl acid esters (acryl acid methyl, acryl acid ethyl, acryl acid 2-ethylhexyl, acryl acid 2-hydroxyethyl, etc.), methacryl acid esters (methacryl acid methyl, methacryl acid ethyl, methacryl acid butyl, methacryl acid 2-hydroxyethyl, etc.), styrene derivatives (styrene, p-hydroxymethylstyrene, p-methoxystyrene, etc.), vinyl esters (methylvinylether, ethylvinylether, cyclohexylvinylether, hydroxyethylvinylether, hydroxybutylvinylether, etc.), vinylesters (acetate vinyl, propionic acid vinyl, cinnamic acid vinyl, etc.), unsaturated carboxylic acid (acrylic acid, methacrylic acid, crotonic acid, maleic acid, itaconic aicd, etc.), acrylamides (N,N-dimethylacrylamide, N-tert-butylacrylamide, N-cyclohexylacrylamide, etc.), methacrylamides (N,N-dimethylmethacrylamide, etc.), acrylonitrile, etc.

Fluorine-contained polymer particularly useful in the invention is random copolymer of perfluoroolefin and vinyl ethers or vinyl esters. It is particularly preferable that the fluorine-contained polymer has a group which can be solely crosslinked (for example, a radical reactive group such as a (meta)acryloyl group, a ring-opening polymeric group such as an epoxy group or an oxetanile group, etc.). These crosslinked group-contained polymeric units occupy preferably 5 to 70 mol %, more preferably 30 to 60 mol % of all polymeric units of polymer. Preferable polymers are disclosed in JP-A-2002-243907, JP-A-2002-372601, JP-A-2003-26732, JP-A-2003-222702, JP-A-2003-294911, JP-A-2003-329804, JP-A-2004-4444 and JP-A-2004-45462.

In addition, it is preferable that a polysiloxane structure is introduced for the purpose of giving anti-smudge property to the fluorine-contained polymer of the invention. It is preferable that the polysiloxane structure is introduced according to a method of introducing a polysiloxane block copolymeric component using a silicon macro-azo initiator, for example, as disclosed in JP-A-6-93100, JP-A-11-189621, JP-A-11-228631 and JP-A-2000-313709 and a method of introducing a polysiloxane graft copolymeric component using a silicon macromer, for example, as disclosed in JP-A-2-251555 and JP-A-2-308806, without being limited thereto. A More preferable compound may include polymer disclosed in examples 1, 2 and 3 of JP-A-11-189621 and copolymers A-2 and A-3 disclosed in JP-A-2-251555. Polysiloxane components of these compounds are preferably 0.5 to 10 weight %, more preferably 1 to 5 weight % of polymer.

The weight mean molecular weight of polymer preferably used in the invention is preferably 5,000 or more, more preferably 10,000 to 500,000, most preferably 15,000 to 2,000,000. A surface of a coated film may be further improved or marring resistance may be further increased when polymers having different weight mean molecular weights are used together.

The above-mentioned polymer may be used along with a curing agent having a proper polymeric unsaturated group, as disclosed in JP-A-10-25388 and JP-A-2000-17028. In addition, it is preferable that the above-mentioned polymer is used along with compounds having a fluorine-contained multifunctional polymeric unsaturated group, as disclosed in JP-A-2002-145952. An example of the compound having the multifunctional polymeric unsaturated group may include the above-mentioned multifunctional monomer of the hard coat layer. Particularly when compounds having a polymeric unsaturated group included in a polymer body are used, scratch resistance can be greatly increased.

### 1-(4) Organosilane Compound

From a standpoint of scratch resistance, it is preferable that at least one of layers constituting the film of the invention contains at least one kind of component of hydrolysate and/or its partial condensate of an organosilane compound, which is so-called sol component (hereinafter, this term is sometimes used), in coated film solution forming the layer.

Particularly, in order to make the antireflection function compatible with the scratch resistance in the antireflection film, it is particularly preferable that a low refractive index layer and a functional layer contain the sol component together. The sol component becomes a part of a binder of the layer when coating solution is applied and condensed by a drying and heating process to form a cured product. In addition, if the cured product has polymeric unsaturated bond, a binder having a three-dimensional structure is formed by irradiation of active light.

It is preferable that the organosilane compound is expressed by the following formula 1.

(R¹)ₘ—Si(X)₄₋ₘ Formula 1:

In the formula 1, R1 is a substituted or non-substituted alkyl group or a substituted or non-substituted aryl group. The alkyl group is an alkyl group having, preferably 1 to 30 carbon atoms, more preferably 1 to 16 carbon atoms, particularly preferably 1 to 6 carbon atoms. An example of the alkyl group may include methyl, ethyl, propyl, isopropyl, hexyl, decyl, hexadecyl, etc. An example of the aryl group may include phenyl, naphthyl, etc., preferably the phenyl.

In the formula 1, X is a hydroxyl group or a hydrolysis group. For example, X may be an alkoxy group (preferably, an alkoxy group having 1 to 5 carbon atoms, such as a methoxy group or an ethoxy group), halogen atoms (for example, Cl, Br, I atoms, etc.), and a group represented by R²COO (R² is preferably a hydrogen atom or an alkyl group having 1 to 6 carbon atoms), for example, CH₃COO, C₂H₅COO, etc. X is preferably the alkoxy group, more preferably the methoxy group or the ethoxy group.

In the formula 1, m is an integer number of 1 to 3, preferably 1 to 2.

If R¹ or X is plural in number, a plurality of R¹s or Xs may be equal to or different from each other.

An example of a substitution group contained in R¹ may include a halogen atom (fluorine, chlorine, bromine atom, etc.), a hydroxyl group, a mercapto group, a carboxyl group, an epoxy group, an alkyl group (methyl, ethyl, i-propyl, propyl, t-butyl, etc.), an aryl group (phenyl, naphthyl, etc.), an aromatic heterocycle group (furyl, pyrazolyle, pyridyl, etc.), an alkylthio group (methythio, ethythio, etc.), an arylthio group (phenylthio, etc.), an alkenyl group (vinyl, 1-propenyl, etc.), an acyloxy group (acetoxy, acryloyloxy, methacryloyloxy, etc.), an alkoxycarbonyl group (methoxycarbonyl, ethoxycarbonyl, etc.), an aryloxycarbonyl group (phenoxycarbonyl, etc.), a carbamoyl group (carbamoyl, N-methylcarbamoyl, N,N-dimethylcarbamoyl, N-methyl-N-octylcarbamoyl, etc.), an acylamino group (acetylamino, benzoylamino, acrylamino, methacrylamino, etc.), etc., without being limited thereto. These substitution groups may be re-substituted.

It is preferable that the R¹ is a substituted alkyl group or a substituted aryl group.

It is preferable that the compound represented by the formula 1 is an organosilane compound having a vinyl polymeric substitution group represented by the following formula 2.

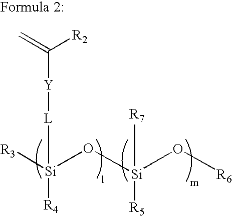

In the formula 2, R₂ is a hygrogen atom, a methyl group, a methoxy group, an alkoxycarbonyl group, a cyano group, a fluorine atom, or a chlorine atom. The alkoxycarbonyl group may include a methoxycarbonyl group, an ethoxycarbonyl group, etc. R² is preferably the hygrogen atom, the methyl group, the methoxy group, the methoxycarbonyl group, the cyano group, the fluorine atom and the chlorine atom, more preferably the hygrogen atom, the methyl group, the methoxycarbonyl group, the fluorine atom and the chlorine atom, particularly preferably the hygrogen atom and the methyl group.

In the formula 2, Y represents a single bond, or *—COO—**, *—CONH—**, or *—O—**, preferably the single bond, *—COO—** and *—CONH—**, more preferably the single bond and *—COO—**, particularly preferably *—COO—**. * represents a position of bond to ═C(R₂)— and ** represents a position of bond to L.

In the formula 2, L represents a bivalent chain. Specifically, L may include a substituted or non-substituted alkylene group, a substituted or non-substituted arylene group, a substituted or non-substituted alkylene group having a linkage group (for example, ether, ester, amide, etc.) therein and a substituted or non-substituted arylene group having a linkage group therein. L is preferably the substituted or non-substituted alkylene group, the substituted or non-substituted arylene group and the substituted or non-substituted alkylene group having the linkage group therein, more preferably the non-substituted alkylene group, the non-substituted arylene group and the alkylene group having the ether or ester linkage group therein, particularly preferably the non-substituted alkylene group and the alkylene group having the ether or ester linkage group therein. A substituted group may include halogen, a hydroxyl group, a mercapto group, a carboxyl group, an epoxy group, an alkyl group, an aryl group, etc. These substituted groups may be re-substituted.

In the formula 2, 1=100-m, and m represents a number between 0 and 50, preferably between 0 and 40, more preferably between 0 and 30.

In addition, R₃ to R₅ are preferably halogen atoms, hydroxyl groups, non-substituted alkoxy groups, or non-substituted alkyl groups, more preferably chlorine atoms, the hydroxyl groups, the non-substituted alkoxy groups having 1 to 6 carbon atoms, particularly preferably the hydroxyl groups, the non-substituted alkoxy groups having 1 to 3 carbon atoms, most preferably the hydroxyl groups or methoxy groups.

In addition, R₆ represents a hydrogen atom, an alkyl group, an alkoxy group, an alkoxycarbonyl group, a cyano group, a fluorine atom or a chlorine atom. The alkyl group may include a methyl group, an ethyl group, etc., the alkoxy group may include a methoxy group, an ethoxy group, etc., and the alkoxycarbonyl group may include a methoxycarbonyl group, an ethoxycarbonyl group, etc. R₆ is preferably the hydrogen atom, the methyl group, the methoxy group, the methoxycarbonyl group, the cyano group, the fluorine atom and the chlorine atom, more preferably the hydrogen atom, the methyl group, the methoxycarbonyl group, the fluorine atom and the chlorine atom, particularly preferably the hydrogen atom and the methyl group. R₇ is similar to R₁ in the above formula 1, more preferably a hydroxyl group or a non-substituted alkyl group, particularly preferably the hydroxyl group or a alkyl group having 1 to 3 carbon atoms, most preferably the hydroxyl group or a methyl group.

In the formula 2, if R₄, R₅ and R₇ are respectively plural in number, they may be respectively equal to or different from each other.

The compound in the formula I may be two or more kinds of compounds. Particularly, the compound in the formula 2 is synthesized with one or two kinds of compounds in the formula 1 as a starting material. In the following description, the compound in the formula 1 and the starting material of the compound in the formula 2 are illustrated, but not being limited thereto.

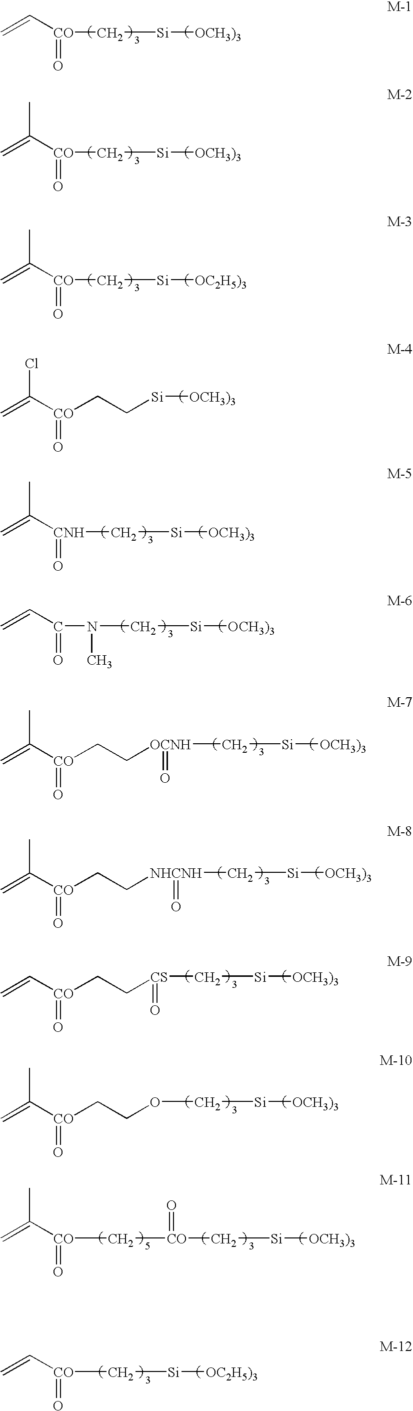

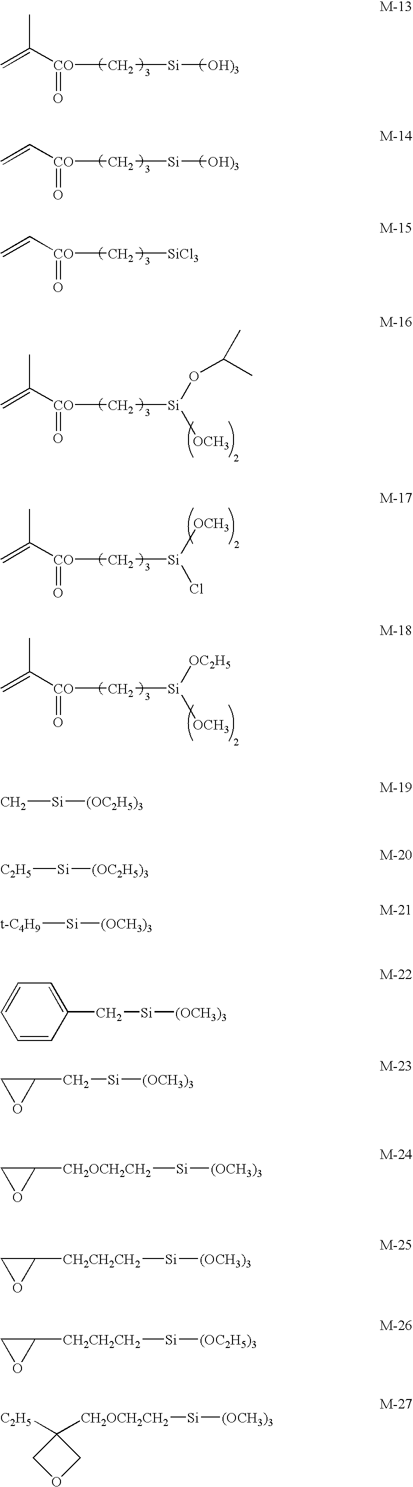

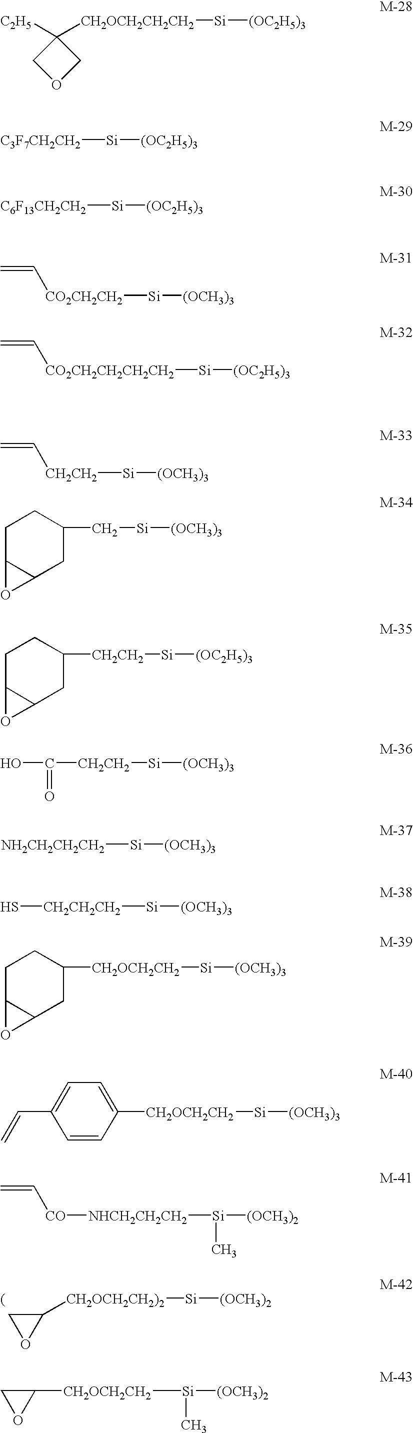

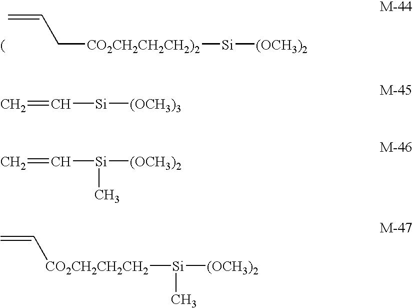

### M-48 Methyltrimethoxysilanes

Of the M-48 methyltrimethoxysilanes, (M-1), (M-2) and (M-25) methyltrimethoxysilanes are particularly preferable as an organosilane containing a polymeric group.

To obtain the effect of the invention, the content of organosilane containing the vinyl polymeric group in the hydrolysate and/or its partial condensate of the organosilane is preferably 30 to 100 weight %, more preferably 50 to 100 weight %, particularly preferably 70 to 100 weight %. When the content of organosilane containing the vinyl polymeric group is more than 30 weight %, no solid is produced, solution does not become muddy, and a pot life does not become deteriorated. In addition, the molecular weight can be easily controlled (that is, the molecular weight is not increased), and material property such as scratch resistance can be improved.

For synthesis of the compound in the formula 2, one of (M-1) and (M-2) methyltrimethoxysilanes is preferable as the organosilane containing the polymeric group and one of (M-19) to (M-21) and (M-48) methyltrimethoxysilanes is preferable as the organosilane containing no polymeric group, in combination with the above-mentioned content of organosilane.

It is preferable to suppress volatility of at least one of the hydrolysate and its partial condensate of the organosilane of the invention in order to stabilize performance of a coated film. Specifically, the amount of volatilization per hour at 105° C. is preferably less than 5 weight %, more preferably less than 3 weight %, particularly preferably less than 1 weight %.

The sol component used in the invention is made by hydrolyzing and/or partially condensing the organosilane.

The hydrolysis and condensation reaction is made when water of 0.05 to 2.0 mole, preferably 0.1 to 1.0 mol, is added to a hydrolysable group (X) of 1 mol and this mixture is agitated at 25 to 100° C. under existence of a catalyst used in the invention.

For at least one of the hydrolysate and its partial condensate of the organosilane of the invention, the weight mean molecular weight of one of the hydrolysate and its partial condensate of the organosilane containing the vinyl polymeric group is preferably 450 to 20,000, more preferably 500 to 10,000, particularly preferably 550 to 5,000, most preferably 600 to 3,000, except the weight mean molecular weight of less than 300.

A component having the molecular weight of more than 20,000 of components having the molecular weight of 300 or more in the hydrolysate and/or its partial condensate of the organosilane is preferably 10 weight % or less, more preferably 5 weight % or less, particularly preferably 3 weight % or less. When the component having the molecular weight of more than 20,000 is 10 weight % or less, a cured coated film obtained by curing a curable composition containing such hydrolysate and/or its partial condensate of the organosilane has good transparency and good adhesion to a substrate.

Here, the weight mean molecular weight and the molecular weight are a molecular weight expressed by a polystyrene conversion by solvent THF and detection of a differential refractometer by means of a GPC analyzer using a column of TSKgel GMHx1, TSKgel G4000Hx1 or TSKgel G2000Hx1 (all of which are available from Tosoh Corporation), and the content is an area % of a peak in the above-mentioned molecular weight range when a peak area of a component having the molecular weight of more than 300 is set to be 100%.

A degree of dispersion (weight mean molecular weight/number mean molecular weight) is preferably 3.0 to 1.1, more preferably 2.5 to 1.1, particularly preferably 2.0 to 1.1, most preferably 1.5 to 1.1.

The state that X in the formula 1 is condensed into a shape of —OSi can be confirmed by ²⁹Si-NMR analysis on the hydrolysate and its partial condensate of the organosilane of the invention.

Here, assuming that a case where three bonded Si atoms are condensed in a shape of —OSi is T3, a case where two bonded Si atoms are condensed in a shape of —OSi is T2, a case where one bonded Si atom is condensed in a shape of —OSi is T1, and a case where no Si atom is condensed is T0, a condensation rate α is expressed as follows.

α=(T3×3+T2×2+T1X1)/3/(T3+T2+T1+T0) Expression II:

The condensation rate α is preferably 0.2 to 0.95, more preferably 0.3 to 0.93, particularly preferably 0.4 to 0.9.

When the condensation rate α is 0.2 or more, sufficient curability is obtained, and when the condensation rate α is 0.95 or less, an interaction with a binder polymer, a resin substrate, inorganic particles, etc. can be enhanced.

Now, the hydrolysate and its partial condensate of the organosilane compound used in the invention will be described in more detail.

In general, the hydrolysis reaction of the organosilane and the subsequent condensation reaction are performed under existence of a catalyst. An example of the catalyst used may include inorganic acids such as hydrochloric acid, sulfuric acid, acetate or the like; organic acids such as oxalic acid, acetic acid, butyric acid, maleic acid, citric acid, formic acid, methanesulfonic acid, toluenesulfonic acid or the like; inorganic bases such as sodium hydroxide, potassium hydroxide, ammonium or the like; organic bases such as triethylamine, pyridine or the like; metal alkoxides such as triisopropoxyaluminium, tetrabutoxyzirconium, tetrabutyltitanate, dibutyltindilaurate or the like; metal chelate compounds containing Zr, Ti, Al or the like as center metal; a fluorine (F)-contained compound such as KF, NH₄F or the like; etc.

The catalyst may be used solely or plurally.

The hydrolysis and condensation reaction of the organosilane may be performed either in solvent or in a solvent-free state. However, it is preferable to use organic solvent, for example, alcohols, aromatic hydrocarbon atoms, ethers, ketones, esters, etc., in order to mix components uniformly.

It is preferable that the solvent dissolves the organosilane and the catalyst. In addition, from a standpoint of process, it is preferable that the organic solvent is used as coating solution or a portion of coating solution. In addition, when the organic solvent is mixed with other materials such as fluorine-contained polymer, it is desirable not to deteriorate solubility or dispersibility.

Of these organic solvents, an example of alcohols may include an monohydric alcohols or dihydric alcohols. An example of the monohydric alcohols may be preferably a saturated aliphatic alcohol having 1 to 8 carbon atoms.

An example of these alcohols may include methanol, ethanol, n-propylalcohol, i-propyl alcohol, n-bytylalcohol, sec-butylalcohol, tert-butylalcohol, ethylene glycol, diethylene glycol, triethylene glycol, ethyleneglycol monobutylether, acetic acid ethyleneglycol monoethylether, etc.

In addition, an example of the aromatic hydrocarbon atoms may include benzene, toluene, xylene, etc., an example of ethers may include tetrahydrofuran, dioxane, etc., an example of ketones may include acetone, methylethylketone, methyisobutylketone, diisobutyleketone, cyclohexanone, etc., and an example of esters may include ethyl acetate, propyl acetate, butyl acetate, propylene carbonate, etc.

These organic solvents may be used solely or in mixture thereof. The concentration of solid in the reaction typically falls within a range of 1 to 100%, without being limited thereto.

The reaction is made when water of 0.05 to 2.0 mole, preferably 0.1 to 1.0 mol, is added to a 1 mol-hydrolysable group of the organosilane and this mixture is agitated at 25 to 100° C. under existence of the solvent or with no solvent and under existence of a catalyst.

In the invention, it is preferable that the hydrolysis reaction is performed when the mixture is agitated at 25 to 100° C. under existence of at least one kind of metal chelate compound containing one selected from Zr, Ti and Al as center metal, with alcohol represented by a formula R³OH (R³ represents an alkyl group having 1 to 10 carbon atoms) and compound represented by a formula R⁴COCH₂COR⁵ (R⁴ represents an alkyl group having 1 to 10 carbon atoms and R⁵ represents an alkyl group having 1 to 10 carbon atoms or an alkoxy group having 1 to 10 carbon atoms) as ligands.

Or if a fluorine-contained compound having capability for complete hydrolysis and condensation is used as the catalyst, it is possible to determine a degree of polymerization and set a molecular weight randomly. That is, in order to adjust the hydrolysate/its partial condensate of the organosilane having an average degree of polymerization of M, water of (M-1) mol may be used for the hydrolysable organosilane of M mol.

The metal chelate compound is not particularly limited if only it contains one selected from Zr, Ti and Al as center metal, with alcohol represented by a formula R³OH (R³ represents an alkyl group having 1 to 10 carbon atoms) and compound represented by a formula R⁴COCH₂COR⁵ (R⁴ represents an alkyl group having 1 to 10 carbon atoms and R⁵ represents an alkyl group having 1 to 10 carbon atoms or an alkoxy group having 1 to 10 carbon atoms) as ligands. The metal chelate compound used in the invention is preferably one selected from the group consisting of compounds represented by formulae Zr(OR³)ₚ₁(R⁴COCHCOR⁵)ₚ₂, Ti(OR³)_{q1}(R⁴COCHCOR⁵)_{q2} and Al(OR³)ᵣ₁(R⁴COCHCOR⁵)ᵣ₂. The metal chelate compound acts to promote condensation reaction of the hydrolysate and its partial condensate of the organosilane compound.

In the metal chelate compound, R³ and R⁴ may be equal to or different from each other. R³ and R⁴ may be an alkyl group having 1 to 10 carbon atoms, for example, an ethyl group, an n-propyl group, an i-propyl group, an n-butyl group, a sec-butyl group, a t-butyl group, an n-pentyl group, a phenyl group, etc. In addition, R⁵ may be an alkoxy group having 1 to 10 carbon atoms, for example, a methoxy group, an ethoxy group, an n-propoxy group, an i-propoxy group, an n-butoxy group, a sec-butoxy group, a t-butoxy group, etc., in addition to the alkyl group having 1 to 10 carbon atoms. In addition, p1, p2, q1, q2, r1 and r2 in the metal chelate compound are 0 or positive integer numbers determined by the following equations: p1+p2=4, q1+q2=4, and r1+r2=3.

An example of the metal chelate compound may include:

a zirconium chelate compound such as tri-n-butoxyethylacetoacetatezirconium, di-n-butoxybis(ethylacetoacetatezirconium)zirconium, n-butoxytris(ethylacetoacetatezirconium)zirconium, tetrakis(n-propylacetoacetate)zirconium, tetrakis(acetylacetoacetate)zirconium, tetrakis(ethylacetoacetate)zirconium or the like;

a titanium chelate compound such as diisopropoxy-bis(ethylacetoacetate)titanium, diisopropoxy-bis(acetylacetoacetate)titanium, diisopropoxy-bis(acetylacetone)titanium or the like;

an aluminum chelate compound such as diisopropoxyethylacetoacetatealuminum, diisopropoxyacetylacetonatealuminum, isopropoxybis(ethylacetoacetate)aluminum, isopropoxybis(acetylacetonate)aluminum, tris(ethylacetoacetate)aluminum, tris(acetylacetonate)aluminum, monoacetylacetonate-bis(ethylacetoacetate)aluminum or the like; etc.

It is preferable that the metal chelate compound is tri-n-butoxyethylacetoacetatezirconium, diisopropoxy-bis(acetylacetoacetate)titanium, diisopropoxyethylacetoacetatealuminum, and tris(ethylacetoacetate)aluminum. These metal chelate compound may be used solely or plurally. In addition, partial hydrolysate of these metal chelate compound may be used.

The metal chelate compound is used at a rate of, preferably 0.01 to 50 weight %, more preferably 0.1 to 50 weight %, particularly preferably 0.5 to 50 weight %, of the organosilane compound. When the metal chelate compound is used in this range, the condensation reaction of the organosilane compound is fast, durability of a coated film, and conservation stability of a composition containing the hydrolysate and its partial condensate of the organosilane compound is improved.

It is preferable that at least one of a β-diketone compound and a β-ketoester compound is added to the coating solution used in the invention, in addition to the composition containing the sol compound and the metal chelate compound, which will be further described below.

In the invention, at least one of the β-diketone compound and the β-ketoester compound, which are expressed by a formula R⁴COCH₂COR⁵, is used to act as stability enhancer of the composition used in the invention. That is, when at least one of the β-diketone compound and the β-ketoester compound is coordinate-bonded to metal atoms of the metal chelate compound (at least one of zirconium, titanium and aluminum compounds), the metal chelate compound suppresses the condensation reaction of the hydrolysate and its partial condensate of the organosilane compound while improving the conservation stability of an obtained composition. R⁴ and R⁵ in the β-diketone compound and the β-ketoester compound are respectively equal to R⁴ and R⁵ in the metal chelate compound.

An example of the β-diketone compound and the β-ketoester compound may include acetylacetone, acetoacetatemethyl, acetoacetateethyl, acetoacetate-n-propyl, acetoacetate-i-propyl, acetoacetate-n-butyl, acetoacetate-sec-butyl, acetoacetate-t-butyl, 2,4-hexane-dione, 2,4-heptane-dione, 3,5-heptane-dione, 2,4-octane-dione, 2,4-nonane-dione, 5-methyl-hexane-dione, etc. The β-diketone compound and the β-ketoester compound are preferably acetoacetateethyl and acetylacetone, particularly preferably acetylacetone. The β-diketone compound and the β-ketoester compound may be used solely or plurally. In the invention, the β-diketone compound and the β-ketoester compound are used with, preferably 2 mol or more, more preferably 3 to 30 mol, for the metal chelate compound of 1 mol. When the metal chelate compound of 2 mol or more is used, the conservation stability of the obtained composition is improved.

It is preferable that the content of the hydrolysate and its partial condensate of the organosilane compound is small for the antireflection layer which is relatively thin, while being large for the hard coat layer or the antiglare layer which is relatively thick. In consideration of effect, refraction invex, shape and surface of film, etc., the content are preferably 0.1 to 50 weight %, more preferably 0.5 to 30 weight %, most preferably 1 to 15 weight %, of all solids of a layer containing the hydrolysate and its partial condensate of the organosilane compound (an addition layer).

### 1-(5) Initiator

Monomer containing various ethylenically unsaturated groups may be polymerized by ionizing radiation or heating under existence of photo-radical initiator or thermal-radical initiator.

When a film of the invention is made, the photo-radical initiator or the thermal-radical initiator may be used together.

<Photo-Radical Initiator>

An example of the photo-radical initiator may include acetophenones, benzoins, benzophenones, phosphineoxides, ketals, antraquinones, thioxanthones, azo compounds, proxides (JP-A-2001-139663), 2,3-dialkyldion compounds, disulfide compounds, fluoroamine compounds, aromatic sulfoniums, lophine dimmers, onium salts, borate salts, active esters, active halogens, inorganic complexes, coumalins, etc.

An example of the acetophenones may include 2,2-dimethoxyacetophenone, 2,2-diethoxyacetophenone, p-dimethylacetophenone, 1-hydroxy-dimethylpenylketone, 1-hydroxy-dimethyl-p-isopropylpenylketone, 1-hydroxycyclohexylpenylketone, 2-methyl-4-methylthio-2-morpholinopropiophenone, 2-benzil-2-dimethyamino-1-(4-morpholinopenyl)-butaneon, 4-phenoxydichloroacetophenone, 4-t-butyl-dichloroacetophenone, etc.

An example of the benzoins may include benzoin, benzoinmethylether, benzoinethylether, benzoinisopropylether, benzildimethylketal, benzoinbenzenesulfonic acid ester, benzointoluenesulfonic acid ester, etc., preferably the benzoinmethylether, the benzoinethylether and the benzoinisopropylether. An example of the benzophenones may include benzophenone, hydroxybenzophenone, 4-benzoyl-4′-methyidipenylsulfide, 2,4-dichlorobenzophenone, 4,4-dichlorobenzophenone, p-chlorobenzophenone, 3,3′-dimethylaminobenzophenone (Michler's ketone), 3,3′,4,4′-tetra(t-butylperoxiycarbonyl)benzophenone, etc.

An example of the borate salts may include organic borate compounds disclosed in Japanese Patent No. 2764769, JP-A-2002-116539, and an article authored by Kunz, Martin and published in “Rad Tech'98. Proceeding April, pages 19-22, 1998, Chicago.” Particularly, the compounds described in paragraphs (0022) to (0027) of JP-A-2002-116539 may be advantageously used as the borate salts. In addition, an example of an organoboron compound may include organic boron transition metal coordination complexes or the like, particularly, ion complexes with cation pigment, which is disclosed in JP-A-6-348011, JP-A-7-128785, JP-A-7-140589, JP-A-7-306527, JP-A-7-292014, etc.

An example of the phosphineoxides may include 2,4,6-trimethylbenzoyldipenylphosphineoxide.

An example of the active esters may include 1,2-octanedion, 1-(4-(penylthio)-, 2-(O-benzoyloxime)), sulfonic acid esters, cyclic active ester compound, etc.

Specifically, the active esters are particularly preferably compounds 1 to 21 disclosed in examples of JP-A-2000-80068.

An example of the onium salts may include aromatic diazonium salt, aromatic iodonium salt, aromatic sulfonium slat, etc.

An example of the active halogens may include compounds, particularly, oxazole compound having substituted trihalomethyl group : s-triazine compound, which is disclosed in “Wakabayashi, et al. “Bull Chem. Soc Japan” Vol 42, page 2924, 1996”, U.S. Pat. No. 3,905,815, JP-A-5-27831, “M. P. Hutt “Jurnal of Heterocyclic Chemistry” Vol 1 (number 3), 1970”. More particularly, the active halogens may be s-triazine derivatives having a s-triazine ring to which at least one of mono-, di- and tri-halogen substitution methyl groups is bonded. An example of the s-triazine derivatives may include S-triazine or oxathiazole compounds, particularly, 2-(p-methoxypenyl)-4,6-bis(tricrolmethyl)-s-triazine, 2-(p-styrylpenyl)-4,6-bis(tricrolmethyl)-s-triazine, 2-(3-Br-4-di(ethylacetateester)amino)penyl)-4,6-bis(tricrolmethyl)-s-triazine, 2-trihalomethyl-5-(p-methoxypenyl)-1,3,4-oxadiazole, etc. Specifically, the s-triazine derivatives are preferably compounds which are described in p 14-30 of JP-A-58-15503, p 6-10 of JP-A-55-77742, p 287 (No. 1-No. 1-No. 8) of JP-A-60-27673, p 443-444 (No. 1-No. 17) of JP-A-60-239736, No. 1-No. 19 of U.S. Pat. No. 4,701,399, etc.

An example of the inorganic complexes may include bis(η⁵-2,4-cyclophentadien-1-il)-bis(2,6-difluoro-3-(1H-pyrol-1-il)-phenyl)titanium.

An example of the coumalins may include 3-ketocoumalin.

These photo-radical polymer initiators may be used solely or in combination.

In addition, various examples of photo-radical polymer initiators useful for the invention are described in “The newest UV curing technology”, “Technology and information association Co., Ltd., p 159, 1991”, ““UV curing system” authored by K. Kato (published by General technology center, p 65-148, 1989”.

An example of the photo-radical polymer initiator may include KAYACURE (DETX-S, BP-100, BDMK, CTX, BMS, 2-EAQ, ABQ, CPTX, EPD, ITX, QTX, BTC, MCA, etc.) which is available from Nippon Kayaku Co., Ltd., IRGACURE (651, 184, 500, 819, 907, 369, 1173, 1870, 2959, 4265, 4263, etc.) which is available from Ciba Specialty Chemicals Co., Ltd., ESACURE (KIP100F, KB1, EB3, BP, X33, KT046, KT37, KIP150, TZT, etc.) which is available from Sartomer Company Inc., and a combination thereof.

The photo-radical polymer initiator is used within a range of, preferably 0.1 to 15 weight %, more preferably 1 to 10 weight %, of multifunctional monomer of 100 weight %.

<Photosensitizer>

Photosensitizer may be used in addition to the photo-radical polymer initiator. An example of the photosensitizer may include n-butylamine, triethylamine, tri-n-butylphosphine, Michler's ketone, thioxanetone, etc.

In addition, as the photosensitizer, azide compound, thiourea compound, mercapto compound, etc. may be used in one or more combinations.

Available photosensitizer may include KAYACURE (DMBI, EPA, etc.) available from Nippon Kayaku Co., Ltd.

<Thermal-Radical Initiator>

Organic or inorganic peroxide, organic azo and diazo compounds, etc. may be used as the thermal-radical initiator.

Specifically, an example of the organic peroxide may include benzoyl peroxide, halogenbenzoyl peroxide, lauroyl peroxide, acetyl peroxide, dibutyl peroxide, cumenehydrofeloxide, butylhydrofeloxide, etc. An example of the inorganic peroxide may include hydrogen peroxide, ammonium persulphate, potassium persulphate, etc. An example of the azo compound may include 2,2′-azobis(iso-butyronitrile, 2,2′-azobis(propionitrile, 1,1′-azobis(cyclohexanecarbonitrile, etc. An example of the diazo compound may include diazoaminobenzene, p-nitrobenzenediazonium, etc.

### 1-(6) Crosslinked Compound

If the monomer or polymer binder of the invention does not sufficient curability solely, crosslinked compound may be added to the monomer or polymer binder to obtain required curability.

For example, if a polymer body contains a hydroxyl group, it is preferable that various amino compounds are used as curing agent. An example of the amino compounds used as the crosslinked compound may include compounds containing one or both of a hydroxyalkylamino group and an alkoxyalkylamino group, particularly a melamine compound, a urea compound, a benzoguanamine compound, a glycoluryl compound, etc.

The melamine compound is commonly known as a compound having a skeleton in which nitrogen atoms are bonded to a triazine ring. Specifically, an example of the melamine compound may include melamine, alkylated melamine, methylolmelamine, alkoxylated methylmelamine, ect. It is preferable that the melamine compound contains one or both of a methylol group or an alkoxylated methyl group in one molecule. It is more preferable that the melamine compound is methylolated melamine, alkoxylated methylmelamine, or derivatives thereof, which is obtained by reacting melamine with formaldehyde under a basic condition. It is particularly preferable that the melamine compound is the alkoxylated methylmelamine in that a curable resin composition has good conservation stability and reactivity. The methylolated melamine and the alkoxylated methylmelamine used as the crosslinked compound are not particularly limited. For example, as methylolated melamine and the alkoxylated methylmelamine, various resin precuts obtained by the method disclosed in a document ┌Plastic material lecture(8)urier.melamine resin┘ (Nikkan Kogyo Shinbun, Ltd.).

In addition, an example of the urea compound may include urea, polymethylolated urea, alkoxylated methyl urea, which is a derivative thereof, methylolated uron and alkoxylated methyluron which have an uronic ring, etc. In addition, various resin products described the above document may be used as a compound such as a urea derivative and the like.

The crosslinked compound is preferably 2 to 50 weight %, more preferably 5 to 40 weight %, particularly preferably 10 to 30 weight %, of the monomer or polymer binder.

### 1-(7) Curing Catalyst

For the film of the invention, radical or acid produced by ioninzing radiation or heating may be used as a curing catalyst to promote curing.

<Thermal Acid Generator>

An example of a thermal acid generator may include various aribhatic sulfonic acids and salt thereof, various aribhatic carboxyl acids, such as citric acid, acetic acid, maleic acid and the like, and salt thereof, various aromatic carboxyl acids, such as benzo, phthalic acid and the like, and salt thereof, alkylbenzenesulfonic acid and ammonium and amine salt thereof, various metal salts, phosphate, phosphate ester of organic acid, etc.

Available thermal acid generators may include products available from Nihon Cytec Industries Inc., such as Catalyst4040, Catalyst4050, Catalyst600, Calalyst602, Catalyst500, Catalyst296-9, products available from King Corporation, such as NACURE series 155, 1051, 5076 and 4054J, and NACURE series 2500, 5225, X49-110, 3525 and 4167 which are block types thereof, etc.

The thermal acid generator is preferably 0.01 to 10 weight %, more preferably 0.1 to 5 weight %, of the curable resin composition of 100 weight %. With this addition range, the curable resin composition has good conservation stability and scratch resistance.

<Photosensitive Acid Generator or Photoacid Generator>

Now, a photoacid generator will be described in detail below.

An example of an acid generator may include a photo initiator of photo cation polymerization, a photoerasable agent and photochromic agent of pigments, known acid generators using microresists, or other known compounds, such as an organic halogen compound, a disulfone compound, an onium compound and the like, and mixtures thereof. An example of the organic halogen compound and disulfone compound may include compounds generating the radicals.

An example of the photosensitive acid generator may include (1) various onium salts such as iodonium salt, sulfonium salt, phosphonium salt, diazonium salt, ammonium salt, pyridinium salt or the like; (2) sulfone compounds such as β-ketoester, β-sulfonylsulfone and α-diazo compounds thereof or the like; (3) sulfonic acid esters such as alkylsulfonic acid, haloalkylsulfonic acid ester, arylsulfonic acid ester, iminosulfonate or the like; (4) sulfoneimide compounds; and (5) diazomethane compounds.

An example of the ionium compound may include diazonium salt, ammonium salt, iminium salt, phosphonium salt, iodine salt, sulfonium salt, alsonium salt, selenonium salt, etc. Of these salts, the diazonium salt, the iodonium salt, the sulfonium salt and the iminium salt are preferable from a standpoint of photosensitivity of photopolymerization initiation and stability of compound material. For example, compounds described in paragraphs (0058) and (0059) of JP-A-2002-29162 are preferable as the ionium compound.

The photosensitive acid generator is preferably 0.01 to 10 weight %, more preferably 0.1 to 5 weight %, of the curable resin composition of 100 weight %.

In addition, details of the compounds and usage are described in JP-A-2005-43876, for example.

### 1-(8) Translucent Particles

Various translucent particles give antiglare (surface scattering) and internal scattering to the film of the invention, particularly the antiglare layer or the hard coat layer.

The translucent particles may be either organic particles or inorganic particles. A little irregular distribution of particle diameter has a little irregular distribution of scattering characteristic, thereby facilitating a haze value design. Plastic beads are suitable for the translucent particles. It is preferable that the translucent particles have high transparency and a refractive index with the binder having the above mentioned numerical values.

An example of the organic particles include polymethylmethacrylate particles (refractive index of 1.49), crosslinked poly(acryl-styrene) copolymeric particles (refractive index of 1.54), melamine resin particles (refractive index of 1.57), polycarbonate particles (refractive index of 1.57), polystyrene particles (refractive index of 1.60), crosslinked polystyrene particles (refractive index of 1.61), polyvinyl chloride particles (refractive index of 1.60), benzoguanamine-melamineformaldehyde particles (refractive index of 1.68), etc.

An example of the inorganic particles may include silica particles (refractive index of 1.44), alumina particles (refractive index of 1.63), zirconia particles, titania particles, hollow or porous inorganic particles, etc.

It is particularly preferable that the translucent particles are crosslinked polystyrene particles, crosslinked poly((meta)acrylate) particles, crosslinked poly(acrylstyrene) particles. When the refractive index of the binder is adjusted to a refractive index of one selected from these particles, internal haze, surface haze and center-line average roughness of the invention can be attained.

In addition, it is preferable to use a combination of a binder (after cured, refractive index of 1.50 to 1.53) having (meta)acrylatemonomer with 3 or more functional groups, as a main component, and translucent particles formed of crosslinked poly(meta)acrylate polymer having acryl of 50 to 100 weight %, particularly a combination of the binder and translucent particles (refractive index of 1.48 to 1.54 formed of crosslinked poly(styrene-acryl) copolymer.

In the invention, the refractive index of the binder (translucent resin) and the translucent particles is preferably 1.45 to 1.70, more preferably 1.48 to 1.65. This refractive index range may be obtained when the kind and weight percentage of the binder and the translucent particles are appropriately selected. The way to select the kind and weight percentage of the binder and the translucent particles can be foreknown experimentally.

In the invention, in addition, the absolute value of a difference in refractive index between the binder and the translucent particles (the refractive index of the translucent particles—the refractive index of the binder) is preferably 0.001 to 0.030, more preferably 0.001 to 0.020, particularly preferably 0.001 to 0.015. When the absolute value of this difference is more than 0.030, there arises no problem of film character breaking, deterioration of dark room contrast, surface white turbid, etc.

Here, the refractive index of the binder can be quantitatively estimated by directly measuring it using an Abbe refractometer or measuring spectral reflection spectrum or spectral ellipsometry. The refractive index of the translucent particles is measured by measuring turbidity of translucent particles equivalently dispersed in solvent having a refractive index changed by varying a mixture ratio of two kinds of solvents having different refractive indexes, and specifying the refractive index of the solvent using the Abbe refractometer when the turbidity becomes minimal.

Since the above-mentioned translucent particles are apt to be sunk in the binder, inorganic filler such as silica may be added in order to prevent the translucent particles from being sunk in the binder. In addition, the increase of the addition amount of the inorganic filler has an adverse effect on the transparency of a coated film although it is effective in preventing the translucent particles from being sunk in the binder. Accordingly, it is preferable that the inorganic filler having diameter of 0.5 μm or less are less than 0.1 weight % of the binder such that the transparency of the coated film is not deteriorated.

An average diameter of the translucent particles is preferably 0.5 to 10 μm, more preferably 2.0 to 8.0 μm. When the average diameter is 0.5 μm or more, a light scattering angle distribution is not spread, thereby causing no problem of character breaking of a display. When the average diameter is 10 μm or less, there is no need to thicken an additional layer, thereby causing no problem of curl and rise of cost.

In addition, two or more kinds of translucent particles having different diameters may be used together.

In addition, the density of the translucent particles is preferably 10 to 10,000 mg/m², more preferably 100 to 700 mg/m².

<Preparation of translucent Particles, Classification>

The translucent particles related to the invention may be prepared using any of a suspension polymerization method, an emulsion polymerization method, soap-free emulsion polymerization method, a dispersion polymerization, a seed polymerization, etc. These polymerization methods are disclosed in “Method of experiment of polymer synthesis” (coauthored by T. Otsu and M. Kinoshita, Kagaku-Dojin Publishing Company, Inc., p 130, 146 and 147), “synthetic polymer” (Vol. 1, p 246-290, Vol. 2, p 1 to 108), Japanese Patent Nos. 2543503, 3508304, 2746275, 3521560 and 3580320, and JP-A-10-1561, JP-A-7-2908, JP-A-5-297506, JP-A-2002-145919, etc.

It is preferable that the size distribution of the translucent particles has monodispersity from a standpoint of control of haze value and diffusivity, and surface homogeneity of a coated film. For example, assuming that particles having a diameter larger by 20% than an average diameter are coarse particles, a percentage of the coarse particles is preferably 1% or less of all particles, more preferably 0.1% or less of all particles, particularly preferably 0.01% or less of all particles. It is effective to classify the particles having such a size distribution after the preparation or a synthesis reaction. Particles having a desired size distribution can be obtained by increasing the number of times of classification or intensifying a classification level.

The classification may preferably include an air classification method, a centrifugal classification method, a precipitation classification method, a filtering classification method, an electrostatic classification method, etc.

### 1-(9) Inorganic Particles

In the invention, various kinds of inorganic particles may be used to improve physical properties such as hardness and optical characteristics such as reflectance and scatterability.

An example of the inorganic particles may include oxides having at least one selected from silicon, zirconium, titanium, aluminum, indium, zinc, tin and antimony, for example, ZrO₂, TiO₂, Al₂O₃, In₂O₃, ZnO, SnO₂, Sb₂O₃, ITO, etc. In addition, the inorganic particles may include BaSO₄, CaCO₃, talc, kaolin, etc.

It is preferable that the diameter of the inorganic particles used in the invention is as small as possible in a dispersed medium. For example, a weight-average diameter of the inorganic particles is 1 to 200 nm, preferably 5 to 150 nm, more preferably 10 to 100 nm, particularly preferably 10 to 80 nm. When the diameter of the inorganic particles is 100 nm or less, it is possible to form a film without deterioration of transparency. The diameter of the inorganic particles may be measured using a light scattering method or an electron microscopic photograph.

The specific surface area of the inorganic particles is preferably 10 to 400 m²/g, more preferably 20 to 200 m²/g, most preferably 30 to 150 m²/g.

It is preferable that the inorganic particles used in the invention are added to coating solution of a layer used as dispersion in the dispersed medium.

It is preferable that the dispersed medium of the inorganic particles use liquid having a boiling point of 60 to 170° C . An example of the dispersed medium may include water, alcohol (for example, methanol, ethanol, isopropanol, butanol, benzilalcohol, etc.), ketone (for example, acetone, methylethylketone, methylisobutylketone, cyclohexanone, etc.), ester (for example, methyl acetate, ethyl acetate, propyl acetate, butyl acetate, methyl formate, ethyl formate, propyl formate, butyl formate, etc.), aribhatic hydrocarbon (for example, hexane, cyclohexane, etc.), halogenated hydrocarbon (for example, methylenechloride, chloroform, carbon tetrachloride, etc.), aromatic hydrocarbon (for example, benzene, toluene, xylene, etc.), imide (for example, dimethylformamide, dimethylacetamide, n-methylpyrrolidone, etc.), ether (for example, diethylether, dioxane, tetrahydrofuran, etc.), etheralcohol (for example, 1-methoxy-2-propanol, etc.), etc. The dispersed medium is more preferably toluene, xylene, methylethylketone, methylisobutylketone, cyclohexanone and the butanol, particularly preferably methylethylketone, methylisobutylketone and cyclohexanone.

The inorganic particles are dispersed by means of a dispersion apparatus. An example of the dispersion apparatus may include a sand grinder mill (for example, pin-quipped beads mill), a fast impeller-mill, a pebble mill, a roller mill, artwriter, an atoritor, a colloid mill, etc. Of these apparautuses, the sand grinder mill and the fast impeller-mill are particularly preferable. In addition, a preliminary dispersion process may be performed. An example of a dispersion apparatus used for the preliminary dispersion process may include a ball mill, a three-roll mill, a kneader, an extruder, etc.

<High Refractive Index Particles>

For the purpose of raising a refractive index of a layer in the invention, it is preferable to use a cured product of a composition in which inorganic particles having a high refractive index are dispersed in a monomer initiator and an organo substituted silicon compound. In this case, it is particularly preferable that ZrO₂, TiO₂ or the like is used for the inorganic particles from a standpoint of refractive index. For the purpose of raising the refractive index of the hard coat layer, it is most preferable that ZrO₂ particles and TiO₂ particles are used for a high refractive index layer and a medium refractive index layer, respectively.

It is particularly preferable that the TiO₂ particles are inorganic particles having TiO₂ containing at least one selected from cobalt, aluminum and zirconium, as a main component. The main component means a component, which has the maximum content (weight %), of components of particles.

In the invention, the refractive index of particles having TiO₂ as the main component is preferably 1.90 to 2.80, more preferably 2.10 to 2.80, most preferably 2.20 to 2.80.

A weight average diameter of primary particles of the particles having TiO₂ as the main component is preferably 1 to 200 nm, more preferably 1 to 150 nm, particularly preferably 1 to 100 nm, most preferably 1 to 80 nm. A crystal structure of the particles having TiO₂ as the main component is preferably a rutile structure, a rutile/anatase mixture structure, an anatase structure, an amorphous structure or the like, as a main component, particularly preferably the rutile structure. Here, the main component means a component, which has the maximum content (weight %), of components of particles.

When the particles having TiO₂ as the main component contain at least one selected from Co (cobalt), Al (aluminum) and Zr (zirconium), photocatalyst activation of TiO₂ can be suppressed, thereby improving weather resistance of the film of the invention.

It is particularly preferable that the particles having TiO₂ as the main component contain Co (cobalt). It is also preferable that the particles are used in combination of two or more of these elements.

The inorganic particles having TiO₂ as the main component may be surface-treated to have a core/shell structure as described in JP-A-2001-166104.

The amount of addition of the monomer or inorganic particles of the layer is preferably 10 to 90 weight %, more preferably 20 to 80 weight % of the total weight of the binder. Two or more kinds of inorganic particles may be used in the layer.

<Low Refractive Index Particles>

Inorganic particles contained in a low refractive index layer preferably have low refractive index particles, for example, magnesium fluoride or silica particles. It is particularly preferable that the inorganic particles are the silica-particles from a standpoint of refractive index, dispersion stability and costs.

An average diameter of the silica particles is preferably 30% to 150%, more preferably 35% to 80%, particularly preferably 40% to 60% of the thickness of the low refractive index layer. For example, if the thickness of the low refractive index layer is 100 nm, the diameter of the silica particles is preferably 30 nm to 150 nm, more preferably 35 nm to 80 nm, particularly 40 nm to 60 nm.

Here, the average diameter of the inorganic particles is measured by a Coulter counter.

This range of the diameter of the silica particles is preferable from a standpoint of improvement of scratch resistance, fine unevenness of a surface of the low refractive index layer, high blackness, integrated reflectance, etc. The silica particles may be either crystalline or amorphous. In addition, although the silica particles are monodispersed particles, the silica particles may be agglomerated particles if only the agglomerated particles have a specified diameter. The silica particles have most preferably a spherical shape, but may have an indeterminate shape.

In addition, it is preferable that at least one kind of silica particles whose average diameter is less than 25% of the thickness of the low refractive index layer (hereinafter referred to as small diameter silica particles) is used along with silica particles having the above-mentioned diameter range (hereinafter referred to as large diameter silica particles).

Since the small diameter silica particles are present among the large diameter silica particles, the small diameter silica particles can act as maintenance agent of the large diameter silica particles.

If the thickness of the low refractive index layer is 100 nm, the average diameter of the small diameter silica particles is preferably 1 nm to 20 nm, more preferably 5 nm to 15 nm, particularly preferably 10 nm to 15 nm. From a standpoint of material costs and a maintenance agent effect, it is preferable to use these silica particles.

The amount of coating of the low refractive index particles is preferably 1 mg/m² to 100 mg/m², more preferably 5 mg/m² to 80 mg/m², particularly preferably 10 mg/m² to 60 mg/m². If it is too small, an effect of improvement of scratch resistance is reduced, and if it is too large, fine unevenness is formed on the surface of the low refractive index layer, thereby deteriorating the high blackness and the integrated reflectance.

<Hollow Silica Particles>

For the purpose of further lowering a refractive index, it is preferable to use hollow silica particles.

The refractive index of the hollow silica particles is preferably 1.15 to 1.40, more preferably 1.17 to 1.35, most preferably 1.17 to 1.30. The refractive index used herein represents an overall refractive index of particles, not a refractive index of outer shell silica forming the hollow silica particles. In this case, assuming that a radius of cavity of the particles is a and a radius of outer shell of the particles is b, a porosity x indicated by the following expression VIII is preferably 10 to 60%, more preferably 20 to 60%, most preferably 30 to 60%. If the hollow silica particles have a lower refractive index and a higher porosity, the outer shell of the particles becomes thinner, thereby weakening the strength of the particles. Accordingly, from a standpoint of scratch resistance, it the hollow silica particles have a low refractive index of 1.15 or more.

x=(4πa³/3)/(4πa³/3)×100 (Expression VIII)

A method of manufacturing the hollow silica particles is disclosed in, for example, JP-A-2001-233611 and JP-A-2002-79616. It is particularly preferable that the hollow silica particles are particles having cavity in the interior of their shells having fine blocked holes. In addition, the refractive index of the hollow silica particles may be calculated by a method disclosed in JP-A-2002-79616.

The amount of coating of the hollow silica particles is preferably 1 mg/m² to 100 mg/m², more preferably 5 mg/m² to 80 mg/m², particularly preferably 10 mg/m² to 60 mg/m². When the amount of coating is more than 1 mg/m², effects of the low refractive index and scratch resistance are improved, and when the amount of coating is 100 mg/m² or less, fine unevenness is not formed on the surface of the low refractive index layer, thereby improving the high blackness and the integrated reflectance.

An average diameter of the hollow silica particles is preferably 30% to 150%, more preferably 35% to 80%, particularly preferably 40% to 60% of the thickness of the low refractive index layer. For example, if the thickness of the low refractive index layer is 100 nm, the diameter of the hollow silica particles is preferably 30 nm to 150 nm, more preferably 35 nm to 100 nm, particularly 40 nm to 65 nm.

In this range of the diameter of the hollow silica particles, it is expected that a percentage of cavity is increased, thereby lowering the refractive index. In addition, fine unevenness is not formed on a surface of the low refractive index layer, and high blackness and integrated reflectance are improved. The hollow silica particles may be either crystalline or amorphous. In addition, the hollow silica particles are preferably monodispersed particles. The hollow silica particles have most preferably a spherical shape, but may have an indeterminate form.

In addition, the hollow silica particles may be used in combination of two or more kinds of particles having different average diameters. The average diameter of the hollow silica particles may be obtained from an electron microscopic photograph.

In the invention, the specific surface area of the hollow silica particles is preferably 20 to 300 m²/g, more preferably 30 to 120 m²/g, most preferably 40 to 90 m²/g. The surface area of the hollow silica particles may be obtained by means of a BET method using nitrogen.

In the invention, silica particles having on cavity may be used along with the hollow silica particles. The diameter of the silica particles having no cavity is preferably 30 nm to 150 nm, more preferably 35 nm to 100 nm, most preferably 40 nm to 80 nm.

### 1-(10) Conductive Particles

Various kinds of conductive particles may be used to give conductivity to the film of the invention.

It is preferable that the conductive particles are formed of metal oxide or metal nitride. An example of the metal oxide or metal nitride may include tin oxide, indium oxide, zinc oxide, titanium nitride, etc., particularly preferably the tin oxide and the indium oxide. The conductive inorganic particles have these metal oxides or nitrides as a main component and may further contain other elements. The main component used herein means a component, which has the maximum content (weight %), of components of particles. An example of other elements may include Ti, Zr, Sn, Sb, Cu, Fe, Mn, Pb, Cd, As, Cr, Hg, Zn, Al, Mg, Si, P, S, B, Nb, In, V, halogen elements, etc. In order to increase conductivity of the tin oxide and indium oxide, it is preferable to add Sb, P, B, Nb, In, V and halogen elements. It is particularly preferable that the conductive particles are formed of tin oxide containing Sb (ATO) and indium oxide containing Sn (ITO). It is preferable that a percentage of Sb in ATO is 3 to 20 weight %, and a percentage of Sn of ITO is 5 to 20 weight %.

An average diameter of primary particles of the conductive inorganic particles used for an anti-static layer which will be described later is preferably 1 to 150 nm, more preferably 5 to 100 nm, most preferably 5 to 70 nm. An average diameter of the conductive inorganic particles of the formed anti-static layer is 1 to 200 nm, preferably 5 to 150 nm, more preferably 10 to 100 nm, most preferably 10 to 80 nm. The average diameter of the conductive inorganic particles means a weight average diameter and may be measured using a light scattering method or an electron microscopic photograph.

The specific surface area of the conductive inorganic particles is preferably 10 to 400 m²/g, more preferably 20 to 200 m²/g, most preferably 30 to 150 m²/g.

The conductive inorganic particles may be surface-treated. The surface treatment is conducted using an inorganic compound or an organic compound. An example of the inorganic compound used for the surface treatment may include alumina, silica, etc., particularly preferably the silica. An example of the organic compound used for the surface treatment may include polyol, alkanolamine, stearic acid, silane coupling agent, titanate coupling agent, etc., most preferably the silane coupling agent. Two or more kinds of surface treatments may be conducted.

It is preferable that the conductive inorganic particles have a granular shape, a spherical shape, a cubic shape, a spindle shape or an indeterminate shape.

Two or more kinds of conductive particles may be used in combination in a particular layer or film.

A percentage of the conductive inorganic particles in the anti-static layer is preferably 20 to 90 weight %, more preferably 20 to 90 weight %, particularly preferably 30 to 80 weight %.

The conductive inorganic particles may be used to form the anti-static layer in a dispersed state.

### 1-(11) Surface Treatment Agent

The inorganic particles used in the invention may be subjected to physical surface treatment such as plasma discharge treatment or corona discharge treatment, or chemical surface treatment using surface active agent or coupling agent in order to achieve dispersion stability or raise affinity or ability of bond to a binder component in dispersed solution or coating solution.

The surface treatment may be conducted using surface treatment agent of an inorganic compound or an organic compound. An example of the inorganic compound used for the surface treatment may include inorganic compounds containing cobalt (CoO₂, Co₂O₃, Co₃O₄, etc.), inorganic compounds containing aluminum (Al₂O₃, Al(OH)₃, etc.), inorganic compounds containing zirconium (ZrO₂, Zr(OH)₄, etc.), inorganic compounds containing silicon (SiO₂, etc.), inorganic compounds containing iron (Fe₂O₃, etc.), etc.

The inorganic compound is particularly preferably the inorganic compounds containing cobalt, the inorganic compounds containing aluminum and the inorganic compounds containing zirconium, most preferably the inorganic compounds containing cobalt, Al(OH)₃ and Zr(OH)₄.

An example of the organic compound used for the surface treatment may include polyol, alkanolamine, stearic acid, silane coupling agent, titanate coupling agent, etc., most preferably the silane coupling agent. It is particularly preferable that the surface treatment is conducted using at least one of the silane coupling agent (organosilane compound), its partial hydrolysate, and its condensate.

An example of the titanate coupling agent may include metal alkoxide such as tetramethoxytitanium, tetraethoxytitanium, tetraisopropoxytitanium or the like, Plenact (KR-TTS, KR-46B, KR-55, KR-41B, etc., which are available from AJIMOTO CO., Inc.), etc.

An example of the organic compound used for the surface treatment may include polyol, alkanolamine, or the other organic compounds having an anionic group, particularly preferably a carboxyl group, a sulfonic acid group or a phosphoric acid group. For example, it is preferable that stearic acid, lauric acid, oleic acid, linolic acid or linoleic acid is used as the organic compound.

In addition, it is preferable that the organic compound used for the surface treatment has a crosslinked functional group and a polymeric functional group. An example of the crosslinked functional group or the polymeric functional group may include an ethylene unsaturated group (for example, a (meta)acryl group, an aryl group, a styryl group, a vinyl oxide group, etc.) which can cause an addition reaction and a polymerization reaction by radical species, a cationic polymeric group (for example, an epoxy group, an oxatanyl group, a vinyloxide group, etc.), a polucondensation reactive group (for example, a hydrolysable silyl group, an N-methylol group, etc.), preferably the ethylene unsaturated group.

Two or more kinds of surface treatment agents may be used in combination. It is particularly preferable that the surface treatment agent is used in a combination of an inorganic compound containing aluminum and an inorganic compound containing zirconium.

If the inorganic particles are silica particles, it is particularly preferable to use the coupling agent. An example of the coupling agent may preferably include an alkoxy metal compound (for example, titanium coupling agent, silane coupling agent, etc.), particularly the silane coupling agent.

Although the coupling agent is used, as surface treatment agent of an inorganic filler of a low refractive layer, to conduct the surface treatment before preparing coating solution of the layer, it is preferable that the coupling agent is contained, as additive, in the layer when the coating solution of the layer is prepared.

It is preferable that the silica particles are dispersed in a medium in advance before the surface treatment in order to alleviate load of the surface treatment.

An example of the surface treatment agent and a compound of a catalyst for the surface treatment may include an organosilane compound and a catalyst which are described in, for example, WO 2004/017105.

### 1-(12) Dispersant

Various kinds of dispersants may be used for dispersion of the particles used in the invention.

It is preferable that the dispersant has a crosslinked functional group or a polymeric functional group. An example of the crosslinked functional group or the polymeric functional group may include an ethylene unsaturated group (for example, a (meta)acryloyl group, an aryl group, a styryl group, a vinyl oxide group, etc.) which can cause an addition reaction and a polymerization reaction by radical species, a cationic polymeric group (for example, an epoxy group, an oxatanyl group, a vinyloxide group, etc.), a polucondensation reactive group (for example, a hydrolysable silyl group, an N-methylol group, etc.), preferably the ethylene unsaturated group.

It is preferable that dispersant having an anionic group is used for dispersion of inorganic particles having, particularly, TiO₂ as a main component. It is particularly preferably that the dispersant has a side chain having a crosslinked functional group or a polymeric functional group.

The anionic group is preferably a group having acidic proton, such as a carboxyl group, a sulfonic acid group (sulfo), a phosphate group (phosphono), a sulfoneamide group or the like, or salt thereof, more preferably the carboxyl group, the sulfonic acid group, the phosphate group, or the salt thereof, particularly preferably the carboxyl group or the phosphate group. The number of anionic groups contained in the dispersant per one molecule is plural, preferably more than two, more preferably more than five, particularly preferably more than ten in average. In addition, a plurality of kinds of anionic groups contained in the dispersant may be contained in one molecule.

For the dispersant having the side chain having the anionic group, a composition of a repeating unit containing the anionic group is 10⁻⁴ to 100 mol %, preferably 1 to 50 mol %, particularly preferably 5 to 20 mol %.

It is preferable that the dispersant contains the crosslinked functional group or the polymeric functional group. An example of the crosslinked functional group or the polymeric functional group may include an ethylene unsaturated group (for example, a (meta)acryloyl group, an aryl group, a styryl group, a vinyl oxide group, etc.) which can cause an addition reaction and a polymerization reaction by radical species, a cationic polymeric group (for example, an epoxy group, an oxatanyl group, a vinyloxide group, etc.), a polycondensation reactive group (for example, a hydrolysable silyl group, an N-methylol group, etc.), preferably the ethylene unsaturated group.

The number of crosslinked or polymeric groups contained in the dispersant per one molecule is preferably more than two, more preferably more than five, particularly preferably more than ten in average. In addition, a plurality of kinds of crosslinked or polymeric groups contained in the dispersant may be contained in one molecule.

In the dispersant preferably used in the invention, an example of a repeating unit having a side chain having an ethylene unsaturated group may include a poly-1,2-butadien and poly-1,2-isoprene structure or a repeating unit of ester or imide of (meta)acryl acid, with specified moiety (a R group of —COOR or —CONHR) combined thereto. An example of the specified moiety (the R group) may include —(CH₂)n-CR²¹═CR²²R²³, —(CH₂O)n —CH₂CR²¹═CR²²R²³, —(CH₂CH₂O)n-CH₂CR²¹═CR²²R²³, —(CH₂)n-NH—CO—O—CH₂₁CR²¹═CR²²R²³, —(CH₂)n-O—CO—CR²¹═CR²²R²³ and —(CH₂CH₂O)₂—X (R²¹ to R²³ are a hydrogen atom, a halogen atom, an alkyl group having 1 to 20 carbon atoms, an aryl group, an alkoxy group and an aryloxy group, respectively, R²¹ and R²² or R²³ may be combined to each other to form a ring, n is an integer number of 1 to 10, and X is a dicyclopentadienyl moiety). An example of the R group as the moiety of ester may include —CH₂CH═CH₂ (corresponding to polymer of alryl(meta)acrylate described in Japanese Patent Application Publication No. Sho64-17047), —CH₂CH₂O—CH₂CH═CH₂, —CH₂CH₂OCOCH═CH₂, —CH₂CH₂OCOC(CH₃)═CH₂, —CH₂C(CH₃)═CH₂, —CH₂CH═CH—C₆H₅, —CH₂OCOCH═CH—C₆H₅, —CH₂CH₂₋NHCOO—CH₂CH═CH₂, —CH₂CH₂O—X(X is a dicyclopentadienyl moiety), etc. An example of the R group as the moiety of amide may include —CH₂CH═CH₂, —CH₂CH₂—Y(Y is a 1-cyclohexenyl moiety), —CH₂CH₂—OCO—CH═CH₂, —CH₂CH₂—OCO—C(CH₃)═CH₂, etc.

The dispersant having the ethylene unsaturated group is cured when a free radical (a polymerization initiation radical or a growth radical in the course of polymerization of a polymeric compound) is added to the ethylene unsaturated group, and a crosslinkage is formed between molecules directly or via a polymeric chain of the polymeric compound. Alternatively, the dispersant is cured when atoms in molecules (for example, hydrogen atoms on carbon atoms adjacent to the ethylene unsaturated group) are drawn by the free radical to generate polymer radicals, and a crosslinkage is formed between molecules by combining the generated polymer radicals together.

The weight mean molecular weight (Mw) of the dispersant having the anionic group and the side chain having the crosslinked or polymeric functional group is preferably 1,000 or more, more preferably 5,000 to 200,000, particularly 10,000 to 100,000, without being particularly limited thereto.

A content unit of the crosslinked or polymeric functional group may be all repeating units except a content unit of the anionic group. The content unit of the crosslinked or polymeric functional group is preferably 5 to 50 mol %, particularly 5 to 30 mol % of all crosslinkage or repeating units.

The dispersant may be a copolymer with proper monomers except a monomer having the crosslinked or polymeric functional group and the anionic group. The copolymer is not particularly limited and may be selected from a standpoint of dispersion stability, miscibility with other monomers, strength of a coated film, etc. An example of the copolymer may preferably include methyl(meta)acrylate, n-butyl(meta)acrylate, t-butyl(meta)acrylate, cyclohexyl(meta)acrylate, styrene, etc.

The form of dispersant is preferably a block copolymer or a random copolymer, particularly preferably the random copolymer from a standpoint of costs and ease synthesis, without being particularly limited thereto.

The amount of dispersant used in the inorganic particles is preferably 1 to 50 weight %, more preferably 5 to 30 weight %, most preferably 5 to 20 weight %. Two or more kinds of dispersants may be used in combination.

The structural formulas show examples of the dispersant preferably used in the invention, without being limited thereto. The dispersant is a copolymer unless otherwise mentioned.

| | | |
|---|---|---|
| 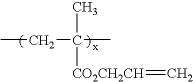 | 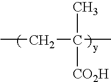 | 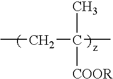 |

x/y/z represents a mole ratio.

| | x | y | z | R | Mw |
|---|---|---|---|---|---|
| P-(1) | 80 | 20 | 0 | — | 40,000 |
| P-(2) | 80 | 20 | 0 | — | 110,000 |
| P-(3) | 80 | 20 | 0 | — | 10,000 |
| P-(4) | 90 | 10 | 0 | — | 40,000 |
| P-(5) | 50 | 50 | 0 | — | 40,000 |
| P-(6) | 30 | 20 | 50 | CH₂CH₂CH₃ | 30,000 |
| P-(7) | 20 | 30 | 50 | CH₂CH₂CH₂CH₃ | 50,000 |
| P-(8) | 70 | 20 | 10 | CH(CH₃)₃ | 60,000 |
| P-(9) | 70 | 20 | 10 | 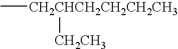 | 150,000 |
| P-(10) | 40 | 30 | 30 | 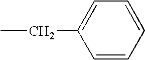 | 15,000 |

| | |
|---|---|
| 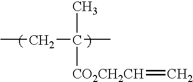 | 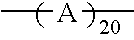 |

| | A | Mw |
|---|---|---|
| P-(11) | 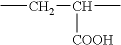 | 20,000 |
| P-(12) | 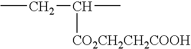 | 30,000 |
| P-(13) | 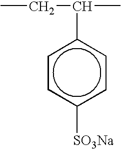 | 100,000 |
| P-(14) | 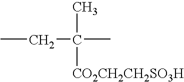 | 20,000 |
| P-(15) | 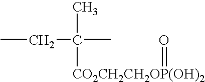 | 50,000 |
| P-(16) | 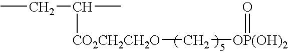 | 15,000 |

| | |
|---|---|
| 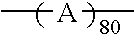 | 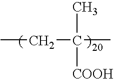 |

| | A | Mw |
|---|---|---|
| P-(17) | 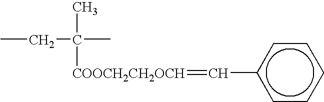 | 20,000 |
| P-(18) | 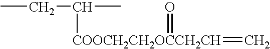 | 25,000 |
| P-(19) | 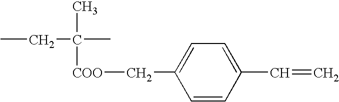 | 18,000 |
| P-(20) | 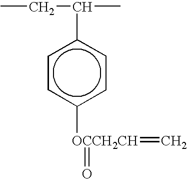 | 20,000 |
| P-(21) | 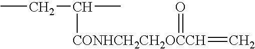 | 35,000 |

| | | |
|---|---|---|
| 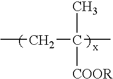 | 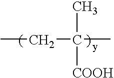 | 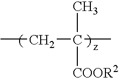 |

| | R¹ | R² | x | y | z | Mw |
|---|---|---|---|---|---|---|
| P-(22) | 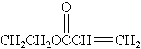 | C₄H₉(n) | 10 | 10 | 80 | 25,000 |
| P-(23) | 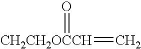 | C₄H₉(t) | 10 | 10 | 80 | 25,000 |
| P-(24) | 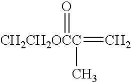 | C₄H₉(n) | 10 | 10 | 80 | 500,000 |
| P-(25) | 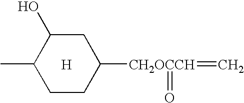 | C₄H₉(n) | 10 | 10 | 80 | 23,000 |
| P-(26) | 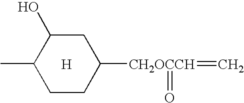 | C₄H₉(n) | 80 | 10 | 10 | 30,000 |
| P-(27) | 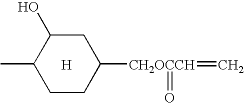 | C₄H₉(n) | 50 | 20 | 30 | 30,000 |
| P-(28) | 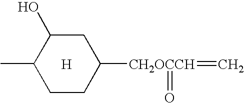 | C₄H₉(t) | 10 | 10 | 80 | 20,000 |
| P-(29) | 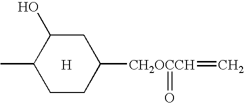 | CH₂CH₂OH | 50 | 10 | 40 | 20,000 |
| P-(30) | 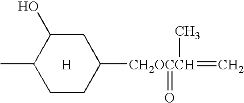 | C₄H₉(n) | 10 | 10 | 80 | 25,000 |

| | | |
|---|---|---|
| P-(31) | 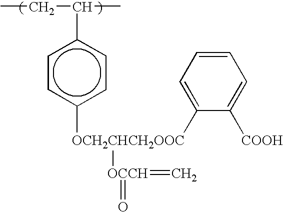 | Mw = 60,000 |
| P-(32) | 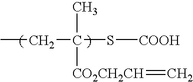 | Mw = 10,000 |
| P-(33) | 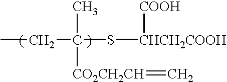 | Mw = 20,000 |
| P-(34) | 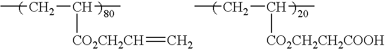 | Mw = 30,000(Block Copolymer) |
| P-(35) | 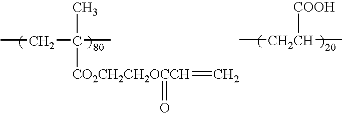 | Mw = 15,000(Block Copolymer) |

| | | | |
|---|---|---|---|
| P-(36) | 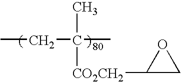 | 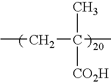 | Mw = 8,000 |
| P-(37) | 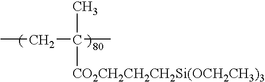 | 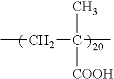 | Mw = 5,000 |
| P-(38) | 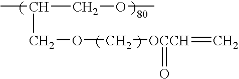 | 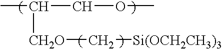 | Mw = 10,000 |

### 1-(13) Anti-Smudge Agent

For the purpose of giving anti-smudge, waterproof, chemical resistance, slidability, etc. to the film of the invention, particularly to the uppermost layer of the film, it is preferable that known silicon or fluorine anti-smudge agent, lubricant, etc. are added to the film.

The amount of addition of these additives is preferably 0.01 to 20 weight %, more preferably 0.05 to 10 weight %, particularly preferably 0.1 to 5 weight % of all solids of a low refractive index layer.

An example of the silicon compound may include compounds in which ends and/or side chains of a compound chain containing a plurality of dimethylsilyl units as a repeating unit have a substituent group. The compound chain containing the dimethylsilyl units as the repeating unit may contain structural units other than the dimethylsilyl units. The substituent group may be plural in number and may be equal to or different from each other. An example of the substituent group may include an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group, an amino group, etc. Molecule weight is preferably 100,000 or less, more preferably 50,000 or less, particularly preferably 3000 to 30,000, without being particularly limited thereto. The content of silicon atoms in the silicon compound is preferably more than 18.0 weight %, particularly preferably 25.0 to 37.8 weight %, most preferably 30.0 to 37.0 weight %, without being particularly limited thereto. An example of the silicon compound may include X-22-174DX, X-22-2426, X-22-164B, X-22-164C, X-22-170DX, X-22-176D and X-22-1821, which are available from Shin-Etsu Chemical Co., Ltd., FM-7725, FM-4421, FM-5521, FM-6621 and FM-1121, which are available from CHISSO Corporation, DMS-U22, RMS-033, RMS-083, UMS-182, DMS-H21, DMS-H31, HMS-301, FMS121, FMS123, FMS131, FMS141 and FMS221, which are available from Gelest, Inc., etc., without being limited thereto.

It is preferable that the fluorine compound is a compound having a fluoroalkyl group. The fluoroalkyl group has preferably 1 to 20 carbon atoms, more preferably 1 to 10 carbon atoms. The fluoroalkyl group may have any of a straight chain (for example, —CF₂CF₃, —CH₂(CF₂)₄H, —CH₂(CF₂)₈CF₃, —CH₂CH₂(CF₂)₄H, etc.), a branch structure (for example, CH(CF₃)₂, CH₂CF(CF₃)₂, CH(CH₃)CF₂CF₃, CH(CH₃)(CF₂)₅CF₂H, etc.) and an alicyclic structure (preferably a 5-membered ring or a 6-membered ring, for example, a perfluorocyclohexyl group, a perfluorocyclopentyl group, or an alkyl group substituted therewith, etc.). The fluoroalkyl group may have an ether bond (for example, CH₂OCH₂CF₂CF₃, CH₂CH₂OCH₂C₄F₈H, CH₂CH₂OCH₂CH₂C₈F₁₇, CH₂CH₂OCF₂CF₂OCF₂CF₂H, etc). A plurality of fluoroalkyl groups may be contained in a single molecule.

It is also preferable that the fluorine compound has a substituent group which contributes to bond to a low refractive index layer or miscibility with the low refractive index layer. The substituent group may be plural in number and may be equal to or different from each other. An example of the substituent group may include an acryloyl group, a methacryloyl group, a vinyl group, an aryl group, a cinnamoyl group, an epoxy group, an oxetanyl group, a hydroxyl group, a polyoxyalkylene group, a carboxyl group, an amino group, etc. The fluorine compound may be either polymer or oligomer with a compound containing no fluorine atom and has no particular limit to molecule weight. The content of fluorine atoms in the fluorine compound is preferably 20 weight % or more, particularly preferably 30 to 70 weight %, most preferably 40 to 70 weight %, without being particularly limited thereto. An example of the fluorine compound may include R-2020, M-2020, R-3833 and M-3833, which are available from Daikin Industries., Ltd., MegafaceF-171, F-172, F-179A and Defensa MCF-300, which are available from Dainippon Ink And Chemicals, Incorporated, etc., without being limited thereto.

For the purpose of giving dustproofing, anti-static property, etc. to the film of the invention, dustproofing agent, anti-static agent, etc., such as known cation surfactant or a polyoxyalkylene compound, may be properly added to the film. A structural unit of the dustproofing agent and anti-static agent may be contained, as a part of function, in the above-mentioned silicon compound or the fluorine compound. The amount of addition of these additives is preferably 0.01 to 20 weight %, more preferably 0.05 to 10 weight %, particularly preferably 0.1 to 5 weight % of all solids of a low refractive index layer. An example of the additives may include MegafaceF-150 which is available from Dainippon Ink And Chemicals, Incorporated, SH-3748 which is available from Toray-Dow Corning Corporation, etc., without being limited thereto.

### 1-(14) Surfactant

For the purpose of giving surface uniformity of coating spots, dry spots, point defects, etc. to the film of the invention, it is preferable that one or both of fluorine surfactant and silicon surfactant are contained in a coating composition for formation of the hard coat layer or a light diffusing layer. The fluorine surfactant is particularly preferable since it exhibits an effect of preventing surface defaults such as coating spots, dry spots, point defects, etc with less amount of addition. Thus, the fluorine surfactant allows high productivity due to fast coating, as well as high surface uniformity.

An example of the fluorine surfactant may include a fluoroaliphatic group-contained copolymer (sometimes abbreviated as fluorine polymer). The fluorine polymer preferably includes copolymers in which acryl resin or methacryl resin containing a repeating unit corresponding to monomer of the following item (i) or a repeating unit corresponding to monomer of the following item (ii) is copolymerized with vinyl monomer.

(i) Fluoroaliphatic group-contained monomer expressed by the following formula A

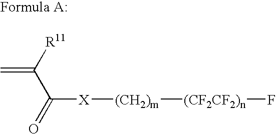

In the formula A, R¹¹ is a hydrogen atom or a methyl group, X is an oxygen atom, a sulfur atom or —N(R¹²)—, m is an integer number of more than 1 and less than 6, and n is an integer number of 2 to 4. R¹² is a hydrogen atom or an alkyl group having 1 to 4 carbon atoms, for example, a methyl group, an ethyl group, a propyl group or a butyl group, preferably the hydrogen atom or the methyl group. X is preferably the oxygen atom.

(ii) Monomer expressed by the following formula B, which can be copolymerized with the monomer of the item (i)

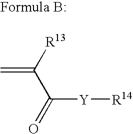

In the formula B, R¹³ is a hydrogen atom or a methyl group, Y is an oxygen atom, a sulfur atom or —N(R¹⁵)—, R¹⁵ is a hydrogen atom or an alkyl group having 1 to 4 carbon atoms, for example, a methyl group, an ethyl group, a propyl group or a butyl group, preferably the hydrogen atom or the methyl group. Y is preferably the oxygen atom, —N(H)—, and —N(CH₃)—.

R¹⁴ is a straight, branch or ring-shaped alkyl group having 4 to 20 carbon atoms, which may have a substituent group. An example of the substituent group of the alkyl group of R¹⁴ may include a hydroxyl group, an alkylcarbonyl group, an arylcarbonyl group, a carboxyl group, an alkylether group, an arylether group, a halogen atom such as a fluorine atom, a chloride atom or a bromine atom, a nitro group, a cyano group, an amino group, etc., without being limited thereto. An example of the straight, branch or ring-shaped alkyl group having 4 to 20 carbon atoms may include a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group, an eicosanyl group, a monocyclic cycloalkyl group such as a cyclohexyl group or a cycloheptyl group, a polycyclic cycloalkyl group such as a bicycle heptyl group, a bicyclodecyl group, a tricycloundecyl group, a tetracyclododecyl group, an adamantyl group, a norbornyl group or a tetracyclodicyl group, etc.

The content of the fluoroaliphatic group-contained monomer, which is used in the fluorine polymer used in the invention and expressed by the above formula A, is more than 10 mol %, preferably 15 to 70 mol %, more preferably 20 to 60 mol %, based on each monomer of the fluorine polymer.

A weight average molecule weight of the fluorine polymer used in the invention is preferably 3,000 to 100,000, more preferably 5,000 to 80,000.

In addition, the amount of addition of the fluorine polymer used in the invention is 0.001 to 5 weight %, preferably 0.005 to 3 weight %, more preferably 0.01 to 1 weight % of coating solution. When the amount of addition of the fluorine polymer is 0.001 weight % or more, a sufficient effect is obtained, and when the amount of addition of the fluorine polymer is 5 weight % or less, a coated film is sufficiently dried, thereby improving performance of the coated film (for example, reflectance, scratch resistance, etc.).

An example of a structure of the fluorine polymer comprising the fluoroaliphatic group-contained monomer expressed by the above formula A is shown below, without being limited thereto. Mw represents a weight average molecule weight.

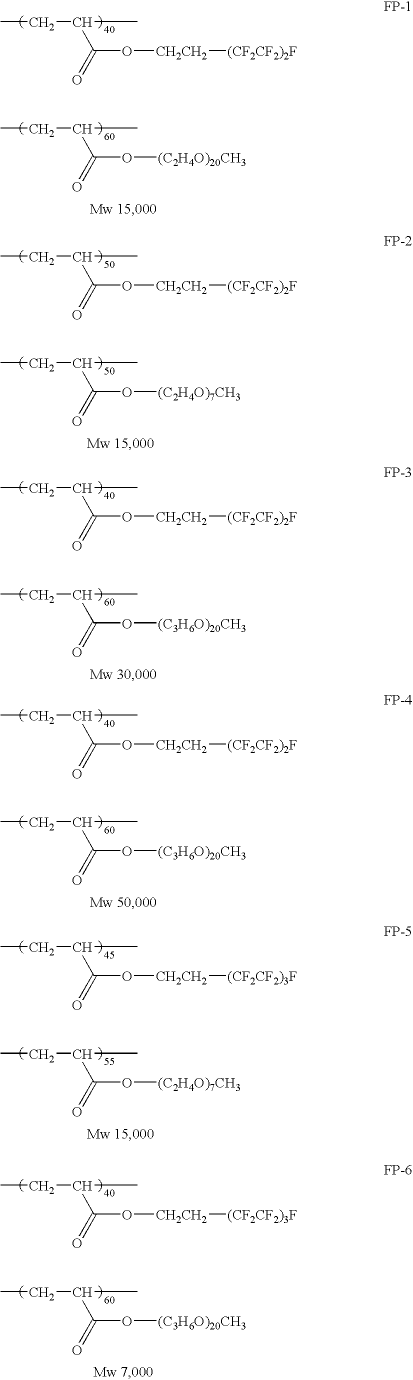

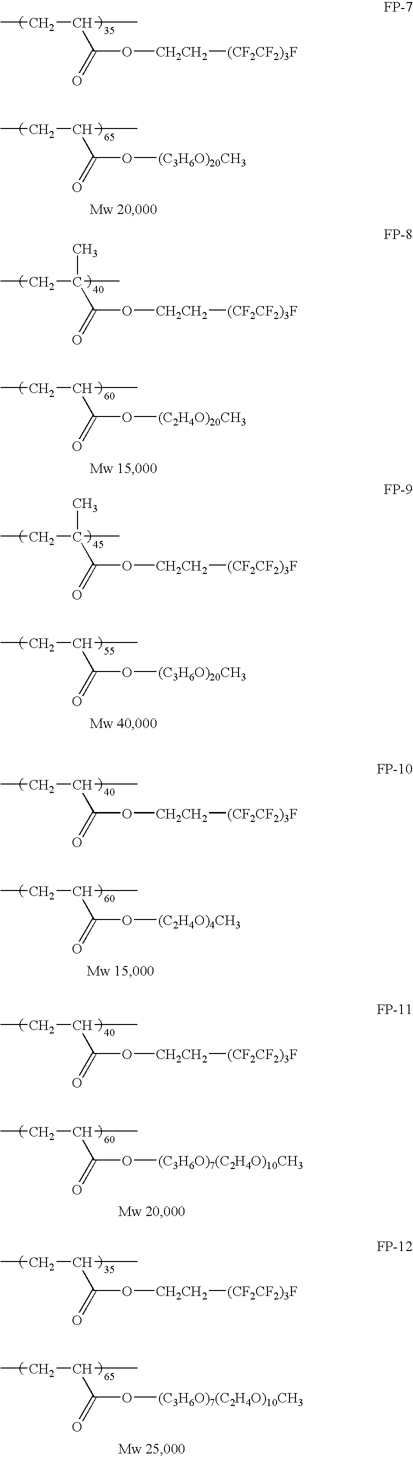

However, since the fluorine polymer used segregates a fluorine atom-contained functional group on a surface of the antiglare layer, surface energy of the antiglare layer is reduced, and antireflection performance is deteriorated when a low refractive index layer is over-coated on the antiglare layer. This is probably because leakage of a curable composition used to form the low refractive index layer is worsened, and accordingly, minute invisible spots are more formed on the low refractive index layer. To overcome such a problem, it is found that it is effective to control the surface energy of the antiglare layer to be, preferably, 20 mN·m⁻¹ to 50 mN·m⁻¹, more preferably, 30 mN·m⁻¹ to 40 mN·m⁻¹ by adjusting a structure and the amount of addition of the fluorine polymer. In order to achieve such surface energy, a F/C, which is a ratio of a fluorine atom-originated peak to a carbon atom-originated peak, has to be 0.1 to 1.5.

In addition, when fluorine polymer, which can be extracted by a solvent constituting an upper layer, is applied on the upper layer, the fluorine polymer is not maldistributed on a surface of a lower layer (that is, an interface) to obtain good adhesion between the upper layer and the lower layer, thereby maintaining surface uniformity even fast coating. Also, in this case, since surface free energy to provide an antireflection film having high scratch resistance can be prevented from being reduced, the surface energy of the antiglare layer before the low refractive index layer is applied can be controlled to the above-mentioned energy range. An example of such a material can include copolymers in which acryl resin or methacryl resin containing a repeating unit corresponding to the fluoroaliphatic group-containing monomer expressed by the following formula C is copolymerized with vinyl monomer, etc.

(iii) Fluoroaliphatic group-containing monomer expressed by the following formula C

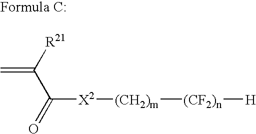

In the formula C, R²¹ is a hydrogen atom, a halogen atom, or a methyl group, preferably the hydrogen atom or the methyl group. X² is an oxygen atom, a sulfur atom or —N(R²²)—, preferably the oxygen atom or —N(R²²)—, more preferably the oxygen atom. m is an integer number of 1 to 6 (preferably 1 to 3, more preferably 1), and n is an integer number of 1 to 18 (preferably 4 to 12, more preferably 6 to 8). R²² is a hydrogen atom or an alkyl group having 1 to 8 carbon atoms, which may have a substituent group, preferably the hydrogen atom or the alkyl group having 1 to 4 carbon atoms, more preferably the hydrogen atom or a methyl group. X² is preferably the oxygen atom.

In addition, two or more kinds of fluoroaliphatic group-contained monomer expressed by the above formula C may be contained in the fluorine polymer.

(iv) Monomer Expressed by the Following Formula D, Which Can be Copolymerized with the Monomer of the Item (iii)

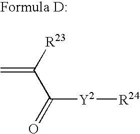

In the formula D, R²³ is a hydrogen atom, a halogen atom or a methyl group, preferably the hydrogen atom or the methyl group. Y² is an oxygen atom, a sulfur atom or —N(R²⁵)—, preferably the oxygen atom or —N(R²⁵)—, more preferably the oxygen atom. R²⁵ is a hydrogen atom or an alkyl group having 1 to 8 carbon atoms, preferably the hydrogen atom or the alkyl group having 1 to 4 carbon atoms, more preferably the hydrogen atom or a methyl group.

In the formula D, R²⁴ is a straight, branch or ring-shaped alkyl group having 1 to 20 carbon atoms, which may have substituent group, an alkyl group containing a poly(alkyleneoxy) group, or an aromatic group, which may have a substituent group, (for example, a phenyl group or a naphthyl group), preferably the straight, branch or ring-shaped alkyl group having 1 to 12 carbon atoms or the aromatic group having 6 to 18 carbon atoms, more preferably the straight, branch or ring-shaped alkyl group having 1 to 8 carbon atoms.

An example of a structure of the fluorine polymer comprising the repeating unit corresponding to the fluoroaliphatic group-contained monomer expressed by the above formula C is shown below, without being limited thereto. Numerals in the following structural formulas represent mol ratios of monomer components. Mw represents a weight average molecule weight.

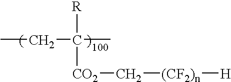

| | R | n | Mw |
|---|---|---|---|
| P-1 | H | 4 | 8000 |
| P-2 | H | 4 | 16000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 10000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |

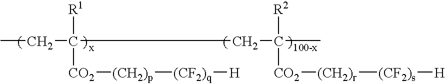

| | x | R¹ | p | q | R² | r | s | Mw |
|---|---|---|---|---|---|---|---|---|
| P-15 | 50 | H | 1 | 4 | CH₃ | 1 | 4 | 10000 |
| P-16 | 40 | H | 1 | 4 | H | 1 | 6 | 14000 |
| P-17 | 60 | H | 1 | 4 | CH₃ | 1 | 6 | 21000 |
| P-18 | 10 | H | 1 | 4 | H | 1 | 8 | 11000 |
| P-19 | 40 | H | 1 | 4 | H | 1 | 8 | 16000 |
| P-20 | 20 | H | 1 | 4 | CH₃ | 1 | 8 | 8000 |
| P-21 | 10 | CH₃ | 1 | 4 | CH₃ | 1 | 8 | 7000 |
| P-22 | 50 | H | 1 | 6 | CH₃ | 1 | 6 | 12000 |
| P-23 | 50 | H | 1 | 6 | CH₃ | 1 | 6 | 22000 |
| P-24 | 30 | H | 1 | 6 | CH₃ | 1 | 6 | 5000 |

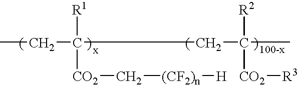

| | x | R¹ | n | R² | R³ | Mw |
|---|---|---|---|---|---|---|
| FP-148 | 80 | H | 4 | CH₃ | CH₃ | 11000 |
| FP-149 | 90 | H | 4 | H | C₄H₉(n) | 7000 |
| FP-150 | 95 | H | 4 | H | C₆H₁₃(n) | 5000 |
| FP-151 | 90 | CH₃ | 4 | H | CH₂CH(C₂H₅)C₄H₉(n) | 15000 |
| FP-152 | 70 | H | 6 | CH₃ | C₂H₅ | 18000 |
| FP-153 | 90 | H | 6 | CH₃ | 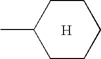 | 12000 |
| FP-154 | 80 | H | 6 | H | C₄H₉(sec) | 9000 |
| FP-155 | 90 | H | 6 | H | C₁₂H₂₅(n) | 21000 |
| FP-156 | 60 | CH₃ | 6 | H | CH₃ | 15000 |
| FP-157 | 60 | H | 8 | H | CH₃ | 10000 |
| FP-158 | 70 | H | 8 | H | C₂H₅ | 24000 |
| FP-159 | 70 | H | 8 | H | C₄H₉(n) | 5000 |
| FP-160 | 50 | H | 8 | H | C₄H₉(n) | 16000 |
| FP-161 | 80 | H | 8 | CH₃ | C₄H₉(iso) | 13000 |
| FP-162 | 80 | H | 8 | CH₃ | C₄H₉(t) | 9000 |
| FP-163 | 60 | H | 8 | H | 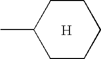 | 7000 |
| FP-164 | 80 | H | 8 | H | CH₂CH(C₂H₅)C₄H₉(n) | 8000 |
| FP-165 | 90 | H | 8 | H | C₁₂H₂₅(n) | 6000 |
| FP-166 | 80 | CH₃ | 8 | CH₃ | C₄H₉(sec) | 18000 |
| FP-167 | 70 | CH₃ | 8 | CH₃ | CH₃ | 22000 |
| FP-168 | 70 | H | 10 | CH₃ | H | 17000 |
| FP-169 | 90 | H | 10 | H | H | 9000 |
| FP-170 | 95 | H | 4 | CH₃ | —(CH₂CH₂O)₂—H | 18000 |
| FP-171 | 80 | H | 4 | H | —(CH₂CH₂O)₂—CH₃ | 16000 |
| FP-172 | 80 | H | 4 | H | —(C₃H₆O)₇—H | 24000 |
| FP-173 | 70 | CH₃ | 4 | H | —(C₃H₆O)₁₃—H | 18000 |
| FP-174 | 90 | H | 6 | H | —(CH₂CH₂O)₂—H | 21000 |
| FP-175 | 90 | H | 6 | CH₃ | —(CH₂CH₂O)₈—H | 9000 |
| FP-176 | 80 | H | 6 | H | —(CH₂CH₂O)₂—C₄H₉(n) | 12000 |
| FP-177 | 80 | H | 6 | H | —(C₃H₆O)₇—H | 34000 |
| FP-178 | 75 | F | 6 | H | —(C₃H₆O)₁₃—H | 11000 |
| FP-179 | 85 | CH₃ | 6 | CH₃ | —(C₃H₆O)₂₀—H | 18000 |
| FP-180 | 95 | CH₃ | 6 | CH₃ | —CH₂CH₂OH | 27000 |
| FP-181 | 80 | H | 8 | CH₃ | —(CH₂CH₂O)₈—H | 12000 |
| FP-182 | 95 | H | 8 | H | —(CH₂CH₂O)₉—CH₃ | 20000 |
| FP-183 | 90 | H | 8 | H | —(C₃H₆O)₇—H | 8000 |
| FP-184 | 95 | H | 8 | H | —(C₃H₆O)₂₀—H | 15000 |
| FP-185 | 90 | F | 8 | H | —(C₃H₆O)₁₃—H | 12000 |
| FP-186 | 80 | H | 8 | CH₃ | —(CH₂CH₂O)₂—H | 20000 |
| FP-187 | 95 | CH₃ | 8 | H | —(CH₂CH₂O)₉—CH₈ | 17000 |
| FP-188 | 90 | CH₃ | 8 | H | —(C₃H₆O)₇—H | 34000 |
| FP-189 | 80 | H | 10 | H | —(CH₂CH₂O)₃—H | 19000 |
| FP-190 | 90 | H | 10 | H | —(C₃H₆O)₇—H | 8000 |
| FP-191 | 80 | H | 12 | H | —(CH₂CH₂O)₇—CH₃ | 7000 |
| FP-192 | 95 | CH₃ | 12 | H | —(C₃H₆O)₇—H | 10000 |

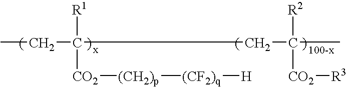

| | x | R¹ | p | q | R² | R³ | Mw |
|---|---|---|---|---|---|---|---|
| FP- | 80 | H | 2 | 4 | H | C₄H₉(n) | 18000 |
| 193 | | | | | | | |
| FP- | 90 | H | 2 | 4 | H | —(CH₂CH₂O)₉—CH₃ | 16000 |
| 194 | | | | | | | |
| FP- | 90 | CH₃ | 2 | 4 | F | C₆H₁₃(n) | 24000 |
| 195 | | | | | | | |
| FP- | 80 | CH₃ | 1 | 6 | F | C₄H₉(n) | 18000 |
| 196 | | | | | | | |
| FP- | 95 | H | 2 | 6 | H | —(C₃H₆O)₇—H | 21000 |
| 197 | | | | | | | |
| FP- | 90 | CH₃ | 3 | 6 | H | —CH₂CH₂OH | 9000 |
| 198 | | | | | | | |
| FP- | 75 | H | 1 | 8 | F | CH₃ | 12000 |
| 199 | | | | | | | |
| FP- | 80 | H | 2 | 8 | H | CH₂CH(C₂H₅)C₄H₉(n) | 34000 |
| 200 | | | | | | | |
| FP- | 90 | CH₃ | 2 | 8 | H | —(C₃H₆O)₇—H | 11000 |
| 201 | | | | | | | |
| FP- | 80 | H | 3 | 8 | CH₃ | CH₃ | 18000 |
| 202 | | | | | | | |
| FP- | 90 | H | 1 | 10 | F | C₄H₉(n) | 27000 |
| 203 | | | | | | | |
| FP- | 95 | H | 2 | 10 | H | —(CH₂CH₂O)₉—CH₃ | 12000 |
| 204 | | | | | | | |
| FP- | 85 | CH₃ | 2 | 10 | CH₃ | C₄H₉(n) | 20000 |
| 205 | | | | | | | |
| FP- | 80 | H | 1 | 12 | H | C₆H₁₃(n) | 8000 |
| 206 | | | | | | | |
| FP- | 90 | H | 1 | 12 | H | —(C₃H₆O)₁₃—H | 15000 |
| 207 | | | | | | | |
| FP- | 60 | CH₃ | 3 | 12 | CH₃ | C₂H₅ | 12000 |
| 208 | | | | | | | |
| FP- | 60 | H | 1 | 16 | H | CH₂CH(C₂H₅)C₄H₉(n) | 20000 |
| 209 | | | | | | | |
| FP- | 80 | CH₃ | 1 | 16 | H | —(CH₂CH₂O)₂—C₄H₉(n) | 17000 |
| 210 | | | | | | | |
| FP- | 90 | H | 1 | 18 | H | —CH₂CH₂OH | 34000 |
| 211 | | | | | | | |
| FP- | 60 | H | 3 | 18 | CH₃ | CH₃ | 19000 |
| 212 | | | | | | | |

### 1-(15) Thickener

In the film of the invention, thickener may be used to adjust viscosity of coating solution.

The thickener used herein means that the viscosity of the coating solution is increased when he thickener is added to the coating solution. When the thickener is added to the coating solution, the viscosity of the coating solution is increased to, preferably 0.05 to 50 cP (0.05 to 50 mPa·s), more preferably 0.10 to 20 cP (0.10 to 20 mPa·s), most preferably 0.10 to 10 cP (0.10 to 10 mPa·s).

An example of the thickener may include:

poly-ε-caprolactone

poly-ε-caprolactonediol

poly-ε-caprolactonetriol

polyvinylacetate

poly(ethyleneadipate)

poly(1,4-bytyleneadipate)

poly(1,4-bytyleneglutarate)

poly(1,4-bytylenesuccinate)

poly(1,4-bytyleneterephthalate)

poly(ethyleneterephthalate)

poly(2-methyl-1,3-propyleneadipate)

poly(2-methyl-1,3-propyleneglutarate)

poly(neophentylglycoladipate)

poly(neophentylglycolsebacate)

poly(1,3-propyleneadipate)

poly(1,3-propyleneglutarte)

polyvinylbutyral

polyvinylformal

polyvinylacetal

polyvinylpropanal

polyvinylhexanal

polyvinylpyrrolidone

polyacrylic acid ester

polymethacrylic acid ester

celluloseacetate

cellulosepropionate, and

celluloseacetatebutylate, but is not limited thereto.

In addition, another example of the thickener may include smectite, fluor-tetrasilicic mica, bentonite, silica, montmorillonite and sodium polyacrylate, which are described in JP-A-8-325491, ethylcellulose, polyacrylic acid, organic clay, etc., which are described in Japanese Patent Application Publication Hei10-219136, other known viscosity modifiers or thixotropic thickeners.

### 1-(16) Coating Solvent

Solvent used for a coating composition for formation of various layers of the invention may be selected in consideration of solubility, dispersibility, surface uniformity in coating and dry processes, solution conservation, saturated vapor pressure, etc.

Two or more kinds of solvents may be used in combination. From a standpoint of dry load and surface stability by increase of drying speed, it is particularly preferable that solvent having the boiling point of less than 120° C. under the condition of normal pressure and room temperature is mainly used.

An example of the solvent having the boiling point of less than 120° C. may include hydrocarbon atoms such as hexane (boiling point: 68, 7° C.), heptane (98.4° C.), cyclohexane (80.7° C.), benzene (80.1° C.) or the like, hydrogen halides such as dichloromethane (39.8° C.), chloroform (61.2° C.), carbon tetrachloride (76.8° C.), 1,2-dichloroethane (83.5° C.), trichloroethylene (87.2° C. or the like, ethers such as diethylether (34.6° C.), diisopropylether (68.5° C.), dipropylether (90.5° C.), tetrahydrofuran (66° C.) or the like, esters such as formic acid ethyl (54.2° C.), acetic acid methyl (57.8° C.), acetic acid ethyl (77.1° C.), acetic acid isopropyl (89° C.) or the like, ketones such as acetone (56.1° C.), 2-butanol (being equal to methylethylketone, 79.6° C.) or the like, alcohols such as methanol (64.5° C.), ethanol (78.3° C.), 2-propanol (82.4° C.), 1-propanol (97.2° C.) or the like, cyan compounds such as acetonitril (81.6° C.), propionitril (97.4° C.) or the like, carbon disulfide (46.2° C.), toluene (110.6° C.), dioxane (101.3° C.), acetic acid isobutyl (118° C.), 1-butanpl (117.7° C.), etc., preferably the ketones and the esters, more preferably the ketones, particularly preferably the 2-butanol.

An example of the solvent having the boiling point of 120° C. or more may include octane (125.7° C.), xylene (138° C.), tetrachloroethylene (121.2° C.), chlorobenzene (131.7° C.), dibutylether (142.4° C.), cyclohexanone (155.7° C.), 2-methyl-4-phentanone (being equal to MIBK, 115.9° C.), N,N-dimethylformamide (153° C.), N,N-dimethylacetamide (166° C.), dimethylsulfocide (189° C.), etc.

A percentage of the solvent having the boiling point of less than 120° C. in the coating solvent is preferably 50 weight % to 100 weight %, more preferably 70 weight % to 100 weight %, particularly preferably 90 weight % to 100 weight %, without being limited thereto.

### 1-(17) Others

In addition to the above described components, resin, coupling agent, anti-stain agent, stain agent (pigment and dye), anti-foaming agent, flame retardant, ultraviolet absorbing agent, infrared absorbing agent, adhesive, polymerization inhibitor, anti-oxidant, surface modifying agent, etc. may be added to the film of the invention.

### 1-(18) Transparent Support

An example of support of the film of the invention may include a translucent resin film, a translucent resin plate, a translucent resin sheet, or transparent glass, without being limited thereto. An example of the translucent resin film may include a celluloseacylate (for example, a cellulosetriacetate film (refractive index: 1.48), a cellulosediacetate film, a celluloseacetatebutylate film, a celluloseacetatepropionate film, etc.), a polyethyleneterephthalate film, a polyethersulfone film, a polyacryl resin film, a polyurethane resin film, a polyester film, a polycarbonate film, a polysulfone film, a polyether film, a polymethylpentene film, a polyetherketone film, a (meta)acryinitril film, etc.

The thickness of support is typically 25 to 1,000 μm, preferably 25 to 250 μm, more preferably 30 to 90 μm.

The width of support may be random, typically 100 to 500 mm, preferably 800 to 3,000 nm, more preferably 1,000 to 2,000 mm from a standpoint of handling, yield, productivity, etc.

The length of a raw material roll for the support can be selected arbitrary, but, from a standpoint of handling, yield and productivity, is generally used within a range of from 300 to 10,000 m, preferably from 500 to 7,000 m and more preferably from 1,000 to 4,000 m.

The surface of support is preferably smooth. For example, an average roughness Ra of the support surface is preferably 1 μm or less, more preferably 0.0001 to 0.5 mm, particularly preferably 0.001 to 0.1 mm.

<Cellulose Acylate Film>

Among the above-mentioned films, the cellulose acylate film which has high transparency and small optical birefringence and which can be easily manufactured and generally used as a protective film of a polarizing plate is preferable.

For the purpose of improvement of dynamical characteristics, transparency, planarity, and the like of the cellulose acylate film, a variety of improvement technologies are known and the technology described in Kokai Gihou No. 2001-1745 can be applied to the film according to the present invention.

As the cellulose acylate film according to the present invention, a cellulose triacetate film is preferable and it is preferable that cellulose acetate of which the degree of acetification is in the range of 59.0 to 61.5% is used for the cellulose acylate film. The degree of acetification means an amount of coupled acetic acid per unit mass of cellulose. The degree of acetification complies with measurement and calculation of the degree of acetification in ASTM: D-817-91 (test method of cellulose acetate, etc.).

The viscosity average degree of polymerization (DP) of cellulose acylate is preferably 250 or more and more preferably 290 or more.

The cellulose acylate used in the present invention has preferably a value of Mw/Mn (where Mw is a weight average molecular weight and Mn is a number average molecular weight) close to 1.0 in gel permeation chromatography, that is, preferably a narrow molecular weight distribution. The specific value of Mw/Mn is preferably in the range of 1.0 to 1.7, more preferably in the range of 1.3 to 1.65, and most preferably in the range of 1.4 to 1.6.

Generally, hydroxyl groups at the 2, 3 and 6-positions of cellulose acylate are not uniformly distributed by ⅓ of the entire degree of substitution, but the degree of substitution of hydroxyl group at the 6-position tends to become smaller. In the invention, it is preferable that the degree of substitution of hydroxyl group at the 6-position is larger than hydroxyl groups at the 2 and 3-positions.

With regard to the entire degree of substation, 6 hydroxyl group is substituted for an acyl group preferably by 32% or more, more preferably by 33% or more, and still more preferably by 34% or more. It is preferable that the degree of substitution of acyl group at the 6-position of cellulose acylate is 0.88 or more. The 6 hydroxyl group may be substituted for a propionyl group, a butyroyl group, a valeroyl group, a benzoyl group, an acryloyl group, and the like which have a carbon number of 3 or more.

In the invention, as cellulose acylate, cellulose acetate obtained using the methods described in Paragraph Nos. “0043” to “0044” (example and synthesis example 1), Paragraph Nos. “0048” to “0049” (Synthesis example 2), and Paragraph Nos. “0051” to “0052” (Synthesis example 3) of JP-A-11-5851 can be used.

<Manufacturing Cellulose Acylate Film>

The cellulose acylate film used in the invention can be manufactured by the use of a solution film forming method (solvent casting method). In the solvent casting method, a solution (dope) in which cellulose acylate is dissolved in an organic solvent is used to form a film.

The organic solvent preferably includes a solvent from ether having the number of carbon atoms of 3 to 12, ketone having the number of carbon atoms of 3 to 12, ester having the number of carbon atoms 3 to 12, and halide hydrocarbon having the number of carbon atoms of 1 to 6. Two or more organic solvents may be mixed for use.

Ether, ketone, and ester may have a ring-shaped structure. A compound having two or more functional groups (that is, —O—, —CO—, and —COO—) of ether, ketone, and ester can be used as the organic solvent. The organic solvent may have another functional group such as an alcohol hydroxyl group. Regarding the preferable number of carbon atoms of the organic solvent having two or more kinds of functional groups, the number of carbon atoms of a compound having any functional group is in the specific range of number.

Examples of esters having the number of carbon atoms of 3 to 12 include diisopropyl ether, dimethoxy methane, dimethoxy ethane, 1,4-dioxane, 1,3-dioxorane, tetrahydro furan, anisole, and phenetole.

Examples of ketones having the number of carbon atoms of 3 to 12 include acetone, methylethyl ketone, diethyl ketone, diisobutyl ketone, cyclohexanone, and methylcyclohexanone.

Examples of ester having the number of carbon atoms 3 to 12 include ethyl formate, propyl formate, pentyl formate, methylacetate, ethylacetate, and pentylacetate.

Examples of the organic solvent having two or more kinds of functional groups include 2-ethoxyethyl acetate, 2-methoxy ethanol, and 2-butoxy ethanol.

The number of carbon atoms of halide hydrocarbon is preferably 1 or 2 and more preferably 1. Halogen of halide hydrocarbon is preferably chlorine. The ratio of hydrogen atoms of halide hydrocarbon is substituted for halogen is preferably in the range of 25 to 75 mol %, more preferably in the range of 30 to 70 mol %, still more preferably in the range of 35 to 65 mol %, and most preferably in the range of 40 to 60 mol %. Methylene chloride is a representative halide hydrocarbon.

The adjustment of the cellulose acylate solution (dope) can be performed by the use of a general method. In the general method, treatment is performed at a temperature of 0° C. or more (at a normal temperature or at a high temperature). The preparation of the solution can be carried out by the use of dope preparing method and apparatus in a general solvent casting method. In the general method, halide hydrocarbon (particularly, methylene chloride) is preferably used as the organic solvent. A non-chloride solvent may be used which is described in Kokai Gihou No. 2001-1745 of Japan Institute of Invention and Innovation.

The amount of cellulose acylate is adjusted to be 10 to 40 weight % in the obtained solution. The amount of cellulose acylate is preferably in the range of 10 to 30 weight %. An additive to be described later may be added to the organic solvent (major solvent).

The solution can be prepared by agitating cellulose acylate and the organic solvent at a normal temperature (0 to 40° C.). A high-concentration solution may be agitated in a pressurized and heated condition. Specifically, cellulose acylate and the organic solvent are put into a pressurizing vessel, the vessel is sealed air-tightly, and then, the solution is heated and agitating in the range of temperature which is higher than the boiling point of the solvent at a room temperature under the pressurized condition and in which the solvent is not boiled. The heating temperature is normally 40° C. or more, preferably in the range of 60 to 200° C., and more preferably in the range of 80 to 110° C.

Respective components may be roughly mixed and then put into the vessel. Alternatively, the components may be put into the vessel.

The vessel necessarily has an agitable structure. The vessel can be pressurized by injecting inert gas such as nitrogen gas thereinto. The increase in steam pressure due to heating may be used. Alternatively, after air-tightly sealing the vessel, the components may be added thereto under a pressure.

It is preferable that the heating is performed from the outside of the vessel. For example, a jacket type heater may be used. The whole vessel may be heated by providing a plate heater outside the vessel and circulating a liquid along pipe therein.

It is preferable that an agitating blade is provided in the vessel and the agitation is performed using the agitating blade. It is preferable that the agitating blade has a length to reach the vicinity of the wall of the vessel. It is preferable that a raking blade is provided at the end of the agitating blade so as to update a liquid film on the wall of the vessel.

The vessel may be provided with meters such as a manometer and a thermometer. The components are dissolved in the solvent in the vessel. The prepared dope is taken out of the vessel after being cooled or is cooled with a heat exchanger after being taken out of the vessel.

The solution may be prepared by the use of a cooling dissolution method. By using the cooling dissolution method, cellulose acylate can be dissolved in an organic solvent in which it is difficult to dissolve cellulose acylate in the general dissolution method. By using the cooling dissolution method, it is possible to rapidly obtain a uniform solution even from a solvent which can dissolve the cellulose acetate.

In the cooling dissolution method, cellulose acylate is slowly added to the organic solvent at a room temperature while being agitated.

The amount of cellulose acylate added to the mixture is preferably in the range of 10 to 40 weight %. The amount of cellulose acylate is more preferably in the range of 10 to 30 weight %. Any additive may be added to the mixture.

Next, the mixture is cooled to the temperature in the range of −100° C. to −10° C. (preferably in the range of −80° C. to −10° C., more preferably in the range of −50° C. to −20° C., and most preferably in the range of −50 to −30° C.). The cooling can be carried out, for example, in a dry ice methanol bath (−75° C.) or in a cooled diethyl glycol solution (−30° C. to −20° C.). The mixture of cellulose acetate and the organic solvent is solidified by the cooling.

The cooling speed is preferably 4° C./min or more, more preferably 8° C./min or more, and most preferably 12° C./min or more. The larger cooling speed is preferably, but the theoretical upper limit thereof is 10000° C./sec, the technical upper limit is 1000° C./sec, and the practical upper limit is 100° C./sec. The cooling speed is obtained by dividing the difference between the temperature at the time starting the cooling and the final cooled temperature by the time until the final cooled temperature is reached after the cooling is started.

When the mixture is heated to the range of 0 to 200° C., preferably to the range of 0 to 150° C., more preferably to the range of 0 to 120° C., and most preferably to the range of 0 to 50° C., cellulose acetate is dissolved in the organic solvent. The heating can be embodied only by leaving the mixture at a room temperature or by heating the mixture with a warm bath.

The heating speed is preferably 4° C./min or more, more preferably 8° C./min, and most preferably 12° C./min. The larger temperature rising speed is preferable, but the theoretical upper limit thereof is 10,000° C./sec, the technical upper limit is 1,000° C./sec, and the practical upper limit is 100° C./sec. The temperature rising speed is obtained by dividing the difference between the temperature at the time starting the heating and the final heated temperature by the time until the final heated temperature is reached after the heating is started.

In this way, a uniform solution is obtained. When the dissolution is not sufficient, the cooling and the heating may be repeated. It is possible to judge whether the dissolution is sufficient by only observing the appearance of the solution with eyes.

In the cooling dissolution method, it is preferable that a sealed vessel is used so as to avoid the invasion of moisture due to dew formation at the time of cooling. In the cooling and heating processes, the dissolution time can be reduced by pressurizing the vessel at the time of cooling and depressurizing the vessel at the time of heating. It is preferably a pressure-resistance vessel is used to perform the pressurizing and depressurizing processes.

The 20 weight % solution in which cellulose acetate (degree of acetification: 60.9%, viscosity average degree of polymerization: 299) is dissolved in methylacetate by the use of the cooling dissolution method has a pseudo phase transition point of a sol phase and a gel phase in the vicinity of 33° C. and is in a uniform gel phase at the temperature. Accordingly, the solution need be maintained at a temperature equal to or greater than the pseudo phase transition temperature and preferably at a temperature higher by 10° C. than the gel phase transition temperature. However, the pseudo phase transition temperature varies depending on the degree of acetification or the viscosity average degree of polymerization of cellulose acetate, a concentration of the solution, or the used organic solvent.

A cellulose acylate film is manufactured from the prepared cellulose acylate solution (dope) by the use of the solvent casting method.

The dope is allowed onto a drum or a band in a flow casting manner and the solvent is vaporized to form a film. The concentration of the dope before the flow casting is preferably adjusted so that the content of solid is in the range of 18% to 35%.

It is preferable that the surface of the drum or band is finished into a specular status. The flow casting and drying processes of the solvent casting method is disclosed in U.S. Pat. Nos. 2,336,310, 2,367,603, 2,492,078, 2,492,977, 2,492,978, 2,607,704, 2,739,069, and 2,739,070, U.K. Patent Nos. 640,731 and 736,892, and JP-B-45-4554, JP-B-49-5614, and JP-B-62-115035.

It is preferable that the dope is flow-cast onto the drum or band of which the surface temperature is 10° C. or less. After the flow casting, the dope is preferably dried by supplying a blow to the dope for 2 seconds or more. The obtained film is peeled off from the drum or the band and is dried with a high-temperature blow of which the temperature is sequentially varied from 100° C. to 160° C., thereby vaporizing the remaining solvent. The above-mentioned method is described in PCT Japanese Translation Patent Publication No. 5-17844. By employing the method, it is possible to reduce the time from the flow casting to the peeling. In order to put the method into practice, it is preferable that the dope is changed to a gel phase at the surface temperature of the drum or band.

A film may be manufactured by flow-casting two or more layers by the use of the solvent casting method using a plurality of prepared cellulose acylate solutions (dopes). In this case, the dope is flow-cast onto the drum or band and the solvent thereof is vaporized to manufacture a film. The concentration of the dope before the flow casting is preferably adjusted so that the content of solid is in the range of 10 to 40 weight %. The surface of the drum or band is finished into a specular status.

When two or more layers are formed by flow-casting a plurality of cellulose acylate solutions, it is possible to flow-cast the plurality of cellulose acylate. Accordingly, a film may be manufactured by flow-casting and laminating the solutions containing cellulose acylate from a plurality of flow casting holes provided in a support with a pitch in the traveling direction of the support, the method of which is described in JP-A-61-158414, JP-A-1-122419, and JP-A-11-198285. A film may be manufactured by flow-casting the cellulose acylate solution from two flow casting holes, the method of which is described in JP-B-60-27562 and JP-A-61-94724, JP-A-61-104813, JP-A-61-158413, and JP-A-6-134933. The method of flow-casting a cellulose acylate film in which a flow of a cellulose acylate solution having a high viscosity is inserted into a cellulose acylate solution having a low viscosity and the cellulose acylate solutions having the high- and low-viscosities are simultaneously pressed out.

Alternatively, by using two flow casting holes, the film formed on the support by the first flow casting hole is peeled off and the second flow casting process is performed to the side contacting the support surface, thereby manufacturing a film, the method of which is described in JP-B-44-20235. The flow-cast cellulose acylate solutions may be equal to or different from each other, which is not particularly limited. In order to allow a plurality of cellulose acylate layers to have different functions, the cellulose acylate solutions corresponding to the functions may be pressed out from the flow casting holes.

In the present invention, by simultaneously flow-casting the cellulose acylate solution and a different functional layer (such as adhesive layer, dye layer, anti-static layer, anti-halation layer, UV absorbing layer, and polarizing layer) forming solution, it may be possible to simultaneously form a functional layer and a film.

In order to obtain a necessary film thickness with a single-layer solution, it is necessary to press out the cellulose acylate solution with a high concentration and a high viscosity. In this case, solids are generated with the poor stability of the cellulose acylate solution, thereby causing a blob failure or a flatness failure. In order to solve the problem, a plurality of cellulose acylate solutions is flow-cast from the flow-casting holes. Accordingly, it is possible to simultaneously press out solutions with high viscosities onto the support and to manufacture an excellent plane-shaped film with high flatness. In addition, by using a thick cellulose acylate solution, it is possible to reduce the drying load, thereby enhancing the formation speed of the film.

In the cellulose acylate film, to improve mechanical property or to improve drying speed after casting in manufacturing films, a plasticizer can be added. Ester phosphate or ester carbonate is used for the plasticizer. The ester phosphate, for example, includes triphenyl phosphate (TTP), diphenyl biphenyl phosphate, and tricrecyl phosphate (TCP). The ester carbonate typically is ester phthalate and ester citrate. The ester phthalate, for example, includes dimethyl phthalate (DMP), diethyl phthalate (DEP), dibutyl phthalate (DBP), dioctyl phthalate (DO), diphenyl phthalate (DPP), and diethylhexyl phthalate (DEHP). The ester citrate, for example, includes o-acetyl citric acid triethyl (OACTE) and o-acetyl citric acid tributyl (OACTB). An example in addition to the ester carbonate includes various trimelltic esters such as oleic butyl, ricinoleic methyl acetyl, and sebacate dibutyl. Phthalate ester plasticizers (DMP, DEP, DBP, DOP, and DEHP) are preferably used. The DEP and DPP are particularly preferable.

The additional amount of the plasticizer is preferably 0.1 to 25 weight % of the amount of the cellulose acylate, more preferably 1 to 20 weight %, and most preferably 3 to 15 weight %.

In the cellulose acylate film, an anti-degrading agent (i.e. anti-oxidizing agent, peroxide decomposing agent, radical preventing agent, metal inactive agent, acid preventing agent, and amine) may be added. They are described in various publications such as JP-A-3-199201, JP-A-5-197073, JP-A-5-194789, JP-A-5-27147, and JP-A-6-107854. The additional amount of the anti-degrading agent is 0.01 to 1 weight % of manufactured solution (dope) in consideration of effect of the anti-degrading agent and bleeding out onto a surface of a film, and more preferably 0.01 to 0.2 weight %. Particularly, a preferable anti-degrading agent, for example, may be butyl hydroxyl toluene (BHT) and tribenzyl amine (TBA).

In the cellulose acylate film, to adjust retardation of the film, a retardation raising agent can be used as necessary. The retardation of the film is preferable in 0 to 300 nm in a direction of the film thickness and 0 to 1,000 nm in a direction of the film inside.

An aromatic compound having at least two aromatic rings is preferable as the retardation raising agent and the aromatic compound is used within a range of 0.01 to 20 weight % on 100 weight % of the cellulose acylate. It is preferable that the aromatic compound is used within a range of 0.05 to 15 weight % on 100 weight % of the cellulose acylate and more preferable that the aromatic compound is used within a range of 0.1 to 10 weight %. Two and more types of the aromatic compound may be used in combination.

More specifically, they are described in JP-A-2000-111914, JP-A-2000-275434, and JP-A-2002-236215 and WO00/065384, etc.

<Stretching Process of Cellulose Acylate Film>

The manufactured cellulose acylate film also can improve prominence and depression of the surface of the film generated by dry stain or dry contraction due to stretching process. In addition, the stretching process is used for adjusting the retardation.

It is not limited to a method of stretching process in a wide direction, but the example may be a stretching method by tender.

In addition, more preferably, the stretch is performed in a longitudinal direction of a roll and a draw rate is adjusted between pass rolls sending a roll film, whereby the longitudinal stretch can be performed.

<Polyethylene Phthalate Film>

In the invention, polyethylene phthalate film also is excellent in transparency, mechanical strength, planarity, pharmaceutical resistance, and moisture resistance and is preferably used in lower cost.

To improve a degree of adhesion between and a hard coat layer disposed on the transparent film, it is more preferable that the transparent film is facilitated in adhesion.

A PET film in which adhesion facilitating layer is added, for example, may be A4100 and A4300 of Cosmoshine made by Toboyo CO,. LTD.

### 2. Layers constituting film

The film according to the present invention is obtained by mixing the various compounds and applying the mixture, and layers constituting the film according to the present invention will be described now.

### 2-(1) Hard Coat Layer

In the film of the invention, to be invested with mechanical strength, a hard coat layer is provided on one surface of a transparent support. A low refractive index layer is provided on the hard coat layer, and more preferably, a medium refractive index layer and a high refractive index layer are provided between the hard coat layer and the low refractive index layer, thereby forming an anti-refracting film.

The hard coat layer may be formed out of laminated layers with two or more layers The refractive index of the hard coat layer in the invention is preferably within a range of 1.48 to 2.00 from optical design for obtaining the anti-reflective film, more preferably, 1.52 to 1.92, and still more preferably, 1.55 to 1.80. In the invention, since at least one low refractive index layer is provided on the hard coat layer, the refractive index is preferably within the range in a viewpoint such as an anti-reflective property and a color of reflective light.

The film thickness of the hard coat layer, in a viewpoint of investing durability sufficient for the film and impact resistance, is generally 0.5 μm to 50 μm, preferably 2 μm to 35 μm, more preferably 5 μm to 35 μm, still more preferably 8 μm to 35 μm, and most preferably 20 μm to 35 μm.

In addition, strength of the hard coat layer, in a test for hardness of a pencil, is preferably 2 H or more, more preferably 3 H or more, still more preferably 4 H or more, and most preferably 5 H or more. In the hard coat film using an ionizing radiation curing binder in the invention, 4 H may be achieved at 8 μm or more of the thickness. 5 H is may be achieved at 20 μm or more. In addition, the thickness is 35 μm or less, thereby increasing brightness or curl and handling-ability or brightness of the film.

In addition, in the Taber test according to JIS K5400, it is preferable that the wear amount of test piece before and after the test is lower.

It is preferable that the hard coat layer is formed by cross-linking reaction or polymerization reaction. For example, an applying composition including an ionizing radiation curing multifunctional monomer or a multifunctional oligomer is applied on the transparent support, whereby the multifunctional monomer or the multifunctional oligomer can be formed by the cross-linking reaction or the polymerization reaction.

The functional group of the ionizing radiation curing multifunctional monomer or the multifunctional oligomer is preferably light, electronic ray, a radial polymeric functional group.

The optical polymer, for example, may be un-saturation polymeric functional group such as an (metha) acryloyl group, a vinyl group, a styryl group, and an allyl group, the (metha) acryloyl group is preferable. In order to invest an inner dispersing property, matte particles, an average diameter of which, for example particles of non-organic compound, a polymerization in corpuscle of non-organic compound or resin particles, is in 0.5 to 10 μm, preferably 2 to 8.0 μm may be contained in the hard coat layer.

A major object of the anti-reflective film of the invention is to function as high blackness as high as possible and a surface haze is preferably less than 5%, more preferably less than 3%. On the other hand, without the surface haze (≈0%), it is flat plane. Accordingly, since reflection on an image in phase increases, the surface haze is preferably 0.1% or more so as not to degrade visibility. That is preferably 0.1 % or more to less than 5%.

Meanwhile, the inner haze is preferably less than 36% , more preferably less than 25%, more preferably less than 15%, still more preferably less than 5% and most preferably less than 1%. When the inner haze exists, front brightness of a display decreases and a displayed image becomes dark and vague. Accordingly, it is preferable that the inner haze do not exist. The value of the inner haze is a value that the value of the surface haze is subtracted from the value of the former haze, and a method of measuring is described below.

### 2-(2) Antiglare Layer

An antiglare layer is formed in order to contribute a hard-coat property, for improving an antiglare property by surface dispersion and preferably an abrasion resistance of the film, on the film. In the film of the invention, the antiglare layer may take also a role of the hard coat layer.

As a method of forming the antiglare property, a method of forming by stacking an urging film which is in a shape of a matte having fine prominence and depression on the surface as disclosed in JP-A-6-16851, a method of using a curing contraction of an ionizing radiation curing resin by difference of a dosage amount of an ionizing radiation as disclosed in JP-A-2000-206317, a method of forming prominence and depression on a coating film by decreasing a mass ratio of good solvent to a translucent resin in a dry condition while gelling and solidifying a translucent corpuscle and a translucent resin as disclosed in JP-A-2000-338310, a method of investing prominence and depression on a surface by outer pressure as disclosed in JP-A-2000-275404, and the like have known, and these disclosed method can be used.

The antiglare layer used for the invention preferably includes a binder for investing the hard coat property and translucent particles for investing the antiglare property, and a solvent as a necessary components, it is preferable that prominence and depression on surface are formed by a projection formed of a projection of the translucent particle itself or polymer with a plurality of particles.

The antiglare layer formed by dispersion of the matte particles is formed of the binder and the translucent particles dispersed in the binder. It is preferable that the antiglare layer having the antiglare property have both the antiglare property and the hard coat property.

As specific examples of the matte particle, the examples may be preferably an inorganic compound such as silica particles, TiO₂ particles; and resin particles such as acryl particles, cross-linking acryl particles, polystyrene particles, cross-linking styrene particles, melamine resin particles, and benzoguanamine resin particles. In these, the cross-linking styrene particles, the cross-linking acryl particles, and acryl particles are preferable.

The shape of the matte particle may be neither a spherical shape nor an uncertain shape. In addition, two or more types of matte particles having different diameters may be used together.

The matte particle contained in the antiglare layer so that the amount of the matte particle of the formed antiglare hard coat layer is preferably 10 to 1,000 mg/m² and more preferably 100 to 700 mg/m².

The granular distribution of the matte particle is measured by the Coulter Counter Method and the measured distribution is converted into distribution of the number of particles.

### 2-(3) High Refractive-Index Layer and Middle Refractive-Index Layer

For the film of the invention, anti-reflectance may be increased by preparing the high refractive-index layer and middle refractive-index layer.

Hereinafter, in the specification, the high refractive-index layer and the middle refractive-index layer will be generically called as the high refractive-index layer. High-, middle-, and low-represented in the high refractive-index layer, the middle refractive-index layer, and the low refractive-index layer according to the invention indicate magnitude relation of relative refractive-index between the layers. In addition, the tropic index in relation with a transparent support is preferable to satisfy the following relationships: the transparent support>the low refractive-index layer and the high refractive-index layer>the transparent support.

Further, the high refractive-index layer, the middle refractive-index layer, and the low refractive-index layer are generically called as an anti-reflecting layer in the specification.

To prepare the anti-reflecting film by constructing the low refractive-index layer onto the high refractive-index layer, it is preferable that the refractive-index of the high refractive-index layer is in the range of 1.55 to 2.40, more preferably in the range of 1.60 to 2.20, further preferably in the range of 1.65 to 2.10, and the most preferably in the range of 1.80 to 2.00.

When forming the anti-reflecting film by sequentially applying the middle refractive-index layer, the high refractive-index layer, and the low refractive-index layer to the support, it is preferable that the refractive-index of the high refractive-index layer is in the range of 1.65 to 2.40 and more preferably in the range of 1.70 to 2.20. The refractive-index of the middle refractive-index layer is adjusted to be the value between the refractive-index of the low refractive-index layer and the refractive-index of the high refractive-index layer. The refractive-index of the middle refractive-index layer is preferably in the range of 1.55 to 1.80.

An inorganic particle of which main component is TiO₂, which is used in the high refractive-index layer and the middle refractive-index layer, is used in a dispersion phase for forming the high refractive-index layer and the middle refractive-index layer.

For the dispersion of the inorganic particle, the inorganic particle is dispersed in the dispersion medium in the presence of a dispersant.

The coating composition for forming the high refractive-index layer and the middle refractive-index layer is prepared by preferably adding the binder precursor (for example the ionizing radiation curing multifunctional monomer or oligomer and the like which will be described later) needed for forming the matrix and the photopolymerization initiator into the dispersion liquid in which the inorganic particle is dispersed in the dispersion medium. The high refractive-index layer and the middle refractive-index layer according to the invention are preferably formed by applying the coating composition for forming the high refractive-index layer and the middle refractive-index layer onto the transparent support and by curing caused by cross-linking reaction or polymerization reaction of the ionizing radiation curing compounds (e.g., multifunctional monomer or multifunctional oligomer and the like).

In addition, the binder of the high refractive-index layer and the middle refractive-index layer preferably has a cross-linking reaction or a polymerization reaction with the dispersants simultaneously or after applying the layers.

To the binder of the high refractive-index layer and the middle refractive-index layer prepared as above-mentioned, an anionic group of the dispersants is taken by the cross-linking reaction or the polymerization reaction of the preferable dispersants and the ionizing radiation curing multifunctional monomer or oligomer. For the binder of the high refractive-index layer and the middle refractive-index layer, the anionic group maintains the dispersion state of the inorganic particle and the cross-linked structure or polymerized structure gives coat forming ability to the binder. Therefore, physical strength, chemical resistance, and weather resistance of the high refractive-index layer and the middle refractive-index layer containing the inorganic particle are improved.

The binder of the high refractive-index layer is added by 5 to 80 wt % with respect to the solid content in the coating composition of the layer.

The content of the inorganic particle in the high refractive-index layer is preferably in the range of 10 to 90% by weight, more preferably in the range of 15 to 80% by weight, and particularly preferably in the range of 15 to 75% by weight relative to the weight of the high refractive-index layer. The inorganic particle may be used in combination of two or more kinds in the high refractive-index layer.

When the low refractive-index layer is on the high refractive-index layer, the refractive-index of the high refractive-index layer is preferably higher than the refractive-index of the transparent support.

The binder obtained on the high refractive-index layer by cross-linking reaction or polymerization reaction of the ionizing radiation curing compound containing aromatic rings, the ionizing radiation curing compounds containing halogenated atoms (e.g., Br, I, Cl, etc.) except fluorine, and the ionizing radiation curing compounds containing atoms such as S, N, P, etc. is preferably used.

The thickness of the film of the high refractive-index layer may be suitably set according to the applications. When the high refractive-index layer is used as an optical interferometric layer, which will be described later, the thickness of the film is preferably in the range of 30 to 200 nm, more preferably in the range of 50 to 170 nm, and particularly preferably in the range of 60 to 150 nm.

The high refractive-index layer is preferably constructed to the transparent support directly or through other layer.

### 2-(4) Low Refractive-Index Layer

In order to reduce the reflection ratio of the film according to the invention, the low refractive-index layer is needed to be used.

The refractive-index of the low refractive-index layer is 1.47 or less, preferably in the range of 1.20 to 1.47, more preferably in the range of 1.25 to 1.47, and particularly preferably in the range of 1.30 to 1.47.

The thickness of the low refractive-index layer is preferably in the range of 50 to 200 nm and more preferably in the range of 70 to 100 nm. The haze of the low refractive-index layer is preferably 3% or less, more preferably 2% or less, and the most preferably 1% or less. In order to enhance antifouling performance of the optical film, contact angle of the surface to water is preferably 90° or higher, more preferably 95° or higher, and particularly preferably 100° or higher.

The curable composition for forming the low refractive-index layer preferably contains the fluorine-containing polymer (A), the inorganic particle (B), and the organosilane compounds (C).

The binder is used for dispersing and maintaining the microparticles of the invention in the low refractive-index layer. The binder described in the hard coat layer may be used as the binder, however it is preferable to use the fluorine-containing polymer having low refractive-index of binder itself or the fluorine-containing sol-gel material. For the fluorine-containing polymer or the fluorine-containing sol-gel, the material which is cross-linked by heat or ionizing radiation and has coefficient of kinetic friction of the surface of the obtaining low refractive-index layer in the range of 0.03 to 0.30 and contact angle to water in the range of 85 to 120° is preferable.

### 2-(5) Anti-Static Layer and Conductive Layer

In the invention, it is preferable to provide an anti-static layer in consideration of preventing static electricity on the film surface. As for a method of forming the anti-static layer, a known method can be used, for example, a method of coating a conductive coating solution which contains conductive particles and reactive curing resin, or a method of forming a conductive thin layer by depositing or sputtering metals or metallic oxides which forms a transparent layer. The conductive layer can be formed directly on the support or on the support with a primer layer which enhances adhesion to the support therebetween. In addition, the antistatic layer can be used as a part of an antireflection layer. For using the conductive layer closer to the outermost layer, sufficient antistatic property can be exhibited with the thin film thickness.

The thickness of the antistatic layer is preferably in the range of 0.1 to 10 μm, more preferably in the range of 0.03 to 7 μm, and further preferably 0.05 to 5 μm. The surface resistance of the antistatic layer is within the range of preferably in the range of 10⁵ to 10¹² Ω/sq, more preferably in the range of 10⁵ to 10⁹ Ω/sq, and further preferably 10⁵ to 10⁸ Ω/sq. The surface resistance of the antistatic layer can be measured by a four-probe method.

The antistatic layer has a light transmittance in 550 nm wavelength of preferably 50% or more, more preferably 60 % or more, still more preferably 65 % or more, and most preferably 70% or more.

### 2-(6) Antifouling Layer

In the invention, the outermost layer (for example, low refractive-index layer) can be also used as an antifouling layer. The antifouling layer decreases surface energy of the antireflection layer and prevents the film from hydrophilic or lipophilic contaminations.

The antifouling layer can be formed by using fluorine-containing polymer or antifouling agent.

The thickness of the antifouling layer is within the range of preferably 2 to 100 nm, and more preferably 5 to 30 nm.

### 2-(7) Interference Pattern Prevention Layer

When there is a substantial refractive-index difference between the transparent support and the hard coat layer, or the transparent support and the antiglare layer (0.03 or more of refractive-index difference), reflective light is generated at the interface of the transparent support/hard coat layer, or the transparent support/antiglare layer. The reflective light interferences with the reflective light on the surface of the antireflection layer whereby the interference pattern due to slight film thickness stain of the hard coat layer (or antiglare layer) can be generated. In order to prevent such a interference pattern, for example, the interference pattern prevention layer may be provided so that medium refractive index np is set between the transparent support and the hard coat layer (or antiglare layer) and satisfies satisfy the following equation.

dp=(2N−1)×λ/(4np)

where λ is the value within the range of 450 to 650 nm in visible light wavelength, and n is an integer of greater than 0.

In addition, for laminating the antireflection film on the image display or the like, an adhering agent layer (or adhesive layer) may be laminated on the surface to which the antireflection of the transparent support is not laminated. In this embodiment, when there is the substantial refractive index difference (0.03 or more) between the transparent support and the adhering agent layer (or adhesive layer), the reflective light is generated at the transparent support/adhering agent layer (or adhesive layer). This reflective light interferes with the reflected light on the surface of the antireflection layer whereby the interference pattern due to film thickness stains on the support or the hard coat layer may be generated. In order to prevent such interference stains, the interference pattern preventing layer may be provided on the layer to which the antireflection layer of the transparent support is not laminated.

The interference pattern preventing layer is described in JP-A-2004-345333 in detail. In the invention, the interference pattern preventing layer described herein may be used.

### 2-(8) Adhesion Facilitating Layer

On the film of the invention, an adhesion facilitating layer may be provided. The adhesion facilitating layer is a layer which functions to facilitate adhesion between the protection film for polarizing plate and the adjacent layer thereof, or the hard coat layer and the support.

Examples of the adhesion facilitating treatment include a treatment of providing the adhesion facilitating layer on the transparent plastic film by adhesion facilitating agent comprising polyester, acylic acid ester, polyurethane, polyethyleneimine, silane coupling agent and the like.

A preferred example of the adhesion facilitating layer useful for the invention include containing a high molecular compound having —COOM groups (where M represents hydrogen atom or cation), and a further preferred example includes providing a layer containing the high molecular compound having —COOM groups on a film base and adjacently providing a layer containing hydrophilic high molecular compound on the polarizer. Examples of the high molecular weight compound having —COOM groups include maleate-styrene copolymer having —COOM groups, vinyl acetate-maleic acid copolymer having —COOM groups, or vinyl acetate-maleic acid-maleic anhydride copolymer having —COOM groups. Particularly, the vinyl acetate-maleic acid copolymer having —COOM groups is preferred. These high molecular weight compounds are used alone or in combination with two or more kinds. A preferred weight average molecular weight is within the range of 500 to 500,000. Particularly preferred examples of the high molecular weight having —COOM groups include examples described in JP-A-6-094915 and JP-A-7-333436.

Preferred examples of the hydrophilic high molecular weight compound include hydrophilic cellulose derivatives (for example, methyl cellulose, carboxy methyl cellulose, hydroxyl cellulose or the like), polyvinyl alcohol derivatives(for example, polyvinyl alcohol, vinyl acetate-vinyl alcohol copolymer, polyvinyl acetal, polyvinyl formal, polyvinyl benzal or the like), natural high molecular weight compound(for example, gelatin, casein, Arabian rubber or the like), hydrophilic polyester derivatives (for example, partially sulfured polyethylene terephthalate or the like), and hydrophilic polyvinyl derivatives (for example, poly-N-vinylpyrrolidone, polyacrylamide, polyvinyl indazole, polyvinyl pyrazole, or the like). These may be used alone or in combination with two or more kinds.

The thickness of the adhesion facilitating layer is preferably within the range of 0.05 to 1.0 μm. With the thickness of less than 0.05 μm, sufficient adhesion is hardly obtained, and with the thickness of more than 1.0 μm, the effect of adhesion is saturated.

### 2-(9) Anti-Curling Layer

On the film of the invention, an anti-curling treatment may be subjected. The anti-curling treatment is to give a function of inwardly curling the surface on which the anti-curling treatment is performed. By subjecting the anti-curling treatment, when any surface treatment is subjected on one surface of the transparent support and another kinds of surface treatment are subjected on both surface of the transparent, a case where the surface which tends to curl inwardly is prevented.

The anti-curling layer may be formed on the opposite side of the hard coat layer, antiglare layer or antireflection layer of the transparent support. In addition, the adhesion facilitating layer may be provided on one surface of the transparent support and the anti-curling treatment may be subjected on the opposite layer.

Specific examples of the anti-curling treatment include a method of coating solvents, and a method of coating solvents and translucent resins layer such as cellulose triacetate, cellulose diacetate, cellulose acetate propionate and the like. Specifically, the method of coating solvents is performed by coating compositions containing solvents for dissolving or swelling a cellulose acrylate film used for the protective film for polarizing plate. Therefore, it is preferable that a coating solution of the layer which functions to prevent curling contains ketone-based or ester-based organic solvents. Preferred examples of ketone-based organic solvents include acetone, methylethyl ketone, methylisobutyl ketone, cyclohexanone, ethyl lactate, acetyl acetone, diacetone alcohol, isophorone, ethyl-n-butyl ketone, diisopropyl ketone, diethyl ketone, di-n-propyl ketone, methyl cyclohexanone, methyl-n-butyl ketone, methyl-n-propyl ketone, methyl-n-hexyl ketone, methyl-n-heptyl ketone and the like. Preferred examples of the ester-based organic solvents include methyl acetate, ethyl acetate, butyl acetate, methyl lactate, ethyl lactate and the like. In addition to the mixture of the dissolving solvents and/or swelling solvents, solvents for not dissolving can be used. The anti-curling treatment can be performed using compositions containing these solvents in a appropriate ratio according to the curling condition of the translucent resin film or kinds of resins, and coating amount.

### 2-(10) Water Absorption Layer

The water absorption layer may also be employed in the film of the invention. A water absorber can be selected from compounds having a water absorption property which mainly is an alkali earth metal. Examples include BaO, SrO, CaO, MgO, and the like. Further, the absorber can be selected from metallic elements such as Ti, Mg, Ba, and Ca. The particle size of the water absorption particle is preferably 100 nm or less, and more preferably 50 nm or less.

2-(11) Primer Layer. Inorganic Thin-Film Layer

The film of the invention may be provided with a well-known primer layer or an inorganic thin-film layer in-between the support and the low refractive-index layer to give a higher gas-barrier property.

For the primer layer, for example, an acrylic resin, an epoxy resin, a urethane resin, a silicone resin, or the like can be used. In the invention, the primer layer is preferably an organic-inorganic hybrid layer, and the inorganic thin-film layer is preferably an inorganic deposited layer or a precise inorganic coated thin-film. The inorganic deposited layer is preferably a deposited layer of silica, zirconia, alumina, or the like. The inorganic deposited layer can be formed by a vacuum deposition method or a sputtering method.

### 3. Layer Constitution of Film

For the film of the invention, a well-known layer constitution can be applied with the use of the aforementioned layers. For example, representative examples are shown as below.

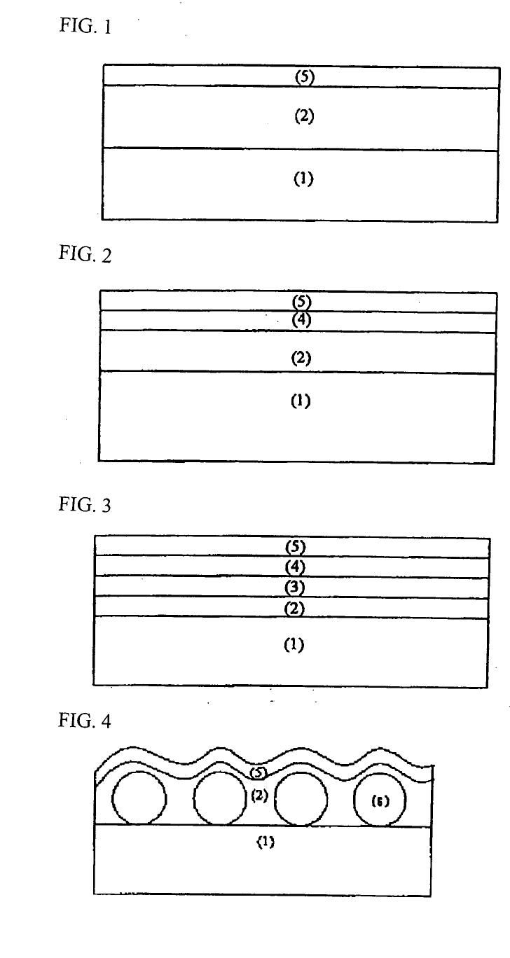

a. support/hard coat layer/low refractive-index layer (FIG. 1)

b. support/hard coat layer/high refractive-index layer/low refractive-index layer (FIG. 2)

c. support/hard coat layer/middle refractive-index layer/high refractive-index layer/low refractive-index layer (FIG. 3)

Like a. (FIG. 1), the hard coat layer (2) is coated on the support (1) and the low refractive-index layer (5) is laminated thereon, so as to be suitably used as an antireflection film. For the low refractive-index layer (5), the low refractive-index layer (5) having a film thickness of around ¼ of a light wavelength is formed on the hard coat layer (2), such reduces the surface reflectance according to a principle of the film interference.

In addition, b. as in (FIG. 2), the hard coat layer (2) is coated on the support (1), and the high refractive-index layer (4) and the low refractive-index layer (5) are laminated thereon, so as to be suitably used as an antireflection film. Further, c. as in (FIG. 3), a layer constituted in the order of the support (1), the hard coat layer (2), the middle refractive-index layer (3), the high refractive-index layer (4), and the low refractive-index layer (5) is provided such to give the reflectance of 1% or less.

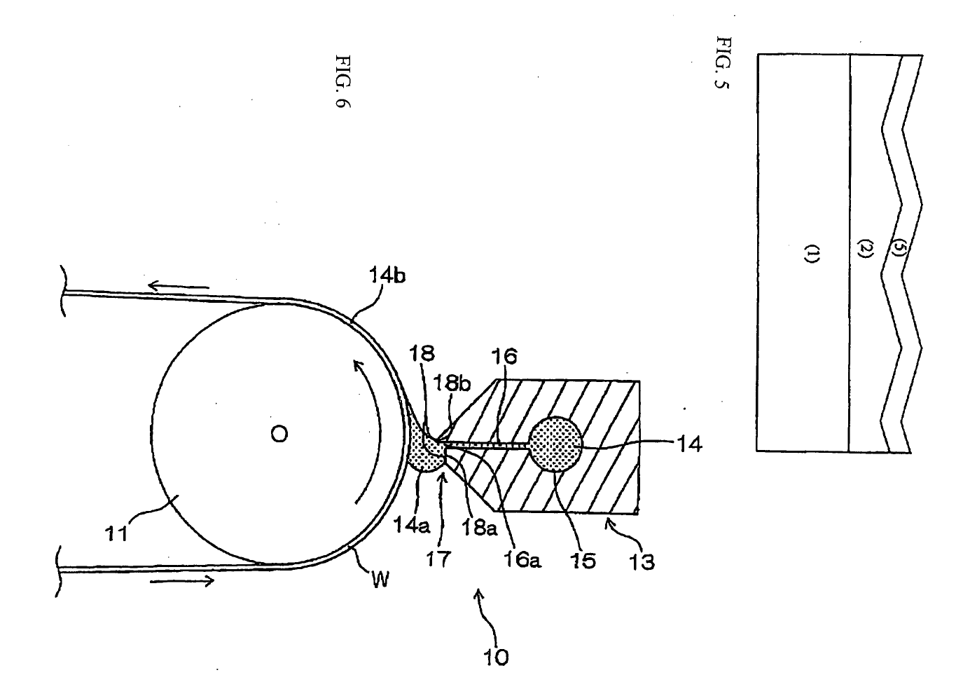

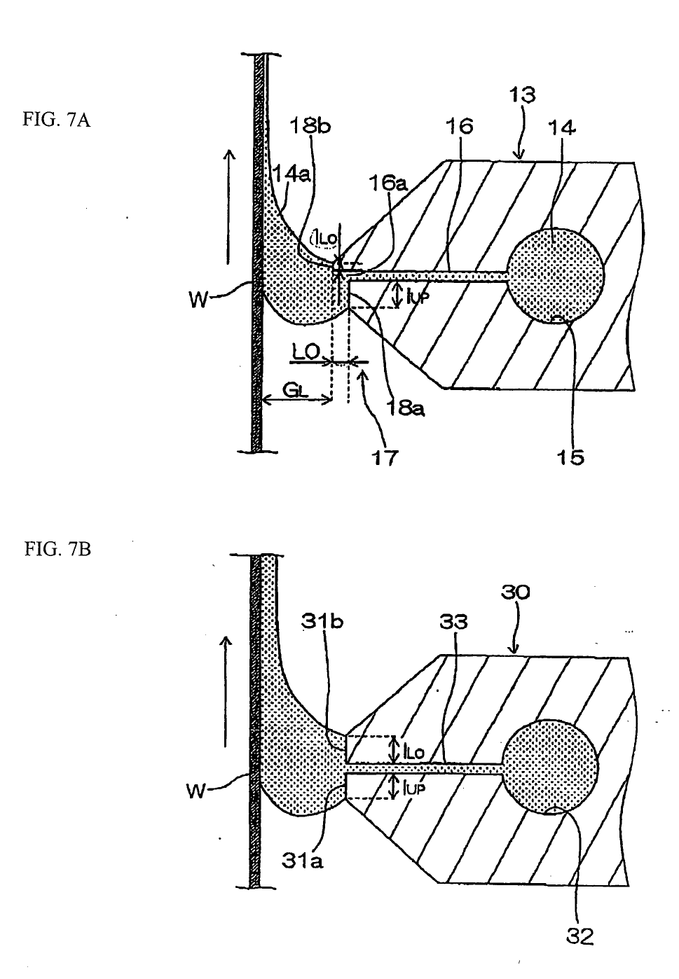

In the constitutions a to c, the hard coat layer (2) can be an antiglare layer having an antiglare property. The antiglare property may be obtained by the dispersion of matte particles (6) as shown in FIG. 4, or may be formed by incorporating a surface subjected to a process such as an emboss process as shown in FIG. 5. The antiglare layer formed by the dispersion of the matte particles (6) is constituted by a binder and translucent particles dispersed in the binder. The antiglare layer having the antiglare property preferably has a combination of antiglare property and hard coat property, and may be formed with a plurality of layers, for example with 2 to 4 layers.

In addition, as the transparent support and a layer which may be provided in-between the layers positioned more on the surface side than the support or provided on the uppermost surface, an interference-stain (rainbow-stain) preventing layer, an antistatic layer (when there is a demand of lowering the surface resistance value from a display side, when dust on the surface becomes a problem), other hard coat layers (when the hardness is not sufficient only with a mono-layered hard coat layer and an antiglare layer), a gas barrier layer, a water absorption layer (vapor barrier layer), an improved adhesive layer, an antifouling layer (anti-staining layer), and the like can be exemplified.

The refractive index of each layer constituting the antireflective film according to the invention preferably satisfies the following relationship:

refractive index of hard coat layer>refractive index of transparent support>refractive index of low refractive-index layer. In addition, when the antireflective film according to the invention has the constitution laminated in the order of transparent support/hard coat layer/high refractive-index layer/low refractive-index layer, the refractive index of each layer preferably satisfies the following relationship:

refractive index of low refractive-index layer<refractive index of hard coat layer<refractive index of high refractive-index layer.

### 4. Preparation Method

The film of the invention can be formed according to the following method, but is not limited by the method.

### 4-(1) Preparation of Coating Solution

<Preparation>

First, a coating solution containing the component for forming each layer is prepared. At this time, increase in the water content in the coating solution can be prevented by controlling the amount of solvent volatilization to a minimum. The water content in the coating solution is preferably 5% or less, and more preferably 2% or less. The control of the amount of solvent volatilization can be achieved by improving the sealing property at the time of stirring after charging each material into a tank, or by minimizing the air contacting area of the coating solution during the solution transferring process. In addition, there may be provided with a means for reducing the water content during coating or before or after the coating.

<Coating Solution Property>

For the coating solution for forming a layer with a dry film thickness of 200 nm or less such as a low refractive-index layer·a middle refractive-index layer·a high refractive-index layer·an antifouling layer, it is necessary to control the property of the solution for the moment of coating, particularly a viscosity and a surface tension, because the maximum coatable speed is largely affected by the solution properties.

The viscosity is preferably 2.0 (mPa·sec) or less, more preferably 1.5 (mPa·sec) or less, and most preferably 1.0 (mPa·sec) or less. Since the coating solution may be varied in its viscosity according to a shearing speed, the above-mentioned values represent the viscosity in the shearing speed at the moment of coating. A thixotropy agent is added to the coating solution, and when the viscosity is low at the time of coating which takes a high shearing and the viscosity increases at the time of drying which hardly takes the shearing in the coating solution, the unevenness at the time of drying is hardly generated, thus is preferable.

In addition, although it is not included as a solution property, the amount of coating solution which to be coated on a transparent support also gives an effect on the maximum coatable speed. The amount of coating solution which to be coated on a transparent support is preferably 2.0 to 5.0 (cm³/m²). When the amount of the coating solution which to be coated on a transparent support is increased, the maximum coatable speed is increased, thus is preferable. However, since the too much increase in the amount of the coating solution which to be coated on a transparent support causes a large load of drying, it is preferable to determine the most suitable amount of the coating solution which to be coated on a transparent support by a liquid prescription-process conditions.

The surface tension is preferably within the range of 15 to 36 (mM/m). It is preferable to reduce the surface tension such as by adding a leveling agent, because the unevenness at the time of drying is prevented. However, since the too much lowered surface tension reduces the maximum coatable speed, it is preferably within the range of 17 (mN/m) to 32 (mN/m), and more preferably within the range of 19 to (mN/m) to 26 (mN/m).

For the antiglare layer including translucent particles, it is preferable to be prepared in the viscosity of 4 cP (4 mPa·s) or more, and more preferable to be prepared in the viscosity of 6 cP (6 mPa·s) or more, from the viewpoint of anti-settling of the particles.

<Filtration>

Coating solution used in the coating is preferably filtrated prior to the coating. The pores of the filter preferably have a diameter as small as possible in a range that components in the coating solution are not removed. For the filtration, absolute filtration precision of the filter is in the range of 0.1 to 50 μm and preferably in the range of 0.1 to 40 μm. The thickness of the filter is preferably in the range of 0.1 to 10 mm and more preferably in the range of 0.2 to 2 mm. In this case, the filtration is preformed in a pressure of 1.5 MPa or less, more preferably 1.0 MPa or less, further preferably 0.2 MPa.

The filtering member is not particularly limited as long as it has no influence to the coating solution. Specifically, an example of the filtering member may include a wet dispersion substance of an inorganic compound.

In addition, the filtered coating solution is preferably de-foamed immediately before the coating by using an ultrasonic dispersion method so that the dispersed substance is maintained in a dispersed state.

### 4-(2) Pre-Coating Treatment

The support used in the invention is preferably subjected to a surface treatment prior to the coating. An example of a specific method may include a corona discharge treatment, a glow discharge treatment, a flame discharge treatment, an oxidation treatment, an alkali treatment, or an ultraviolet irradiation treatment. Alternatively, a primer layer disclosed in JP-A-7-333433 may preferably used.

In addition, an example of a method of removing dust used in a dust removing process as a pre-process of the coating may include a dry-type dust removing method such as a method of abutting unwoven cloth or a blade against a film surface as disclosed in JP-A-59-150571, a method of ejecting ultra-clean air at high speed so as to detach foreign materials adhering to the film surface from the surface and suck the materials in a suction port disposed in close proximity to the surface as disclosed in JP-A-10-309553, and a method of ejecting ultrasonic vibrating compressed air so as to detach foreign materials adhering to the film surface from the surface and suck the materials as disclosed in JP-A-7-333613 (which is manufactured by SHINKO CO., LTD.).

In addition, an example of a method of removing dust used in a dust removing process as a pre-process of the coating may include a wet-type dust removing method such as a method of introducing a film to a cleaning tank and detaching attached materials using ultrasonic vibrators, a method of supplying washing liquid to a film and then applying high velocity air jets, thereby sucking adhering particles from the film as disclosed in JP-B-49-13020, and a method of successively rubbing a web with a wet roll and then discharging liquid on the rubbed surface thereby cleaning the surface, as disclosed in JP-A-2001-38306. Among these dust removing method, the ultrasonic dust removing method or the wet-type dust removing method is especially preferable in view of the effectiveness of the dust removal.

In view of increasing the efficiency of dust removal to suppress attachment of foreign materials thereto, it is preferable to neutralizing electrostatic charges on the support. An example of a neutralizing method may include a method of using a corona discharge type ionizer and a method of using light irradiation type ionizer using UV, soft X-ray. The charging pressure of the film support is preferably maintained at 1,000 V or less, more preferably 300 V or less, and further preferably 100 V or less, before and after the time of the dust removing and coating treatment.

In view of maintaining the flatness of the film, it is preferable to maintain the temperature of the cellulose acylate film during the process equal to or less than Tg, specifically equal to or less than 150° C.

In the case of attaching the cellulose acylate film to a polarizing plate such as using the film of the invention as a protective film of the polarizing plate, it is particularly preferable to perform an oxidation treatment or alkali treatment, i.e., a saponification treatment to the cellulose acylate.

In view of adhesiveness or the like, the surface energy of the cellulose acylate film is preferably 55 mN/m or more, more preferably equal to or greater than 60 mN/m and equal to or smaller than 75 mN/m, which can be adjusted through the surface treatment.

### 4-(3) Coating

The respective layers of the film of the invention can be formed by the following coating method but is not limited to this.

Known examples of the coating method may include a dip coating method, an air knife coating method, a curtain coating method, a roller coating method, a wire bar coating method, a gravure coating method, an extrusion coating method (a die coating method) (see U.S. Pat. No. 2,681,294 for reference), and a micro gravure coating method. Among these methods, the micro gravure coating method is preferable.

The micro gravure coating method used in the invention is a coating method in which a gravure roll having a diameter of in the range of about 10 to 100 mm, preferably about 20 to 50 mm with the entire circumference inscribed with a gravure pattern is disposed below the support and rotating in a direction opposite to the transporting direction of the support, the surface of the gravure roll is scratched by a doctor blade so as to drop a surplus coating solution from the surface, and a predetermined amount of coating solution is transferred to a bottom surface of the support of which the top surface is in a free state. One side of the support successively rolled out from a roll-shaped transparent support may be coated with at least one of a hard-coating layer or at least one layer of low-refractive layers containing fluorine-containing olefin-based polymer by using the micro gravure coating method.

As a coating condition for the micro gravure coating method, the number of lines in the gravure pattern inscribed to the gravure roll is preferably 50 to 800 lines per inch, more preferably 100 to 300 lines per inch; the depth of the gravure pattern is preferably 1 to 600 μm, more preferably 5 to 200 μm; the rotation number of the gravure roll is preferably 3 to 800 rpm, more preferably 5 to 200 rpm; and the transferring speed of the support is preferably 0.5 to 100 meters per minute, more preferably 1 to 50 meters per minute.

In order to supply the film of the invention with high productivity, the extrusion coating method (die coating method) is preferably used. A die coater preferably usable in an area having a smaller wet coating amount (20 cm³/m² or less) such as the hard-coating layer or an antireflection layer will be described below.

<Configuration of Die Coater>

FIG. 6 is a sectional view illustrating a coater using a slot die suitable for the invention. The coater 10 applies the coating solution 14 with a bead 14a to a web W successively traveling being supported by a backup roll 11 from a slot die 13, thereby forming a coating film 14b on the web W.

A pocket 15 and a slot 16 are formed in the inner portion of the slot die 13. The pocket 15 may have a curved or linear section or a circular or semi-circular section as shown in FIG. 6. The pocket 15 extends in a coating solution storage extending in the width direction of the slot die 13, and the effective extension length is generally equal to or slightly greater than the width of the coating. The supply of the coating solution 14 to the pocket 15 is performed in a direction from the lateral surface of the slot die 13 or from a central portion of a surface on the opposite side of the slot aperture 16a. A lid for preventing the leakage of the coating solution 14 is provided to the pocket 15.

The slot 16 serves as a flow path of the coating solution 14 extending from the pocket 15 to the web W and extends in the width direction of the slot die 13 similar to the pocket 15. The width of the aperture portion 16a disposed to the side of the web is generally adjusted using a width-restricting plate (not shown) so that it is equal to the width of the coating. The angle made by the tangential line in the web traveling direction of the backup roll 11 in the front end of the slot 16 is preferably equal to or greater than 30° and equal to or smaller than 90°.

The front end rib 17 of the slot die 13 where the aperture portion 16a of the slot 16 is disposed is tapered in the longitudinal direction and the front end portion constitutes a flattened portion 18 called a land. In the land 18, the portion disposed in the upstream side of the traveling direction of the web W with respect to the slot 16 and the portion disposed in the downstream side are called an upstream side rib land 18a and a downstream side rib land 18b, respectively.

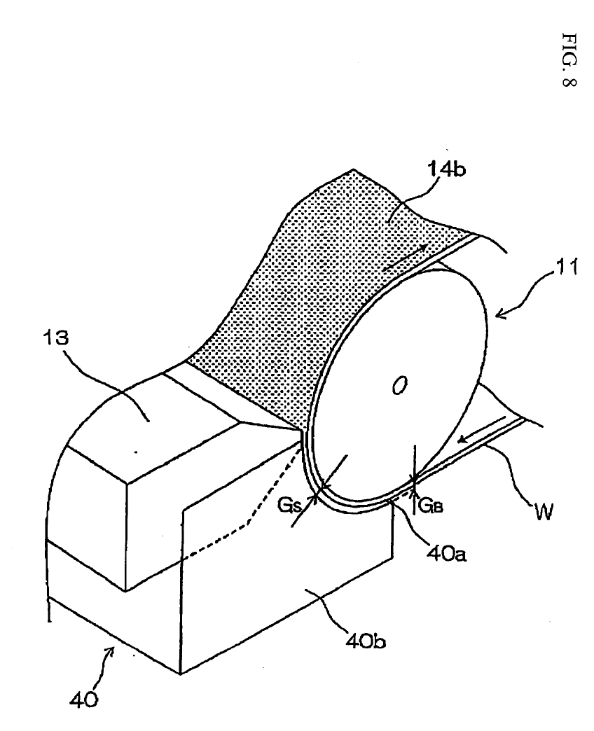

FIGS. 7A and 7B show a sectional shape of the slot die 13 compared with that of a conventional one, in which FIG. 7A shows the slot die 13 suitable for the invention and FIG. 7B shows the slot die 30 according to the conventional one. In the conventional slot die 30, the distance between the web and the upstream side rib land 31a is equal to the distance between the web and the downstream side rib land 31b. In addition, reference numeral 32 denotes a pocket, and reference numeral 33 denotes a slot. To the contrary, in the slot die 13 of the invention, the length of the downstream side rib land is set to I_{LO,} and it is thus possible to perform the coating with high precision so that the thickness of the moisture film is 20 μm or less.

The length I_{UP} of the upstream side rib land 18a is not particularly limited but preferably set to in the range of 500 μm to 1 mm. The length I_{LO} of the downstream side rib land 18b is set to a value equal to or greater than 30 μm and equal to or smaller than 80 μm, more preferably equal to or greater than 30 μm and equal to or smaller than 60 μm. By setting the length I_{LO} of the downstream side rib land 18b to a value equal to or greater than 30 μm, it is possible to prevent the dropping of the edge of the front rib or the land and generation of stripe scar on the coating film. In addition, it becomes easy to set the position of the leaking line in the downstream side, thereby preventing the dispersion of the coating solution in the downstream side. The leaking and dispersing of the coating solution in the downstream means an irregular leaking line, thereby leading to a problem of causing a failure shape to be formed on the coating surface, such as scars.

The downstream side rib land 18b has an over-bite shape in which it is disposed more close to the web W than the upstream side rib land 18a. Therefore, it becomes possible to decrease depressurizing rate and form the beads suitable for the thin film coating. The difference of distance between the web W and the downstream side rib land 18b and the distance between the web W and the upstream side rib land 18a (hereinafter, referred to as an over-bite length LO) is preferably equal to or greater than 30 μm and equal to or smaller than 100 μm, more preferably equal to or greater than 30 μm and equal to or smaller than 80 μm. When the slot die 13 has the over-bite shape, the gap G_{L} between the front end rib 17 and the web W represents the gap between the downstream side rib land 18b and the web W.

FIG. 8 is a perspective view illustrating a slot die and the periphery thereof in a coating process suitable for the present invention.

On the opposite side of the traveling direction of the web W, a depressurizing chamber 40 is disposed in a position not contacting the traveling direction of the web so that it is possible to perform a sufficient depressurizing adjustment to the bead 14a. The depressurizing chamber 40 includes a back plate 40a and a side plate 40b in order to maintain the operation efficiency, and gaps G_{B} and G_{S} are provided between the back plate 40a and the web W and between the side plate 40b and the web W, respectively.

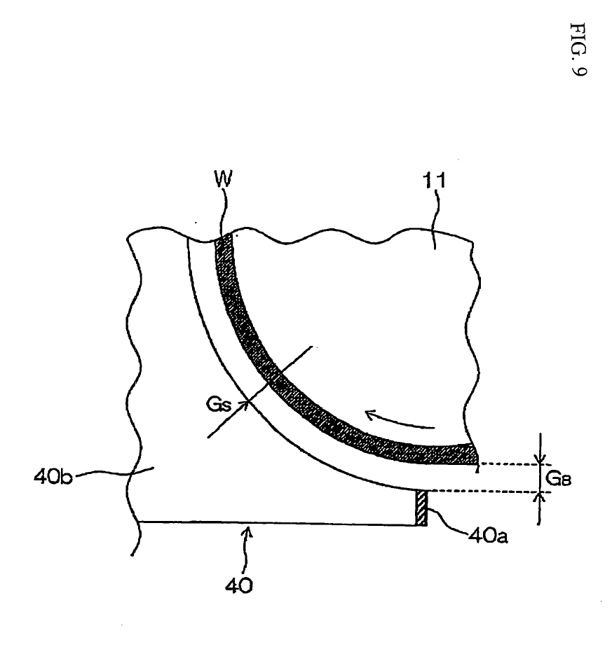

FIG. 9 is a sectional view illustrating the depressurizing chamber 40 and the web W adjacent to each other. The side plate and the back plate may be integrally formed with the chamber body as shown in FIG. 9, or may be fixed to the chamber with a screw so that the gap therebetween can be adjusted. In either case, the gap between the back plate 40a and the web W and the gap between the side plate 40b and the web W are defined as G_{B} and G_{S}, respectively. The gap G_{B} between the back plate 40a and the web W in the depressurizing chamber 40 represents the gap between the uppermost end of the back plate 40a and the web W when the depressurizing chamber 40 is installed below the web W and the slot die 13 as shown in FIG. 8.

The gap G_{B} between the back plate 40a and the web W is preferably set to a vale greater than the gap G_{L} between the front end rib 17 of the slot die 13 and the web W. Accordingly, it is possible to prevent the variation in the depressurizing rate in the vicinity of the bead resulting from the eccentricity of the backup roll 11. For example, when the gap G_{L} between the front end rib 17 of the slot die 13 and the web W is set to a value equal to and greater than 30 μm and equal to and smaller than 100 μm, the gap G_{B} between the back plate 40a and the web W is preferably set to a value equal to and greater than 100 μm and equal to and smaller than 500 μm.

<Material and Precision>

The longer the length of the front end rib in the web traveling direction on the side of the web traveling direction, the more disadvantageous for the formation of the bead. When the length is uneven in a position in the width direction of the slot die, the bead becomes unstable by a subtle external disturbance. Therefore, it is preferable to set the distance so that the variation width in the width direction of the slot die is less than 20 μm.

When a stainless steel is used as a material of the front end rib of the slot die, it may expand in a step of machining the die. Accordingly, even when the length of the front end rip of the slot die in the traveling direction of the web is set in the range of 30 to 100 μm, there may be an occasion where it may not satisfy the precision of the front end rib. Therefore, in order to maintain a high machining precision, it is preferable to use a super-hard material as disclosed in Japanese Patent No. 2817053. Specifically, it is preferable that at least the front end rib of the slot die is made of a super-hard alloy coupled with a carbonic crystal having an average diameter of 5 μm. As a super-hard alloy, a carbonic crystal particle such as tungsten carbide (hereinafter, referred to as WC) which is coupled with a coupling metal such as cobalt. As the coupling metal, titanium, tantalum, niobium, and a mixture metal thereof. The average diameter of the WC crystal is preferably set to a value of 3 μm or less.

In order to perform the coating with high precision, the length of the land on the side of the traveling direction of the web of the front end rib and the degree of irregularity of the gap between the web and the front end rib in the width direction of the slot die become important factor. It is preferable to attain straightness in a range that the combination of these two factors, i.e., the variation width of the gap is suppressed to some extent. Preferably, the straightness of the front end rib and the backup roll is controlled so that the variation width of the gap in the width direction of the slot die is equal to or greater than 5 μm.

<Coating Speed>

By attaining the precision of the backup roller and the front end rib, the coating method preferably used in the invention is highly stable in view of the film thickness at the time of performing the coating at high speed. Since the coating method is a pre-measuring method, it is easy to secure a stable film thickness at the time of high speed coating. With respect to a small amount of coating solution, the coating method can be performed at high speed with a stable film thickness. Although other coating methods may be used, the dip coating method inevitably involves a vibration of coating solution in the droplet receiving tank and may produce a step-shaped stain. In a reverse-roll coating method, it is likely to produce a step-shaped stain due to the eccentricity and bending of the roll related to the coating. In addition, since these coating methods are post-measuring method, it is difficult to secure a stable film thickness. Therefore, it is preferable to perform the die coating method at a speed of 50 meters per minute or more in view of productivity.

### 4-(4) Drying

After being applied onto the support directly or with another layer interposed therebetween, the film according to the invention is preferably transported to a heated zone by a web so as to dry the solvent.

A variety of known methods can be used as the method of drying the solvent. Specific examples thereof are described in JP-A-2001-286817, JP-A-2001-314798, JP-A-2003-126768, JP-A-2003-315505, and JP-A-2004-34002.

The temperature of the drying zone is preferably in the range of 25° C. to 140° C. It is preferable that the front half of the drying zone is at a relatively low temperature and the rear half thereof is at a relatively high temperature. However, it is preferable that the temperature of the drying zone is lower than the temperature at which volatilization of components other than the solvent contained in the coating compositions of the layers is started. For example, some optical radical generating agents available and used together with UV curable resin are volatilized by several tens % within several minutes in the hot blow of 120° C. Some acrylate monomers with single or two functional groups are being volatilized in the hot blow of 100° C. Accordingly, it is preferable that the temperature is lower than the temperature at which the volatilization of the components other than the solvent contained in the coating compositions of the layers is started It is preferable that the drying blow after the coating compositions of the layers are applied onto the support has a blow speed in the range of 0.1 to 2 m/sec on the coating surface when the solid concentration of the coating composition is in the range of 1 to 50%, so as to prevent the dry stain.

When the difference in temperature between the support and the transport roll contacting the opposite surface of the coating surface of the support in the dry zone after the coating compositions of the layers are applied onto the support is in the range of 0° C. to 20° C., the dry stain due to the heat conducting stain on the transport roll can be prevented, which is preferable.

### 4-(5) Curing

The film can cure a coated film by passing the zone curing each coated film by an ionizing radiation and/or a heat by a web after drying a solvent.

The ionizing radiation type of the invention is not particularly limited and it is selected from ultraviolet rays, electric rays, near ultraviolet rays, visible light, near infrared rays, infrared rays, X-rays and the like according to a type of a curable composition. However, the electric rays are preferable, and particularly, the ultraviolet rays are preferable in that the dealing is simple and high energy is easy.

As a light source of the ultraviolet rays photopolymerizing an ultraviolet reactive compound, any light source generating the ultraviolet rays can be used. For example, a low-temperature lamp, a middle-temperature lamp, a high-temperature lamp, an ultrahigh-temperature lamp, a carbon-arc lamp, a metal halide lamp, a xenon lamp, and the like can be used. Additionally, an ArF excimer laser, a KrF excimer laser, an excimer lamp, a synchrotron orbital radiation, and the like can be used. Among these, the ultrahigh-temperature lamp, the high-temperature lamp, the low-temperature lamp, the carbon-arc lamp, the xenon-arc lamp, and the metal halide lamp can be preferably used.

The electrical rays can be used as well. The examples of the electrical rays are the electrical rays having an energy of the range of 50 to 1000 KeV, preferably in the range of 100 to 300 KeV, radiated from all kinds of electron-ray accelerating devices such as a Cockcroft-Walton type, a Van de Graaff type, a resonance transformation type, an insulating core transformer, a straight type, a dynamitron type, and a high-frequency type.

Irradiation conditions are different according to each lamp, but a light amount of the irradiation is preferably 10 mJ/cm² or more, more preferably in the range of 50 to 10000 mJ/cm², and particularly preferably in the range of 50 to 200 mJ/cm². In this case, the irradiation amount distribution including from the center to both edges in a width direction of the web is preferably in the range of 50 to 100%, and more preferably in the range of 80 to 100%.

According to the invention, it is preferable that at least one layer stacked on a support is irradiated by the ionizing radiation and the layer laminated on the support is cured by a step of irradiating the ionizing radiation in an ambient atmosphere in which an oxygen concentration is 10 volume % or less during a 0.5 or more second from the irradiation initial of the ionizing radiation, heating at 60° C. or more of a temperature of a film surface.

It is also preferable that the layer is irradiated by the ionizing radiation and/or successively heated in an ambient atmosphere in which the oxygen concentration is 3 volume % or less.

In particular, a low refractive-index layer which is the most outer layer and of which a thickness is thin is preferably cured by this way. The curable reaction is accelerated by a heat and thus a film with excellence in a physical strength and a chemical resistance can be formed.

A period of irradiating the ionizing radiation is preferably in the range of 0.7 to 60 seconds, and more preferably in the range of 0.7 to 10 seconds. By irradiating for 0.7 second or more, the curable reaction is completed to fully perform the curing. Additionally, a large-scale equipment is avoidable because it is not necessary to keep a hypoxia condition by irradiating for 60 seconds or more. Accordingly, it is excellent in that a large amount of an inactive gas is not necessary.

The oxygen concentration is preferably formed by a cross-linking reaction of the curing compound of the ionizing radiation or a polymerization reaction, and the oxygen concentration is more preferably 4 volume % or less, particularly preferably 2 volume % or less, and most preferably 1 volume % or less. In order to lower the oxygen concentration more than is necessary, a large amount of the inactive gas such as nitrogen is required to be used and it is not preferable in terms of a manufacture cost.

As for a method of lowering the oxygen concentration to 10 volume % or less, the atmosphere (where a nitrogen concentration is about 79 volume % and an oxygen concentration is about 21 volume %) can be preferably substituted for other gas and particularly preferably for nitrogen (nitrogen purge).

The inactive gas is provided to an ionizing radiation chamber, and under a condition the inactive gas extracted in the web exit of the ionizing radiation chamber, an introduced air accompanying with a web convey is suppressed to effectively lower the oxygen concentration of the reaction chamber and the practical oxygen concentration of a large pole surface of a curable obstruction due to oxygen can be effectively lowered. A flowing direction of the inactive gas in the web exit of the reaction chamber can be controlled by adjusting an air supply of the reaction chamber and a balance of an air discharge.

The method of extracting the inactive gas to of removing the introduced air.

By providing an anterior chamber in the front of the reaction chamber and removing the oxygen of the web surface, a more effective curing can be proceeded. A gap between the reaction chamber of the ionizing radiation or the side constituting web entrance of the anterior chamber and the web surface is preferably in the range of 0.2 to 15 mm, more preferably in the range of 0.2 to 10 mm, and the most preferably in the range of 0.2 to 5 mm. However, when the web is produced successively, the web is required to be bonded. When the web is bonded, a bonding tape is widely used. As a result, when the gap between the entrance surface of the reaction chamber of the ionizing radiation or the anterior chamber and the web are too small, a problem that a bonding member is in stuck can occur. In order to narrow the gap, at least a part of the entrance surfaces of the reaction chamber of the ionizing radiation or the anterior chamber is preferably driven to make a gap corresponding to a thickness of the bonding member wider at the time of inserting the bonding member. In order to achieve the above method, while driving the entrance of the reaction chamber of the ionizing radiation or the anterior chamber in a front and back directions of the movement, the gap is required to be broadened by moving the entrances in a front and back at the time of passing the bonding member. Otherwise, by driving the entrance of the reaction chamber of the ionizing radiation or the anterior chamber in a direction vertical to the web surface, the entrance can be moved up and down such that the gap is broadened at the time of passing the bonding member.

At the time of curing, the film surface is heated preferably in the range of 60° C. to 170° C. The curing can be performed sufficiently at a temperature of 60° C. or more and the deformation, etc. of the support can be prevented at a temperature of 170° C. The heating temperature of the film surface is more preferably in the range of 60° C. to 100° C. The surface temperature indicates the surface temperature of a layer to be cured. The time until the film reaches the above-mentioned temperature is preferably in the range of 0.1 second to 300 seconds from the time of start of UV irradiation and more preferably 10 seconds or less. The above-mentioned time range is preferable in view of promotion of a reaction of curable compositions constituting the film, optical performance of the film, and the scale of equipment.

The heating method is not particularly limited, but a method of bringing a heated roll into contact with the film, a method of spraying heated nitrogen, and a method of irradiating far infrared rays or infrared rays are preferable. The method of allowing mediums such as hot water or vaporized oil to flow in a rotating metal roll can be used which is described in Japanese Patent No. 2523574. A dielectric heating roll may be used as the heating means.

The UV rays may be irradiated every when each constituent layer is formed or after the constituent layers are stacked. Alternatively, a combination thereof may be used. It is preferable in view of productivity that the UV rays are irradiated after the constituent layers are stacked.

In the present invention, at least one layer stacked on the support can be cured by the use of several times of ionizing radiations. In this case, at least two times of ionizing radiations are performed preferably in continuous reaction chambers having a volume of 3 vol % or less. By performing several times of ionizing radiations in the same low-oxygen-concentration reaction chamber, it is possible to effectively secure the reaction time for curing.

Specifically, when the production speed is increased for the purpose of high productivity, several times of ionizing radiations are preferable to secure ionizing radiation energy necessary for the curing reaction.

When the curing rate (100—content of remaining function groups) is less than 100% and the curing rate of the lower layer at the time of curing the layers with the ionizing radiations and/or heat in a state where an upper layer is provided is higher than that before the upper layer is provided, the adhesion property between the lower layer and the upper layer is improved, which is preferable.

### 4-(6) Handling

In order to continuously manufacture the film according to the present invention, a process of continuously sending out a roll-shaped support film, a process of applying and drying a coating solution, a process of curing a coated film, and a process of winding the support film having the cured layer may be carried out.

The film support is continuously sent into a clean room roll-shaped film support, static electricity charged on the film support is removed by an electricity removing apparatus in the clean room, and particles attached to the film support are removed by an anti-dust apparatus. Subsequently, a coating solution is applied onto the film support from a coating unit installed in the clean room and the coated film support is sent to a drying chamber and dried.

The film support having the dried coating layer is sent to a curing chamber from the drying chamber and is cured by polymerization of monomers contained in the coating layer. The film support having the cured layer is sent to a curing unit and completely cured. The film support having the completely cured layer is wound into a roll shape.

The process may be performed every time of forming each layer or the formation of the respective layers may be continuously performed by providing a plurality of sets of coating unit, drying chamber, and curing unit.

In order to manufacture the film of the present invention, it is preferable that the coating process of the coating unit and the drying process of the drying chamber are performed in the atmosphere with high cleanness at the same time of precise filtration of the coating solution as described above and remnants and dust on the film are sufficiently removed before performing the coating process. The air cleanness of the coating process and the drying process is, based on the air cleanness according to FED 209E, Class 10 (in which the particles having a size of 0.5 μm or more are included in 355/m³ or less) or more, and more preferably Class 1 (in which the particles having a size of 0.5 μm or more are included in 35.5/m³ or less) or more. The air cleanness is preferably high in the sending and winding units in addition to the coating and drying processes.

### 4-(7) Saponification Process

When the polarizing plate is formed by using the film of the invention as one of the surface protecting films of two sheets of polarizer, it is preferable to improve adhesion in an adhesive surface by hydrophilizing the surface adhered to the polarizer.

a. Method of Immersing in Alkaline Solution The method is a technique of saponifying all faces having reactivity to alkali of an entire film surface by immersing a film in alkaline solution in an appropriate condition. Preferred concentration is 0.5 to 3 mol/L and more particularly preferred concentration is 1 to 2 mol/L. Since a special facility is not required for the method, the method is preferable in terms of cost. It is preferable that alkaline solution is aqueous sodium hydroxide. A preferable solution temperature of alkaline solution is 30 to 75° C. and a more particularly preferable solution temperature of alkaline solution is 40 to 60° C. It is preferable that the combination of the saponification conditions is the combination of comparatively mild conditions, but the combination of the saponification conditions may be set depending on materials or constitution of the film and a desired contact angle. It is preferable that neutralize alkaline component by washing the film or immersing the film in diluted acid so that the alkaline component does not remain in the film after immersing the film in alkaline solution.

A surface opposite to a surface having a coating layer is hydrophilized by the saponification process. A protective film for the polarizing plate is used by bonding a hydrophilized surface of a transparent support to the polarizer. The hydrophilized surface is effective to improve adhesion with an adhesive layer which is mainly formed of polyvinyl alcohol. It is preferable that the saponification process is preferable in terms of adhesion as the contact angle to water of a surface of the transparent support opposite to the surface having the coating layer in the saponification process decreases. Meanwhile, since the surface and the inner side having the coating layer are damaged by alkali in the immersing method, it becomes important to perform the saponification process in minimum reaction conditions. When the contact angle to water of the transparent support on the opposite surface as the damage of the layers caused by alkali, the contact angle is preferably 10° to 50°, more preferably 30° to 50°, and further preferably 40° to 50°. Since a problem occurs in the adhesion to the polarizer at 50° or higher, it is not preferable that the contact angle is 50° or higher. The range is preferable in terms of the adhesion to the polarizer, a damage of the film, and a physical intensity.

b. Method of Applying Alkaline Solution

An alkaline solution coating method of applying alkaline solution to the only surface opposite to the surface having the coating layer in appropriate conditions and heating, flushing, and drying the applied surface is used as a measure for preventing damages to the films the immersing method described above. In this case, the coating means that the alkaline solution is in contact with an only saponified surface. Spraying and contacting the solution to a belt other than the coating may be used in the immersing method. Since a facility and a process for applying the alkaline solution by adopting these methods, the method of applying the alkaline solution is inferior to the immersing method in ‘a’ in terms of cost. Meanwhile, since the alkaline solution is in contact with the only saponified surface, a layer formed of a material susceptible to the alkaline solution may be provided on a surface opposite to the saponified surface. For example, since various effects such as corrosion, dissolution, and exfoliation by the alkaline solution occur in an evaporation film or a sol-gel film, it is preferable that the layer is provided in the immersing method, but it is possible to use the layer since the layer is not in contact with the solution in this coating method.

Since the saponification process can be performed after the formation of the layers wound up from the roll-shaped support in both saponification methods in ‘a’ and ‘b’, the saponification process may be additively performed by a series of operations after the film producing process. Similarly, it is possible to form the polarizing plate more efficiently than a double operation by continually performing a process of emulating with the polarizing plate which is formed of a wound support.

c. Method of Saponifying by Protecting with Laminate Film

As described in ‘b’, it is possible to exfoliate the laminate film by hydrophilizing only triacetylcellulose surface opposite to the face where a final layer is formed by immersing the layers after adhering the laminate film on the surface where the final surface when the resistance of the coating layer to the alkaline solution is insufficient. Even in this method, the hydrophilization process required as a polarizing plate protecting film is performed on the only surface opposite to the surface where the final layer of the triacetylcellulouse film without a damage of the coating layer. There is an advantage that the laminate film is generated as a waste, while a device for applying the alkaline solution is not required in comparison with the method ‘b’.

d. Method of Immersing in Alkaline Solution After Formation of Middle Layer

When a lower layer has the resistance to the alkaline solution, but an upper layer has sufficient resistance to the alkaline solution, both sides of the lower layer by immersing the film in the alkaline solution after forming the film are hydrophilized. Then, the upper layer may be formed. There is an advantage that interlayer adherence between a glare-proof layer and a low refractive index layer is improved when a film formed of the glare-proof layer and the low refractive index layer has a hydrophilic group even though the producing process is complicated.

e. Method of Previously Forming Coating Layer on Saponified Triacetylcellulose Film

The triacetylcellulose film is saponified by being previously immersed in the alkaline solution. The coating layer may be formed directly on one surface of the film or via other layers. The interlayer with the triacetylcellulose surface hydropihilized by the saponification may be deteriorated when the film is saponified by being immersed in the alkaline solution. In such a case, it is possible to deal with the deterioration of the interlayer adherence by forming the coating layer after removing the hydrophilized surface by performing processes of corona discharge and glow discharge on the only surface where the coating is formed.

### 4-(8) Producing Polarizing Plate

Since the film of the invention is used as the polarizer and the protective film disposed one side or both sides of the polarizer the polarizing plate, the film of the invention may be used the polarizing plate. The film of the invention may be as one protective film and a normal cellulose acetate film may be used as the other protective film. It is preferable to use the cellulose acetate film which is produced by the solution film production method described above and extends in a width direction in a roll film shape at an extension magnification of 10 to 100%. In the polarizing plate of the invention, it is preferable that the one protective film is an antiglare film and the other protective film is an optical compensation film having an optical anisotropy layer composed of mesomorphism compound.

The polarizer includes an iodine-system polarizer, a dye-system polarizer or a polyene-system polarizer using dichromatic dye. The iodine-system polarizer and the dye-system polarizer are generally produced by a polyvinyl alcohol-system film. A slow axis of the transparent support of the antiglare film or the cellulose acetate film and a transmission axis of the polarizer are actually disposed parallel to each other.

Moisture permeability of the protective film is important in productivity of the polarizing plate. The polarizer and the protective film are adhered to each other by aquatic bonding adhesive and the bonding adhesive solution is spread and dried. As the moisture permeability of the protective film is higher, the bonding adhesive solution is dried more fast and the productivity is improved. However, when the moisture permeability becomes too high, moisture is induced in the polarizer. Accordingly, polarization ability is lowered. The moisture permeability of the protective film depends on the thickness, free volume, and pro-hydrophobic property of the transparent support or a polymer film (and polymerization liquid crystal compound). When the film of the invention is used as the protective film of the polarizing plate, the moisture permeability is preferably 100 to 1000 g/m²·24 hrs and more preferably 300 to 700 g/m²·24 hrs. The thickness of the transparent support can be adjusted by a lip flow and a line speed, or extension, and compression at the time of the film production. The free volume of the transparent support can be adjusted by a drying temperature and a drying time at the time of the film production. Even in this case, since the moisture permeability is different by main material to be used, it is possible to adjust the free volume to a preferable range by a free volume adjustment. The pro-hydrophobic property of the transparent support can be adjusted by an additive. The moisture permeability becomes higher by adding a hydrophilic additive to the free volume and the moisture permeability becomes lower by adding a hydrophobic additive. It becomes possible to produce the polarizing plate having the optical compensation ability at a low cost and in high productivity by controlling the moisture permeability independently.

The known polarizer and a polarizer of which absorption axis is cut down from a long polarizer not parallel and perpendicular to a length direction of the polarizer may be used as the polarizer. The long polarizer of which absorption axis is not parallel and perpendicular to the length direction are produced by the following method.

That is, the polarizing extending by adding a tensile force to both ends of the polymer film while holding both ends of the polymer film supplied continually by holding means can be produced by a extension method performed in a state where a difference in lengthwise progression speeds of holding devices on both ends of the film is less than 3% and an angle between a film progress direction and a film extension direction in an outlet of a process holding both ends of the film is 20 to 70°. Particularly, it is preferable that the inclination angle is 45° in terms of productivity.

The method of extending the polymer film will be specifically described in Paragraph Nos. 0020 to 0030 of JP-A-2002-86554.

Among two sheets of protective films of a polarizer, it is preferable that a film other than the antiglare film is the optical compensation film having an optical compensation layer formed of the optical anisotropy layer. The optical compensation film (a phase contrast film) provides improvement in viewing angle characteristic of a liquid crystal display screen.

The known optical compensation film may be used as the optical compensation film, but it is preferable that the optical compensation film disclosed in JP-A-2001-100042 is used as the optical compensation film.

### 5. Usage of the Invention

The film according to the invention is used in an image display such as a liquid crystal display (LCD), a plasma display panel (PDP), an electroluminescence display (ELD), and a cathode ray tube (CRT). The film or polarizing plate according to the invention can be used for the outermost surface of the known display such as LCD, PDP, ELD, and CRT.

### 5-(1) Liquid Crystal Display

The film or polarizing plate according to the invention can be advantageously used in the image display such as a liquid crystal display and is used preferably for the outermost surface of the display.

The liquid crystal display has a liquid crystal cell and two polarizing plates disposed on both sides thereof and the liquid crystal cell contains liquid crystal between two electrode plates. An optical anisotropic layer may be disposed between the liquid crystal cell and one polarizing plate, or two optical anisotropic layers may be disposed between the liquid crystal cell and one polarizing plate and between the liquid crystal cell and the other polarizing plate.

It is preferable that the liquid crystal cell has a TN mode, a VA mode, an OCB mode, an IPS mode, or an ECB mode.

<TN Mode>

In the liquid crystal cell with the TN mode, at the time of application of no voltage, rod-shaped liquid crystal molecules are aligned substantially in the horizontal direction and twisted by 60° to 120°.

The liquid crystal cell with the TN mode is most widely used for a color TFT liquid crystal display and is described in various documents.

<VA Mode>

In the liquid crystal cell with the VA mode, at the time of application of no voltage, the rod-shaped liquid crystal molecules are aligned substantially in the vertical direction

In addition to (1) a liquid crystal cell with a narrow-meaning VA mode in which the rod-shaped liquid crystal molecules are vertically aligned at the time of application of no voltage and are horizontally aligned at the time of application of a voltage (which is described, for example, in JP-A-2-176625), the liquid crystal cell with the VA mode includes (2) a liquid crystal cell in which the VA mode is made into multi domains (MVA mode) for the purpose of enlargement of a viewing angle (which is described in SID97, Digest of Tech. Papers (Preprint) 28(1997), p. 845), (3) a liquid crystal cell with a mode (n-ASM mode) in which the rod-shaped liquid crystal molecules are vertically aligned at the time of application of no voltage and are twisted in multi domains at the time of application of a voltage (which is described in Preprint p. 58-59 (1998) of Japanese Liquid Crystal Discussion, and (4) a liquid crystal cell with a SURVIVAL mode (which is published in LCD International 98).

<OCB Mode>

The liquid crystal cell with the OCB mode has a bend alignment mode in which the rod-shaped liquid crystal molecules are aligned in the upper portion and the lower portion of the liquid crystal cell substantially in the opposite directions (symmetrically) and is described in U.S. Pat. Nos. 4,583,825 and 5,410,422. Since the rod-shaped liquid crystal molecules are symmetrically aligned in the upper portion and the lower portion, the liquid crystal cell with the bend alignment mode has a self optical compensation function. Accordingly, the liquid crystal mode is called an OCB (Optically Compensatory Bend) liquid crystal mode. The liquid crystal display with the bend alignment mode has an advantage that the response speed is high.

<IPS Mode>

The liquid crystal cell with the IPS mode switches the alignment by applying a transverse electric field to nematic liquid crystal and is specifically described in p. 577-580 of Proc. IDRC (Asia Display '95) and p. 707-710 of Proc. IDRC (Asia Display '95).

<ECB Mode>

In the liquid crystal cell with the ECB mode, the rod-shaped liquid crystal molecules are aligned substantially in the horizontal direction at the time of application of no voltage. The ECB mode is one liquid crystal display mode having the simplest structure and is specifically described in Japanese Unexamined Patent Application Publication No. 5-203946.

### 5-(2) Display Other than Liquid Crystal Display

<PDP>

The plasma display panel (PDP) generally includes a gas, a glass substrate, an electrode, an electrode lead material, a thick film printing material, and a fluorescent substance. The glass substrate includes two sheets of a front glass substrate and a rear glass substrate. An electrode and an insulating layer are formed on the two sheets of glass substrate. A fluorescent layer is further formed on the rear glass substrate. Two glass substrates are assembled and the gas is enclosed therebetween.

The plasma display panel (PDP) comes to the market. The plasma display panel is described in JP-A-5-205643 and JP-A-9-306366.

A front plate may be disposed in the front of the plasma display panel. The front plate has preferably a sufficient strength to protect the plasma display panel. The front plate may be disposed with a gap from the plasma display panel or may be directly attached to the plasma display panel body.

In the image display such as the plasma display panel, an optical filter may be attached directly to the surface of the display. When the front plate is disposed in the front of the display, an optical filter may be attached to the front side (outside) or the rear side (display side) of the front plate.

<Touch Panel>

The film according to the invention can be applied to a touch panel described in JP-A-5-127822 and JP-A-2002-48913.

<Organic EL device>

The film according to the present invention can be used as a substrate (base film) or a protective film of an organic EL device.

When the film according to the present invention is used in the organic EL device, the details described in JP-A Nos. 11-335661, 11-335368, 2001-192651, 2001-192652, 2001-192653, 2001-335776, 2001-247859, 2001-181616, 2001-181617, 2002-181816, and 2002-181617 can be applied. These details are preferably applied together with the details described in JP-A Nos. 2001-148291, 2001-221916, and 2001-231443.

### 6. Various Characteristic Values

Various measuring methods and characteristics according to the present invention will be described below.

### 6-(1) Reflectance

The 5° specular reflectance in the invention is an average specular reflectance of 450 nm to 650 nm at the time of fitting an adapter “ARV-474” into a spectroscope “V-150” (made by JASCO Corporation) and measuring a specular reflectance at an exit angle −5° in response to an incident angle of 5° in the wavelength domain of 380 nm to 780 nm. The average integrated reflectance is an average integrated reflectance of 450 nm to 650 nm at the time of fitting an adapter “ILV-474” into a spectroscope “V-550” (made by JASCO Corporation) and measuring a specular reflectance at an incident angle of 5° in the wavelength domain of 380 nm to 780 nm.

### 6-(2) Surface Roughness

A center-line average surface roughness Ra is measured on the basis of JIS-B0601.

### 6-(3) Haze

The entire haze of the film according to the invention is a haze value defined in JIS-K7105 and is a value which is automatically measured by haze=(diffused light/entire transmitted light)×100(%) by the use of “NDH-1001 DP” made by NIPPON DENSHOKU Co. Ltd. On the basis of the measurement defined in JIS-K7361-1. Entire haze=Surface haze+Inner haze. The inner haze is measured after the same material as the outermost layer is overcoated to have no surface unevenness (surface haze) of the hard coat film. The surface haze is obtained by subtracting the inner haze from the entire haze.

### 6-(4) Hardness

<Pencil Hardness>

The strength of the film according to the invention can be evaluated through a pencil hardness test complying with JIS-KT5400.

### 6-(5) Weakness Test (Crack Resistance)

The crack resistance is an important characteristic for causing a crack defect due to the handling such as coating, processing, and cutting of a film, coating of an adhesive, and attachment to a variety of objects.

When a film sample is cut in a size of 35 mm×140 mm, is left for 2 hours under the condition of a temperature of 25° C. and a relative humidity of 60%, and is rolled in a cylinder shape, the crack of the surface can be evaluated by measuring a diameter of curvature in which a crack starts.

### 6-(6) Performance of Liquid Crystal Display

Now, an evaluation method of characteristics and a preferable state when the film according to the invention is used in a display apparatus are described.

A visual-side polarizing plate disposed in a liquid crystal display (32″ TV: W32-L7000 made by Hitachi Co., Ltd.) using an IPS mode liquid crystal cell is detached and the film or polarizing plate according to the invention is attached instead of the polarizing plate with an adhesive in a state where the applied surface faces the visual side. A black display is set in the liquid crystal display at a bright place with 1000 lux and then the following evaluation is performed with eyes.

<<High Blackness>>

OO Black is displayed very clear without haze due to external light at all (Success)

O Black is displayed clear without haze due to external light (Success)

ΔBlack is displayed with lowered darkness and with haze due to external light (Failure)

X: Black is displayed without emphasis and with strong haze due to external light (Failure)

<<Reflection on image of fluorescent lamp>>

O: The invasion on an image of a fluorescent lamp is not cared (Success)

X: The invasion on an image of the fluorescent lamp is greatly cared (Failure)

<<Haze of displayed image>> which results from an internal haze.

5: The displayed image is very clear (Success)

4.5: Middle between 5 and 4. The displayed image is clear (Success)

4: The displayed image is very clear (Success)

3.5: Middle between 3 and 4. The displayed image is clear (Success)

3: The displayed image is clear (Success)

2: The displayed image is slightly hazy (Failure)

1: The displayed image is hazy (Failure)

### EXAMPLES

The present invention will be described with reference to the following examples, but is not limited to the examples.

### (Coating of Antiglare Hard Coat Layer)

### Example 1

50 parts by weight of commercially available UV cured resin (produced by NIPPON KAYAKU CO.,LTD., PETA, refractive index: 1.51), 2 parts by weight of photopolymerization initiator (produced by Nihon Ciba-Geigy K. K., trade name: IRGACURE 184), 1 part by weight of acrylstyrene beads having an average diameter of 3.5 μm (produced by Soken Chemical & Engineering Co., Ltd., refractive index: 1.55), and 6 parts by weight of styrene beads having an average diameter of 3.5 μm (produced by Soken Chemical & Engineering Co., Ltd., refractive index: 1.60) were mixed with 25/25/25 parts by weight of toluene/methyl isobutyl ketone/cyclohexanone as solvents to produce antiglare hard coat layer coating solution. After the coating solution was applied to a triacetylcellulose film (produced by FUJIFILM corporation, trade name: TD-80U, thickness: 80 μm) and dried at 70° C. for one minute, the triacetylcellulose film was cured by irradiating an ultraviolet beam (100 mJ/cm²) so as to coat the triacetylcellulose film with the antiglare hard coat layer having thickness of 5 μm.

(Preparation of Sol Liquid)

120 parts by weight of methyl ethyl ketone, 100 parts by weight of acryloxypropylmethoxysilane (KMB-5103, produced by Shin-Etsu Chemical Co.Ltd.), and 3 parts by weight of diisopropoxyaluminum ethylacetoacetate were added to a stirrer and a reactor having a reflux condenser and mixed, and 30 parts by weight of ion-exchange water was added into the mixture. The sol liquid was produced by reacting the mixture at 60° C. for four hours and cooling the mixture to room temperature. Weight-average molecular weight was 1800, and components having molecular weight of 1000 to 20000 were 100% among components over oligomer. Condensation rate a calculated from ²⁹Si-NMR measurement was 0.88. When gas chromatography analysis was performed, the acryloxypropylmethoxysilane did not remain at all as materials.

(Preparation of Coating Solution 1 for Low Refractive-Index Layer)

| | |
|---|---|
| Fluorine-containing polymer A (6%) | 13.0 g |
| MEK-ST-L(30%) | 1.0 g |
| The sol liquid | 0.5 g |
| MEK | 5.0 g |
| Cyclohexanone | 0.5 g |

The coating solution was stirred and filtered by the use of a polypropylene filter having pore diameter of 1 μm so as to produce an coating solution for the low refractive-index layer.

Respective compounds to be used will be described as follows.

The fluorine-containing polymer A: A compound having concentration of 6% (produced by JSR, refractive-index 1.44, concentration of solid 6%) in which 80 g of the fluorine-containing polymer, 20 g of CYMEL 303 (produced by Nihon Cytec Industries Inc.) as curing agent, 2.0 g of CATALYST 4050 (produced by Nihon Cytec Industries Inc.) as curing solvent dissolved in the MEK described in Example 1 of JP-A-11-189621.

The MEK-ST-L: A colloidal silica dispersion material (produced by NISSAN CHEMICAL INDUSTRIES, LTD., difference of particle size of MEK-ST, average diameter 45 nm, concentration of solid 30%)

The KMB-5103: a silane coupling agent (acryloxypropyltri-methoxysilane) (produced by hin-Etsu Chemical Co., Ltd.)

(Coating of Low Refractive-Index Layer)

The triacetylcellulose film on which the hard coat layer was applied was rolled again, the coating solution for the low refractive-index layer was applied to the triacetylcellulose film by using a doctor blade and a micro gravure roll which has a gravure pattern having lines of 200 per an inch and depth of 30 μm and has a diameter of 50 mm under a condition of a transportation speed of 20 m per a minute, was dried for 75 seconds at 120° C., was dried for 10 minutes, and was irradiated with UV beams having intensity of 400 mw/cm² and an amount of irradiated light of 240 mJ/cm² by using an air-cooled metal halide lamp (manufactured by EYEGRAPHICS CO.,LTD.) of 240 W/cm under a nitrogen purge. Accordingly, low refractive-index layer having a thickness of 100 nm was formed and rolled so as to obtain an Example 1. A refractive index of the low refractive-index layer was 1.43.

Examples 2 to 21 and Comparative Examples 1 to 4 were produced in the same manner as the Example 1 except for a compounding formulation changed as shown in Table 1. Styrene-acryl particles used for the Example I were extracted in Example Specimens 19 to 21 to change the styrene particles to amorphous silica particles (aggregates of silica microparticles of several tens of nano-order, having a second average diameter of 3 μm).

Average 5° specular reflectance A (%), average integrated reflectance B (%),roughness of surface Ra, satisfaction of requirements (Formula 1) of the invention (whether B-A/Ra was less than 4), inner haze, pencil hardness of an antireflection film to be obtained, and a performance of a liquid crystal device shown in 6-(6) were examined. The results of the examination were shown in Table 1. Evaluations (−) of high blackness shown in Comparative Examples 3 and 4 represented unvalued high blackness.

TABLE 1

| | | Acrylstyrene | Styrene | | Thickness of | | | | |
|---|---|---|---|---|---|---|---|---|---|
| | PETA | Beads | Beads | Initiator | Hard Coat | | | | |
| | (part by | (part by | (part by | (part by | Layer | A | B | | Ra |
| | weight) | weight) | weight) | weight) | (μm) | (%) | (%) | B − A | (μm) |
| Example 1 | 50 | 1 | 6 | 2 | 5 | 2.66 | 2.80 | 0.14 | 0.05 |
| Example 2 | 50 | 1 | 4.6 | 2 | 5 | 2.66 | 2.80 | 0.14 | 0.05 |
| Example 3 | 50 | 1 | 4.3 | 2 | 5 | 2.66 | 2.80 | 0.14 | 0.05 |
| Example 4 | 50 | 1 | 2.9 | 2 | 5 | 2.66 | 2.80 | 0.14 | 0.05 |
| Example 5 | 50 | 1 | 2.6 | 2 | 5 | 2.66 | 2.80 | 0.14 | 0.05 |
| Example 6 | 50 | 1 | 1.2 | 2 | 5 | 2.66 | 2.80 | 0.14 | 0.05 |
| Example 7 | 50 | 1 | 0.9 | 2 | 5 | 2.66 | 2.80 | 0.14 | 0.05 |
| Example 8 | 50 | 1 | 0.17 | 2 | 5 | 2.66 | 2.80 | 0.14 | 0.05 |
| Example 9 | 50 | 1 | 0.14 | 2 | 5 | 2.66 | 2.80 | 0.14 | 0.05 |
| Comparative | 40 | 1 | 4.3 | 1.6 | 4 | 1.70 | 2.86 | 1.16 | 0.22 |
| Example 1 | | | | | | | | | |
| Comparative | 45 | 1 | 4.3 | 1.6 | 4.5 | 1.99 | 2.82 | 0.83 | 0.19 |
| Example 2 | | | | | | | | | |
| Example 10 | 47 | 1 | 4.3 | 1.9 | 4.7 | 2.29 | 2.80 | 0.51 | 0.13 |
| Example 11 | 48 | 1 | 4.3 | 1.9 | 4.8 | 2.54 | 2.80 | 0.26 | 0.09 |
| Comparative | 50 | 0 | 0 | 2 | 5 | 2.76 | 2.79 | 0.03 | 0.01 |
| Example 3 | | | | | | | | | |
| Comparative | 60 | 1 | 0 | 2.4 | 5 | 2.72 | 2.79 | 0.07 | 0.02 |
| Example 4 | | | | | | | | | |
| Example 12 | 55 | 1 | 0.19 | 2.2 | 5.5 | 2.66 | 2.79 | 0.11 | 0.03 |
| Example 13 | 70 | 1.4 | 0.24 | 2.8 | 7 | 2.67 | 2.77 | 0.10 | 0.05 |
| Example 14 | 80 | 1.6 | 0.27 | 3.2 | 8 | 2.68 | 2.76 | 0.08 | 0.05 |
| Example 15 | 150 | 3 | 0.51 | 8 | 15 | 2.68 | 2.76 | 0.08 | 0.04 |
| Example 16 | 200 | 4 | 0.68 | 8 | 20 | 2.68 | 2.75 | 0.07 | 0.04 |
| Example 17 | 350 | 7 | 1.2 | 14 | 35 | 2.68 | 2.75 | 0.07 | 0.04 |
| Example 18 | 400 | 8 | 1.4 | 16 | 40 | 2.67 | 2.74 | 0.07 | 0.04 |
| Example 19 | 25 | 0 | 8(silica) | 1 | 2.5 | 1.94 | 2.80 | 0.86 | 0.24 |
| Example 20 | 25 | 0 | 4(silica) | 1 | 2.5 | 2.21 | 2.76 | 0.55 | 0.20 |
| Example 21 | 25 | 0 | 2(silica) | 1 | 2.5 | 2.63 | 2.78 | 0.15 | 0.09 |

| | Internal Haze | | Display Performance Evaluation | | |
|---|---|---|---|---|---|
| | (%) | Pencil Hardness | High Blackness | Reflection Image | Image Unclearness |
| Example 1 | 35 | 3H | ◯◯ | ◯ | 3 |
| Example 2 | 27 | 3H | ◯◯ | ◯ | 3 |
| Example 3 | 25 | 3H | ◯◯ | ◯ | 3.5 |
| Example 4 | 17 | 3H | ◯◯ | ◯ | 3.5 |
| Example 5 | 14 | 3H | ◯◯ | ◯ | 4 |
| Example 6 | 7 | 3H | ◯◯ | ◯ | 4 |
| Example 7 | 4.5 | 3H | ◯◯ | ◯ | 4.5 |
| Example 8 | 1 | 3H | ◯◯ | ◯ | 4.5 |
| Example 9 | 0.8 | 3H | ◯◯ | ◯ | 5 |
| Comparative | 25 | 3H | Δ | ◯ | 3.5 |
| Example 1 | | | | | |
| Comparative | 25 | 3H | Δ | ◯ | 3.5 |
| Example 2 | | | | | |
| Example 10 | 25 | 3H | ◯ | ◯ | 3.5 |
| Example 11 | 25 | 3H | ◯◯ | ◯ | 3.5 |
| Comparative | 0 | 3H | — | X | 5 |
| Example 3 | | | | | |
| Comparative | 0.1 | 3H | — | X | 5 |
| Example 4 | | | | | |
| Example 12 | 0.8 | 3H | ◯ | ◯ | 5 |
| Example 13 | 1.3 | 3H | ◯◯ | ◯ | 4.5 |
| Example 14 | 1.6 | 4H | ◯◯ | ◯ | 4.5 |
| Example 15 | 3 | 4H | ◯◯ | ◯ | 4.5 |
| Example 16 | 4 | 5H | ◯◯ | ◯ | 4.5 |
| Example 17 | 7 | 5H | ◯◯ | ◯ | 4 |
| Example 18 | 8 | 5H | ◯◯ | ◯ | 4 |
| Example 19 | 1.8 | 2H | ◯ | ◯ | 4.5 |
| Example 20 | 0.9 | 2H | ◯◯ | ◯ | 5 |
| Example 21 | 0.5 | 2H | ◯◯ | ◯ | 5 |

The followings were shown in Table 1.

(1) It was preferable that a film on which Ra was more than or equal to 0.03 μm and a difference (B−A) between the integrated reflectance (B) and the 5° specular reflectance (A) was less than four times Ra was provided as a film having high anti-reflectance to display well, and it was more preferable to provide a film on which the difference (B−A) between the integrated reflectance (B) and the 5° specular reflectance (A) was less than three times Ra.

(2) It was preferable that the inner haze was less than 36% , more preferably less than 25% still more preferably less than 15%, even more preferably less than 5%, and the most preferably less than 1%. Accordingly, it was possible to decrease the image unclearness so as to provide a preferable antireflection film.

(3) In a viewpoint of film toughness (the pencil hardness), it was preferable that a film thickness of the hard coat layer was 5 μm or more, more preferably 8 μm or more (4 H and above), still more preferably 20 μm or more(5 H and above). When the film thickness of the hard coat layer thickened up to 40 μm, it was not preferable in a viewpoint of brightness and handling. It was preferable that maximum size of the film thickness was set up to about 35 μm.

Respective Examples 22 to 23 and 24 to 26 were produced in the same manner as respective Examples 8 to 9 and 19 to 21 except for changing the Coating solution I for low refractive-index layer with Coating solution 2 for low refractive-index layer described below, so that the refractive index of the low refractive-index layer was low (refractive index=1.38). Accordingly, reflective index was low and the reflection on an image of a fluorescent lamp was controlled so as to provide the image display device having more preferable antireflection film.

Coating Solution 2 for Low Refractive-Index Layer

| | |
|---|---|
| DPHA | 1.5 g |
| FP-1 (2.0%) | 5.5 g |
| Hollow Silica (18.2%) | 20.0 g |
| RMS-033 | 0.7 g |
| IRUGACURE 907 | 0.2 g |
| Sol Liquid | 6.0 g |
| MEK | 305.0 g |
| Cyclohexanone | 9.0 g |

Respective compounds to be used will be described as follows:

DPHA: A compound between dipentaerythritol penta acrylate and dipentaerythritol hexaacrylate (produced by NIPPON KAYAKU CO.,LTD.)

FP-1: Fluorochemical agent for surface modification (the exemplified compound FP-1 being dissolved at 2.0 wt % in MEK)

Hollow silica: Surface modification rate of hollow silicasol (made by CATALYSTS&CHEMICALS IND.CO.,LTD. CS-60 IPA, refractive index 1.31, average diameter 60 nm, thickness of shell 10 nm, concentration of solid 18.2%) on which surface modification was performed by the KBM-5103 to silica 30 weight %

RMS-033: Reactive silicon (made by Gelest)

IRUGACURE 907: Photopolymerization initiator (made by Ciba Specialty Chemicals Co., Ltd.)

Respective Examples 27 to 28 and 29 to 31 were produced in the same manner as respective Examples 8 to 9 and 19 to 21 except for changing the Coating solution 1 for low refractive-index layer with Coating solution 3 for low refractive-index layer described below, so that the refractive index of the low refractive-index layer was low (refractive index=1.35). Accordingly, reflective index was low and the reflection on an image of a fluorescent lamp was controlled so as to provide the image display device having more preferable antireflection film.

Coating Solution 3 for Low Refractive-Index Layer

| | |
|---|---|
| Fluorine-Containing Polymer B (6%) | 25.0 g |
| Hollow Silica (18.2%) | 20.0 g |
| RMS-033 | 0.7 g |
| Irgacure 907 | 0.2 g |
| MEK | 100.0 g |
| Cyclohexanone | 3.0 g |

Respective compounds to be used will be described as follows:

Fluorine-containing polymer B: a fluorine-containing polymer containing an ethylenic unsaturated group (a fluorinated polymer (A-1) described in JP-A-2005-89536, Example 3, being diluted with MIBK to 6.0 wt % (refractive index 1.35)).

Each of all the samples of the Examples was adhered to television sets not only of 32 inches but also of 23, 26 and 42 inches, and was evaluated under the aforementioned evaluating conditions (visual evaluation and judgment in a lighted room of 1000 lux, with a black display on the liquid crystal display apparatus). As a result, the effect of the present invention could be confirmed in any size, and the effect of the present invention was more evidently observed in the television of a size of 32 inches or more This can be attributable to a fact that a larger image size is liable to be more influenced by the ambient external light, whereby the improvement by the present invention to obtain a high blackness appears more effectively.

Such results dependent on the size of television were also confirmed in other liquid crystal modes (TN, VA, OCB and ECB).

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2006-025822 filed Feb. 2 of 2006, the contents of which are incorporated herein by reference.

What is claimed is:

1. An antireflection film comprising: a transparent support; at least one hard coat layer; and a low refractive index layer having a refractive index of 1.47 or less, the low refractive index layer being an uppermost layer of the antireflection film,
wherein the antireflection film has a center-line average roughness Ra of 0.03 μm or more, and the antireflection film satisfies Expression (1):
B−A<4Ra (1)
wherein A represents an average 5° specular reflectance in a wavelength rage of 450 to 650 nm, and B represents an average integrated reflectance in the wavelength range.

2. The antireflection film of claim 1, which has an internal haze of less than 36% .

3. The antireflection film of claim 1, wherein the hard coat layer has a thickness of 5 to 35 μm.

4. A polarizing plate comprising: a polarizer; and two protective films, wherein at least one of the two polarizing plate is an antireflection film of claim 1.

5. An image display comprising an antireflection film of claim 1 as an outermost layer of the image display.

6. The image display of claim 5, which is a television having a size of 32 inches or more.
